(19) United States
(12) Patent Application Publication
(10) Pub. No.: US 2005/0169270 A1
(43) Pub. Date: Aug. 4, 2005

(54) Router, frame forwarding method, and lower layer frame virtual forwarding system

(76) Inventors: Ryoichi Mutou, Kawasaki (JP); Masato Okuda, Kawasaki (JP); Atsushi Kitada, Kawasaki (JP)

Correspondence Address: KATTEN MUCHIN ROSENMAN LLP, 575 MADISON AVENUE, NEW YORK, NY, 10022-2585, US

(21) Appl. No.: 11/092,315

(22) Filed: Mar. 29, 2005

Related U.S. Application Data
(63) Continuation of application No. PCT/JP03/03360, filed on Mar. 19, 2003.

(51) Int. Cl. H04L 12/28; H04L 12/56; H04J 3/22

(52) U.S. Cl. 370/390; 370/469; 370/395.2

(57) ABSTRACT

In an MPLS network, multicast, broadcast and address learning belonging to the layer 2 functions are realized. An ingress router comprises a frame receiving unit, a determining unit, a first frame transmitting unit, a physical address table for multicast, a label switching unit, a tunnel label table, a VCID giving unit, a L2 header creating unit and a second frame transmitting unit. The load on the network is suppressed, the band is efficiently used, and wasteful frame duplication and frame forwarding between edge routers are avoided.

### TECHNICAL FIELD

The present invention relates to a router, a frame forwarding method and a lower layer frame virtual forwarding system in a MPLS-layer 2-VPN (MPLS-Layer 2-Virtual Private Network: a layer 2 virtual private network to which MPLS is applied), wherein a public network can be used like a private network, by using, for example, MPLS (Multi-protocol Label Switching) technique. Particularly, the present invention relates to a router, a frame forwarding method and a lower layer frame virtual forwarding system suitable for use to a router having multicasting, broadcasting and unicasting functions, and a layer 2 address learning function.

### BACKGROUND ART

In these years, service providing entities such as service providers (SPs: Service Providers), carriers (communication carriers) and the like configure virtual private networks (virtual networks or VPNs) in layer 2 (data link layer), by using MPLS [MPLS defined in RFC (Request for Comments) 3031, RFC 3032] technique for certainly forwarding packets or frames.

(P1) Schematic Description of VPN (virtual network), L2VPN (Virtual Network in Layer 2) and MPLS

(P1-1) Packet, Frame, Label and LSP (Label Switched Path)

In the following description, “packet” signifies a basic unit of forwarded data. “Frame” is obtained by giving a header including a label to a layer 2 packet, and encapsulating the packet by layer 3. “Label” is an identifier of a path. The label is given to a frame transmitted in an MPLS network by an ingress router of the MPLS network. A frame given a label is called a MPLS frame.

LSP is classified into tunnel LSP and VCLSP. The tunnel LSP functions as a tunnel for a plurality of VCs (Virtual Circuits: virtual lines, VCLSPs), as shown in FIG. 2, for example. Each VCLSP functions as an actual line for transmitting layer 2 frames. In other words, the tunnel LSP is used to forward frames, and a label representing this tunnel LSP is called a tunnel label. VCLSP relates to a virtual line for forwarding frames. A label representing this VC is called a VC label.

Accordingly, these tunnel label and VC label function as hierarchical path identifiers.

(P1-2) Virtual Network

Generally, “virtual network” signifies a network where a service provider provides a private network service to users, by using a public network. “Virtual network in layer 2” signifies a network obtained by expanding the virtual network to a network forwarding frames in layer 2 such as MAC (Media Access Control) packets (physical packets) for example.

(P1-3) Schematic Description of MPLS

MPLS is a technique, in which a router (a forwarding apparatus or a node) gives (maps) a label to a frame in a format in any one of various protocols, and each router refers to only the label to forward the frame, or a technique of selecting a forwarding path (forwarding route). Accordingly, irrespective of the protocol of a frame encapsulated by MPLS, each router in the MPS network can forward the frame. The service provider can thus provide the frame forwarding service independently of layer-3 protocol of the user's side apparatus (user site) even when the frame to be encapsulated by MPLS is in layer 2.

Originally, MPLS is a technique for speeding up the forwarding process in a large-scale IP (Internet Protocol) network such as the Internet or the like. However, improvement of the hardware technique for a router enables each router to forward packets at high speed, thus MPLS becomes less important in the viewpoint of high-speed forwarding.

(P1-4) Purpose of Use of MPLS to Virtual Network

By giving the both labels to a frame, each router can identify the frame. It is also possible to give not only one label but also two or more labels to a frame, which can expand the application of MPLS using labels. The purposes of use of MPLS are mainly two, in addition to the high-speed forwarding.

The first purpose is to give a function of explicitly setting a path in an IP network [traffic engineering (TE) function] to the network.

Why the traffic engineering is necessary is that a result of path calculation, which is normally performed, sometimes degrades the use efficiency of the band. In selecting a path leading to a destination IP address by means of normal path calculation, each link cost is calculated on the basis of the hop count of routers and the band width, calculated link costs are added, and a path having the smallest cost is selected as the shortest path.

On the other hand, the shortest paths obtained by path calculation are prone to be concentrated in a specific link (a path between neighboring routers) in the network, which may cause degradation of the use efficiency of the band.

In order to prevent the paths from being concentrated, the router explicitly designates a path, using the traffic engineering function, to make a detour. Whereby, specific network resources are allocated to each traffic.

The second purpose of use of MPLS is that the service provider provides a VPN service such as a L2VPN (virtual network in layer 2) with MPLS, for example. This VPN service is that the service provider configures its own MPLS network, logically divides the MPLS network for each user, and provides the obtained network as a virtual network (VPN) to the user.

Whereby, in a L2VPN, the user can use existing routers unconscious of MPLS. Additionally, different users can share the same IP address. Further, the service provider can forward a layer 2 frame, irrespective of the layer-3 protocol of a network that the user uses.

(P1-5) Label Switching

The layer 2 frame forwarding function is realized by label switching, using a label switching path that MPLS has. A frame from, for example, an IP network neighboring the MPLS network is forwarded (routed or forwarded) along a label switched path (hereinafter, referred to as an LSP, unless specifically mentioned) set between routers belonging to the MPLS network. The routing in the MPLS network is performed in such a way that each router disposed between an ingress router (ingress edge router: LER, ingress LER or Ingress Router), which is disposed at the start of the LSP, and an egress router (egress edge router: LER, egress LER or Egress Router), which is the end of the LSP, has a label table for a reception label and a transmission label, and each router refers to this label table to forward the frame.

FIG. 29 is a diagram for illustrating label switching in an MPLS network. FIG. 29 shows an example where an IP packet of a user is encapsulated by MPLS. The MPLS network (MPLS domain) 100 shown in FIG. 29 has an ingress router (LER) #1 and an egress router (LER) #2, both of which transmit/receive packets to/from user networks 51a and 51b, and a relay router (LSR [Label Switch Router]: label switch router) #1 coping with MPLS.

In the following description, “packet” signifies a basic unit of forwarded data, and a frame is obtained by giving a header including a label to a packet and encapsulating the packet by the higher layer of layer 2, unless specifically mentioned.

The IP packet from the user network 51a is given a label in the ingress router #1. The frame given the label is forwarded to the relay router #1. The relay router #1 refers to the label of the received frame, replaces the label with a label showing the egress router #2, and forwards the frame. The egress router #2 removes the label of the MPLS frame, and transmits the frame to the user network 51b. The ingress router #1 and the egress router #2 look up the IP address of the IP packet, but the relay router #1 forwards the frame, using only the label table disposed in the relay router #1 itself.

Meanwhile, the operation of giving a label to a frame and forwarding the same performed in the ingress router #1 is called “push.” The operation of replacing the label and forwarding the frame performed in the relay router #1 is called “swap.” The operation of removing the label and forwarding the frame performed in the egress router #2 is called “pop.”

(P1-6) FEC (Forwarding Equivalence Class)

A collection of packets having the same destination (egress router) and to be undergone the same process among IP packets from the user network 51a is called FEC. For example, an IP subnetwork or integrated network addresses correspond to one FEC. Label is used as a mark for discriminating the same FEC. A path for forwarding an MPLS frame given a label corresponds to the above LSP. LSP is used for point-to-point forwarding. When frames have the same destination, LSPs are sometimes merged and used for point-to-point forwarding.

(P1-7) Point-to-Point Forwarding with LSP

FIG. 30(a) is a diagram for illustrating label swapping in the MPLS network 100. A relay router (LSR) #1 shown in FIG. 30(a) forwards a frame having, for example, a label “25.” A relay router (LSR) #2 reads the label of the frame, and refers to a tunnel label table (label table) 15 shown in FIG. 30(b). In this tunnel label table 15, a reception label (reception label value) and a transmission label (transmission label value) are related to each other, and held. The relay router #2 replaces the reception label “25” with the transmission label “35” for a relay router #3 in the following stage, and forwards the packet without using a routing table. Accordingly, the label is replaced with a different one each time the packet passes through each of the relay routers #1 through #3.

The relay routers #1 through #3 correspond to one LSP. The relay router #2 gives an FEC “11” to this LSP. Whereby, a number of LSPs can be identified, and each of the relay routers #1 through #3 can logically set a plurality of LSPs. Incidentally, LSP shows a path in one direction. When the two directions are required, two LSPs are required.

(P1-8) Description of PHP (Penultimate Hop Popping)

As an example of label popping, PHP is known. PHP is a forwarding method (frame forwarding method) in which a relay router in a stage immediately before the egress router removes the label of an MPLS frame.

FIG. 31 is a diagram for illustrating PHP. An LSP is set between an ingress router #1 and an egress router #2. An IP packet shown in FIG. 31 is pushed a label L1 in the ingress router #1, and encapsulated into an MPLS frame (composed of an IP packet and a label). The label L1 of this MPLS frame is swapped to a label L2 in a relay router #1. An egress router #2 does not need to read the label from the relay router #1. Accordingly, the label is removed in a relay router in a stage immediately before the egress router #2, the packet is then forwarded to the user network 51b.

LSP can be applied to point-to-multipoint forwarding. Now, practical forwarding methods are under examination, and various drafts are proposed.

(P1-9) Format of MPLS Frame

With respect to an original packet or the like (also referred to media) having a field corresponding to a label such as an IP packet, a SONET (Synchronous Optical NETwork) frame or the like included in an MPLS frame, the ingress router #1 directly gives a label to the field. For example, this corresponds to VPI (Virtual Path Identifier)/VCI (Virtual Channel Identifier) of ATM (Asynchronous Transfer Mode), or DLCI (Data Link Connection Identifier) of frame relay. VPI and VCI become a pair to identify the destination of a frame in the next stage.

On the other hand, media not including a part corresponding to the label, the ingress router #1 adds a new header (shim header [Shim Header]) to the frame. For example, media in PoS (Packet over SONET) and Ethernet are given shim header.

FIGS. 32(a) through 32(c) are diagrams showing an example of the format of an MPLS frame. An MPLS frame shown in FIG. 32(a) has a shim header. The shim header can include n (n representing a natural number) kinds of different labels, as shown in FIG. 32(b). Whereby, each router can accumulate (stack) a plurality of labels on the MPLS frame.

Here, a label n is a bottom label (the last label) that is the first label given to the frame. In the shim header of the MPLS frame, labels n-1 are stacked in order by relay routers. A portion read by the relay routers is only the outer label. The order in which the plural labels are removed is from the outer label 1 to the label n. By stacking, it is possible to generate a hierarchical LSP. Incidentally, these stacked labels are used when a virtual network (VPN) using MPLS is provided.

Each of the labels 1 through n includes Label Value, EXP (showing a name according to description in RFC 3032), S (Bottom of Stack) bit, and TTL (Time To Live) Value. EXP is used to transmit information about CoS (Class of Service)/QoS (Quality of Service). Qos is a technique for realizing assurance of communication quality, band guarantee and the like. CoS is a technique in which the transmitting apparatus sets the priority to a packet, and the router preferentially forward a packet having higher priority. S bit represents whether the label is the bottom label or not. When the given label is the bottom label, “1” is written in the S bit. When the given label is not the bottom label, “0” is written. TTL is the number of times the frame is forwarded until the frame is discarded.

(P1-10) Label Distribution Protocol

The magnitude of the load on the MPLS network is fluctuated at any time. For this, each router replaces the reception label with a transmission label beforehand assigned to a relay router in the following stage, generates a label table in which the reception label and the transmission label are related to each other. Thereafter, the router refers to the label table, and forwards the frame whose label has been replaced. The replacement of the label and packet forwarding are repeated, whereby the labels are distributed to relay routers between the ingress router and the egress router.

The label distribution protocol used by each router is a transmission/reception protocol of control signals. As this signaling protocol, LDP (Label Distribution Protocol: RFC 3036) and RSVP-TE (Resource ReserVation Protocol with Traffic Extensions) are known.

(P1-11) LDP

LDP is a signaling protocol for label distribution only. LSP defines a method (or procedure) of beforehand distributing information about assignment of FEC and label between neighboring routers or relay routers away from each other. As an example of a label distributing method using LDP, DoD (Downstream on Demand) mode and DU (Downstream Unsolicited) mode are known.

FIG. 33(a) is a diagram for illustrating DoD mode. In DoD mode, when a relay router on the upper stream side shown in FIG. 33(a) transmits an inquiry message (label request message) about a label corresponding to FEC to a relay router on the downstream side, the relay router on the downstream side distributes a label to the relay router on the upper stream side (label mapping message).

FIG. 33(b) is a diagram for illustrating DU mode. In DU mode, a relay router on the downstream side having FEC determines a label and transmits a label request message (label request) to a relay router on the upper stream side, and the relay router on the upper stream side transmits mapping representing that label is assigned to the relay router on the downstream side when receiving the label request.

Label distribution becomes possible with LDP. On the other hand, LSP represents a path itself, and accords with the shortest path of the routing protocol. There is no dependence between LSP and LSP, which are dependent of each other. LDP lacks a function of securing the bandwidth that LSP has. For this, as a technique realizing the function that LDP lacks, RSVP-TE (RSVP Traffic Engineering; RFC3209) and CR-LDP (Constraint Routed LDP: RFC3212) are known.

(P1-12) RSVP-TE

RSVP-TE was obtained by adding the label distributing function to RSVP (Resource Reservation Protocol) established for band reservation in IP networks and extending the RSVP. CR-LDP was obtained by adding necessary functions to LDP itself. Basically, RSVP-TE and CR-LDP set a point-to-point LSP in DoD mode, which realize a function called ER6 (Explicit Route 6) explicitly designating a LSP, and have a function of reserving a bandwidth in each link (physical link or forwarding path).

(P2) Draft-Martini System (First Draft or Martini Draft)

(P2-1) Contents of Provision

Martini Draft defines a method of forwarding a layer 2 packet point-to-point. There are known a plurality of L2 protocols supported by Martini Draft. Among them, most attracting attention is Ethernet.

(P2-2) Tunnel Label and VC Label Defined in Martini Draft

“Tunnel” signifies that a virtual path (tunnel LSP) is set between an ingress router and an egress router, and a VCLSP is set inside the tunnel LSP. By mapping a layer 2 packet to the VCLSP, transmission of a packet having an exclusive address that cannot pass through the Internet and a communication between networks applied a protocol other than IP protocol become possible.

(P2-3) Example of Forwarding Method

FIG. 34 is a diagram for illustrating a forwarding method defined in Martini Draft. With respect to users A and B shown in FIG. 34, an LSP coping with the users A and B is established in an MPLS network 100. Each of an ingress router #1, relay routers #1 and #2, and an egress router #2 is a provider edge router (PE) providing an Ethernet virtual line (Ethernet VC).

First, the ingress router #1 sets a tunnel LSP (denoted by cylindrical shape) between the ingress router #1 and the egress router #2. A label showing the tunnel LSP (tunnel label) is written in the outermost portion of each of packets 91a and 91b. The ingress router #1 sets two VCLSPs (denoted by thick line and broken line) in order to provide two Ethernet virtual lines in the one tunnel LSP. A label (VC label) showing a VCLSP is on the inner side than the tunnel label, and written in a portion outside the user L2 packet.

The frame format shown in FIG. 34 is defined in Martini Draft, where a layer 2 header, a tunnel label (T, T2 or the like), a VC label (A, B or the like) and CW (Control Word) are written. Here, “layer 2 header” is a header relating to physical link. “Tunnel label” is a label for forwarding a frame in a virtual network (MPLS network). “VC label” is used to identify a virtual line, which is distributed by expanding the label LDP, for example. “CW” is used for control, which is optionally used in a domain of Ethernet or VLAN (Virtual Local Area Network). “Payload” shows the whole Ethernet frame excepting the preamble and frame check sequence. Accordingly, an MPLS frame is forwarded, using two kinds of stacked labels.

The ingress router #1 sets a common VCID (user identifier) for identifying an Ethernet virtual line to, for example, “2400,” and sets a VC label “2000” as a label showing the VCID “2400.” A reason of this is that the egress router #2 cannot discriminate the user point (ingress router) with only the VCID. For this, a VC label is assigned in order to identify both the user and the ingress router #1 showing the user point. Whereby, the ingress router #1 finds that what the ingress router #1 should do is giving the VC label “2000” to an MPLS frame to be forwarded to the egress router #2 having the same VCID “2400.”

The ingress router #1 gives a tunnel label T1 common to both the users A and B, and VC labels A and B for identifying the users A and B to packets 91a and 91b received from the users A and B, respectively, and transfers them to the MPLS network 100.

As above, according to the frame forwarding method defined in Martini Draft, a tunnel label and a VC label are set in two stages, and MPLS frames are forwarded through a plurality of VCLSPs.

(P2-4) Meanwhile, Martini Draft is under standardization. Two kinds of drafts, that is, a forwarding method (Transport of Layer 2 Frames over MPLS, draft-martini-12circuit-trnas-mpls-09.txt) and an encapsulation method (Encapsulation Methods for Transport of Layer 2 Frames Over IP and MPLS Networks, draft-martini-12circuit-encap-mpls-0.4 text) have been published. Many venders have already started to apply it to their products. VPLS is known as expanded Martini Draft.

(P3) VPLS (Virtual Private LAN Service)

VPLS is a service for expanding the wide area LAN service provided by many service providers. VPLS is a multipoint layer 2 VPN technique for efficiently transferring, specifically, an Ethernet packet among layer 2 packets. VPLS has both the layer 2 function which is necessary to forward an MPLS frame including a layer 2 packet, and an MPLS function (label switching, label pushing and label popping) of the ingress router or the egress router. This layer 2 function represents a source MAC address recognizing function and a layer 2 switching function.

This layer 2 switching signifies switching of a forwarding path or an apparatus switching the forwarding path. In concrete, the layer 2 switching represents filtering, forwarding or flooding on the basis of the MAC address of a frame. Incidentally, “flooding” signifies that, when a router having the layer 2 switching receives a blind frame having an unknown destination address, the router duplicates the received frame and transmits the duplicated frames to all output ports (excepting the port that has received the frame) related to the layer 2 switching. Hereinafter, these definitions will be used in the same senses, unless specifically mentioned.

In more detail, according to VPLS, the service provider emulates (virtually realizes) switching of layer 2 frames for the user, using an MPLS network of the service provider itself, and the ingress router and the egress routers have a layer 2 address learning function. According to this frame forwarding method using VPLS, when a destination MAC address is not registered in the MAC address table, the MPLS frame including an Ethernet packet is forwarded to only an egress router #2 connected to the destination user site in order to efficiently use the band and eliminate redundant forwarding. For this, VPLS switches the Ethernet packet on the basis of its destination MAC address.

To the contrary, the above Martini Draft makes point-to-point forwarding possible, but does not include a function of realizing forwarding based on the layer 2 switching function, that is, the MAC address learning.

(P4) Description of Draft-lassere-vkompella (Virtual Private LAN Services over MPLS, draft-lasserre-vkompella-ppvpn-vpls-01.txt) System (Second Draft)

(P4-1) Contents of Provision

The second draft is one of practical ideas for realizing a service (VPLS) virtually realizing the layer 2 forwarding in an MPLS network. The second draft, schematically, defines a point-to-multipoint layer 2 VPN having the MAC address learning function, which can be used as the backbone (basic trunk) of a wide area LAN service. In the second draft, described are the MAC address learning in the ingress router and the egress router, and the operations of multicasting and broadcasting in an MPLS network.

(P4-2) VCID (VC-Identification: User Identifier for Identifying Each User)

Practically, a VCID is assigned to each user, and a full-mesh virtual network is configured, using the VCIDs.

Whereby, the MPLS network is assumed to be a virtual bridge. In the MPLS network, the service provider can provide VPLS to the users.

(P4-3) Bridge (Bridging Function)

“Bridging” signifies that a frame is forwarded in layer 2 on the basis of a MAC address table, wherein filtering, forwarding, flooding or the like of the frame is performed.

(P4-4) Cast in MPLS Network

Existing LAN supports services of multicasting and broadcasting. On the other hand, MPLS network does not support these services at present.

Here, “multicast” signifies that a plurality of routers (addresses of routers) are designated in a network, and the same data is transmitted. “Broadcast” signifies that data is transmitted to unspecified many routers (addresses of routers). “Unicast” signifies that data is transmitted to a single router (an address of a router).

In order that the MPLS network uses MPLS, each of traffics of multicast, broadcast and unicast are appropriately forwarded between user sites having the same multicast or broadcast domain and connected to the MPLS network.

In order to realize appropriate forwarding of each of the traffics, the MAC address learning function is required for each LSP (or per LSP). Additionally, a frame is duplicated in number corresponding to required VCLSPs, whereby flooding of a multicast frame, a broadcast frame and a unicast frame whose destination is unknown is realized.

(P4-5) Construction of Virtual Network (VPN)

When unicast LSPs are used in an MPLS network, full-mesh VCs are established between the ingress routers and the egress routers corresponding to nodes configuring a virtual network, whereby a virtual network is configured. Since this VC represents only one direction, a pair of VCs for transmitting traffics in the two directions is present between the ingress router and the egress router. Here, switching of the VC label is performed, relying on LDP or the like, and the user VPN is identified with a unique VPNID of, for example, 32 bits.

(P4-6) Example of Frame Forwarding

The user traffic is forwarded to a specific virtual network according to setting of a FEC based on input ports of a router or VLAN. The ingress router and the egress router have different MAC address tables called VFI (Virtual Forwarding Instance) to recognize a source MAC address, like a normal layer 2 switch (L2 switch).

In order to forward a frame, it is necessary to provide a function of relating a VCLSP and a destination MAC address and holding them to a bridge apparatus (apparatus having the bridging function) in the MPLS network. However, it is practically impossible to statically relate combinations of all possible destination MAC addresses and VCLSPs. Accordingly, the ingress router and the egress router have to relate an inbound VC label to an outbound VC label and hold them so as to dynamically learn the destination MAC address.

(P4-7) VC Label Assigning Method

FIG. 35 is a diagram for illustrating a VC label assigning method. An MPLS network 100 shown in FIG. 35 is virtual network in layer 2 using MPLS. Users A1 through A4 are segments in the same VPLS (networks divided by apparatuses having the layer 3 function such as routers or the like, representing unit domains transmitting broadcast frames), each of which is assigned a VCID “1234.” An ingress router #1 has a MAC address table in which a destination MAC address and a VC label are related to each other and held in order to forward an Ethernet packet, and retrieves a VC label with a MAC address.

As a label distributing method, the egress router #2 notifies (label signaling) the ingress router #1 of information about a VC label. In concrete, the egress router #2 notifies the ingress router #1 that a MPLS frame addressed to the egress router #2 and having an VCID “1234” should be given a VC label “201” and forwarded.

(P4-8) Example of Transfer between Routers

When the ingress router #1 receives a packet including a destination MAC address M2 whose entry is not present from a user site connected to the ingress router #1 itself, the ingress router #1 transmits this MPLS to all LSPs having VC labels belonging to the virtual network of the user site.

FIG. 36 is a block diagram of the ingress router #1. When a frame receiving unit 93a of the ingress router #1 receives a packet from a user network 51a, a MAC bridge process unit 93b refers to a MAC address table 93d, and transmits the frame from a first frame transmitting unit 93c.

When the frame is unicast, a VC label pushing unit 93f gives a VC label to the frame, and a tunnel label pushing unit 93g gives a tunnel label to the frame on the basis of information held in a tunnel label table 93h. A layer 2 header creating unit 93i creates a layer 2 header for the MPLS frame given the labels, and a second frame transmitting unit 93j outputs the frame. When the MAC bridge process unit 93b determines that the frame is a multicast frame, a frame duplicating unit 93e duplicates the frame, and inputs the frames to the VC label pushing unit 93f.

When the ingress router #1 receives a frame whose destination is unknown, the ingress router #1 forwards the received frame to VCLSPs relating to virtual networks to which the received frame belongs.

FIG. 37 is a diagram for illustrating flooding. When an ingress router #1 shown in FIG. 37 receives a frame including a source MAC address M1 and a destination MAC address (destination MAC address) M2 from a user A1, the ingress router #1 duplicates the MPLS frame for VCLSPs when not knowing the destination MAC address M2. The ingress router #1 transmits the MPLS frames having VC labels 201 and 301 toward corresponding egress routers. Whereby, a unicast frame whose destination is unknown can be flooded.

FIG. 38 is a block diagram of a relay router #1 (LSR #1). In the relay router #1 (a relay router #2 having the same structure) shown in FIG. 38, when a frame receiving unit 94c receives a frame, a L2 header removing unit 94d removes the header and inputs the frame to a label switching unit 94b. The label switching unit 94b refers to a tunnel label table 94a, swaps the tunnel label, and outputs the swapped frame through a L2 header creating unit 94e and a second frame transmitting unit 94f. Accordingly, the relay router #1 refers to only the tunnel label of the received frame, and forwards the frame.

On the other hand, processes using a VC label bind table are shown in FIGS. 39 and 40. FIG. 39 is a block diagram of the egress router #2 (LER #2). The egress router #2 shown in FIG. 39 refers to a VC label bind table 95a as does in the normal layer 2 switching when receiving a frame. An address learning unit 95b refers to the VC label bind table 59a when the VC label of the received frame is 201 and the source MAC address is of M1 as shown in FIG. 40, relates the MAC address M1 to a VC label 102 which is a VC in the opposite direction, and makes an entry in a MAC address table 95c (FIG. 39).

FIG. 41 is a diagram for illustrating unicast forwarding. When an egress router #2 shown in FIG. 41 receives a frame having a destination MAC address M1 from a user site (user A2 or A4) connected to the egress router #2, the egress router #2 retrieves the MAC address M1 in a MAC address table (not shown), and obtains a VC label 102. The egress router #2 sets the VC label of the received frame to 102, and transmits the set frame to the MPLS network 100.

After the ingress router #1 receives the frame having the source MAC address M2, an entry is made in the MAC address table by learning. A frame having the destination MAC address M2 is transmitted unicast to the egress router #2.

(P4-9) Relationship Among Ingress Router #1, Egress Router #2 and MAC Address

Accordingly, the ingress router #1 and the egress router #2 both do not recognize all MAC addresses in a virtual network to which MPLS protocol is applied. The ingress router #1 and the egress router #1 both recognize only MAC addresses relating to an accommodating virtual network.

On the other hand, the relay routers #1 through #1 perform only label switching without recognizing MAC addresses.

(P5) Publicly Known Technique

There has been proposed a structure, in which each of terminal apparatuses and relaying apparatuses determines a forwarding destination while communicating with a route controlling apparatus in a connectionless communication network (for example, Patent Document 1).

Whereby, the convergence time of a control message and the band consumption of the control message are suppressed to small in a connectionless communication network so that the multicast communication can be performed, stably and economically.

(P6) Description of Problems

However, when a protocol defined in the above second draft (Draft-lassere-vkompella system) is used, the load on the MPLS network 100 becomes large.

FIG. 42 is a diagram for illustrating broadcast, using the known technique. An ingress router #1 shown in FIG. 42 receives a multicast frame, a broadcast frame or a unicast frame whose destination is unknown from a user site. When the ingress router #1 receives, for example, a broadcast frame, makes copies of the received frame in number corresponding to the number of VCs to which the frame should be transmitted, and transmits the plural copies of the frame to relay router #1 in the following stage.

For this, a number of frames are forwarded to the MPLS network 100. Accordingly, a number of the same frames are transmitted through the same link, which increases the load on the MPLS network 100.

When receiving a unicast frame whose destination is unknown, the ingress router #1 transmits the unicast frame to all routers in the MPLS network 100. Accordingly, the load on the MPLS network 100 increases, as well. Since a large number of copies of the frame are transmitted in, specifically, a network of the best effort type, the band cannot be effectively used.

When the ingress router #1 once enters the MAC address of a received multicast frame in the MAC address table, the ingress router #1 transmits all musticast frames received thereafter to the egress router #2 having the MAC address as a destination MAC address registered in the MAC address table. Accordingly, wasteful frame duplication and frame forwarding are caused between the ingress router #1 and the egress router #3, which is the load on the virtual network.

Further, the MPLS network 100 is without the layer 2 address learning that the layer 2 switch requires. The service provider cannot efficiently provide a point-to-multipoint layer 2 virtual network having the layer 2 address learning function to the users in its own network.

Additionally, the route control apparatus described in above Patent Document 1 transmits a route setting message to the terminal apparatus and the relaying apparatus to set a forwarding route.

However, the route control apparatus described in the Patent Document 1 is not in a layer 2 virtual network to which MPLS is applied. Therefore, the route control apparatus does not learn addresses. Moreover, the above route control apparatus does not have functions of source MAC address recognition, layer 2 switching, label replacement in the ingress router or the egress router, label pushing and label popping (layer 2 functions) at the same time.
Patent Document 1: Japanese Patent Laid-Open No. 2002-77239

### DISCLOSURE OF INVENTION

In the light of the above problems, an object of the present invention is to provide a router, a frame forwarding method and a lower layer frame virtual forwarding system, which, in a layer 2 virtual network to which MPLS is applied, can realize address learning indispensable to the layer 2 functions, can suppress the load on the network to the minimum, can efficiently use the band in the virtual network and can prevent wasteful frame duplication and frame forwarding between the ingress router and the egress router.

The present invention provides a router in a virtual network being able to forward a lower layer frame including a protocol identifier for identifying duplication or non-duplication and a label switch frame having a hierarchical path identifier on the basis of the hierarchical path identifier, the router comprising a determining unit for determining whether a received lower layer frame or a received label switch frame is to be duplicated or not on the basis of a protocol identifier of the received lower layer frame or the received label switch frame, and a forwarding process unit for passing the received lower layer frame or the received label switch frame determined not to be duplicated by the determining unit, while giving at least any one of a hierarchical path identifier for unicast, a hierarchical path identifier for multicast and a user identifier to the received lower layer frame or the received label switch frame determined to be duplicated by the determining unit, and forwarding the frame.

Whereby, it is possible to suppress the load on the virtual network to the minimum.

The router can be configured as any one of (I) ingress router, (II) relay router and (III) egress router, below.

(I) The router may be configured as an ingress edge router pushing the label switch frame obtained by giving the hierarchical path identifier to an external lower layer frame from the outside of the virtual network to the virtual network, the determining unit may determine whether a received external lower layer frame is to be duplicated or not on the basis of a MAC address table for multicast in which a physical address to be duplicated is related to a plurality of output ports, and the forwarding process unit may give at least one selected from labels and an identifier below to the received external lower layer frame determined to be duplicated by the determining unit, and forward the frame:
(a) a label of a user point identification path selected from a plurality of user point identification paths for forwarding unicast frames;
(b) a user point identification path showing a forwarding source point of the frame to be duplicated and a tunnel path label showing a virtual route of the frame to be duplicated;
(c) a multicast label for multicase; and
(d) a user identifier for identifying the user.

Accordingly, it is possible to reduce the burden of duplicating the same frame.

(II) The router may be configured as a relay router forwarding the label switch frame to the virtual network on the basis of the hierarchical path identifier, the determining unit may determine whether to duplicate the label switch frame or not on the basis of the protocol type (a protocol identifier) included in the label switch frame, and the forwarding process unit may bridge to forward the label switch frame determined not to be duplicated by the determining unit, while duplicating the label switch frame determined to be duplicated by the determining unit on the basis of a VC label table for multicast in which at least a user point identification path label is related to contents of a process to be performed on the label switch frame to be duplicated, and giving the user point identification path label and the tunnel path label to the same.

Accordingly, it is possible to reduce the burden of processing layer 3 on each relay router, prevent the same frames from being duplicated and forwarded in the same link, and prevent the load on the virtual network from increasing.

(III) The router may be configured as an egress edge router removing the hierarchical path identifier given to the label switch frame forwarded from the virtual network and transmitting the label switch frame to the outside of the virtual network, and the forwarding process unit may comprise a popping process unit learning a relationship between a source MAC address of the label switch frame and the hierarchical path identifier, and transmitting a lower layer frame from which the hierarchical path identifier has been removed to the outside of the virtual network. Accordingly, it is possible to avoid wasteful frame duplication and frame forwarding between the ingress router and the egress router, and reduce the load on the virtual network.

The present invention further provides a frame forwarding method comprising a determining step of determining, by an ingress edge router pushing a label switch frame obtained by giving a hierarchical path identifier to an external lower layer frame from the outside of a virtual network to the virtual network, whether a received layer lower frame or a received label switch frame is to be duplicated on the basis of a protocol identifier of the received lower layer frame or the received label switch frame, a forwarding process step of passing, by the ingress edge router, the received lower layer frame or the received label switch frame determined not to be duplicated at the determining step, while giving at least any one of a hierarchical path identifier for unicast, a hierarchical path identifier for multicast and a user identifier to the received lower layer frame or the received label switch frame determined to be duplicated at said determining step, and forwarding the same, and a relaying step of duplicating or forwarding, by a relay router forwarding to the virtual network, the received lower layer frame or the received label switch frame forwarded at the forwarding process step on the basis of at least any one of the hierarchical path identifier for unicast, the hierarchical path identifier for multicast and the user identifier.

Accordingly, it is possible to efficiently use the transmission band of the virtual network.

At the forwarding process step, the ingress edge router may forward the label switch frame obtained by giving an address for multicast to a destination address of the received external lower layer frame, and at the relaying step, the relay router may duplicate and forward the label switch frame forwarded at the forwarding process step on the basis of a MAC table for multicast in which an address for multicast is related to forwarding destination router addresses. Accordingly, it is possible to realize multicasting and broadcasting of a packet or frame having a layer 2 protocol other than, for example, Ethernet in the virtual network.

The forwarding process step may comprise a determining step of determining, by the ingress edge router, whether to duplicate the received external lower layer frame or not on the basis of a MAC address table in which a MAC address to be duplicated is related to a user point identification path for forwarding a unicast frame, a selecting step of selecting, by the ingress edge router, a user point identification path from user point identification paths for a plurality of the frames not to be duplicated forwarded from the same output ports as output ports for forwarding the frames to be duplicated among a plurality of user point identification paths for forwarding the frames not to be duplicated among the user point identification paths, and a transmitting step of transmitting, by the ingress edge router, the label switch frame having a user point identification path selected at the selecting step, and, at the relaying step, the relay router may duplicate and forward the label switch frame transmitted at the transmitting step on the basis of a user point identification path label table for multicast in which a user point identification label for multicast is related to forwarding destination router addresses.

Accordingly, it is possible to allow a relay router which does not have the multicasting and broadcasting functions to use the both functions, whereby virtual forwarding of a layer 2 packet becomes possible.

The forwarding process step may comprise a setting step of setting, by the ingress edge router, a user point identification path for multicast and a tunnel path for multicast, and a forwarding step of forwarding, by the ingress edge router, the label switch frame through the user point identification path for multicast and the tunnel path for multicast, the relaying step may comprise a duplicating/forwarding step of duplicating and transferring, by a first relay router, the label switch frame on the basis of a label table for multicast in which the user point identification path label for multicast is related to forwarding destination router addresses, wherein a second relay router duplicates the label switch frame duplicated and forwarded at the duplicating/forwarding step, and forwards the same through the user point identification path for multicast and the tunnel path for multicast set at the setting step.

Accordingly, since the ingress edge router sets an LSP for multicast, the user can use the existing network resources as they are, while the service provider can give a value added to the virtual network with the minimum investment.

The forwarding process step may comprise a setting step of setting, by the ingress edge router, a point/tunnel identification path (point and tunnel identification path) for identifying a user point for multicast and a tunnel for multicast, and a forwarding step of forwarding, by the ingress edge router, the label switch frame through the point/tunnel identification path, the relaying step may comprise a duplicating/forwarding step of duplicating and forwarding, by a first relay router, the label switch frame on the basis of a second label table for multicast in which the point/tunnel identification path is related to forwarding destination router addresses, wherein a second relay router duplicates the label switch frame duplicated and forwarded at the duplicating/forwarding step, and forwards the same through the point/tunnel identification path set at the setting step. Accordingly, it is possible to eliminate forwarding of redundant information data, and improve the use efficiency of the transmission band.

The forwarding process step may comprise a setting step of setting a user point identification path for multicast and a tunnel path for multicast between the ingress edge router and each of a plurality of egress edge routers, and a transmitting step of transmitting, by the ingress edge router, a plurality of the label switch frames to be transferred to a plurality of the relay routers from the same output ports as output ports for forwarding the frames to be duplicated to the respective relay routers through the user point identification path for multicast and the tunnel path for multicast set at the setting step, at the relaying step, each of the relay routers may duplicate the label switch frame transmitted at the transmitting step, and forward the same through the user point identification path for multicast and the tunnel path for multicast set at the setting step.

Accordingly, the relay router can eliminate a redundant process on the received frame, and the efficiency of the frame forwarding in the MPLS network can be improved.

The forwarding process step may comprise a setting step of setting a point/tunnel identification path for identifying a user point for multicast and a tunnel for multicast between the ingress edge router and each of a plurality of egress edge routers, each of which removes the hierarchical path identifier given to the label switch frame forwarded from the virtual network and transmits the label switch frame to the outside of the virtual network, a giving step of giving, by the ingress edge router, a user identifier for identifying a user to the inside of each of a plurality of the label switch frames to be forwarded to a plurality of the relay routers from the same output ports as output ports for forwarding the frames to be duplicated, and a transmitting step of transmitting, by the ingress edge router, the label switch frame including the user identifier given to the inside of the frame at the giving step to each of the relay routers through the point/tunnel identification path set at the setting step, the relaying step may comprise a forwarding step of duplicating, by the relay router, the label switch frame transmitted at the transmitting step and forwarding the same through the point/tunnel identification path set at the setting step, and a learning step of learning an address, by the egress router, using the point/tunnel identification path used at the forwarding step and the user identifier given at the giving step.

Accordingly, since VCID fulfills the both functions of user identification and user point identification, it is possible to newly set a point-to-multipoint path to the tunnel LSP and VCID, which allows efficient frame forwarding.

The forwarding process step may comprise a setting step of setting a point/tunnel identification path for identifying a user point for multicast and a tunnel for multicast between the ingress edge router and each of plural egress edge routers, each of which removes the hierarchical path identifier given to the label switch frame forwarded from the virtual network and transmits the label switch frame to the outside of the virtual network, a giving step of giving, by the ingress edge router, the point/tunnel identification path set at the setting step to the outside of each of a plurality of the label switch frames to be forwarded to a plurality of the relay routers from the same output ports as output ports for forwarding the frames to be duplicated, and a transmitting step of transmitting, by the ingress edge router, the label switch frame given the point/tunnel identification path at the giving step to each of the relay routers through the point/tunnel identification path set at the setting step, the relaying step may comprise a forwarding step of duplicating, by the relay router, the label switch frame transmitted at the transmitting step and forwarding the same through the point/tunnel identification path set at the setting step, a forwarding step of duplicating, by each of the relay routers, the label switch frame transmitted at the transmitting step, and forwarding the same through the point/tunnel identification path set at the setting step, and a learning step of learning an address, by the egress edge router, using the point/tunnel identification path used at the forwarding step.

By doing so, a new label switched path for multicast is set between the ingress edge router and the egress edge router, whereby the egress edge router can identify the ingress edge router, and a point-to-multipoint path can be established end-to-end.

The present invention still further provides a lower layer frame virtual forwarding system comprising an ingress edge router, a relay router, and an egress edge router, each of the ingress edge router, the relay router, and the egress edge router comprising a determining unit for determining whether a received lower layer frame or a received label switch frame is to be duplicated or not on the basis of a protocol identifier of the received lower layer frame or the received label switch frame, and a forwarding process unit for passing the received lower layer frame or the received label switch frame determined not to be duplicated by the determining unit, while giving at least any one of a hierarchical path identifier for unicast, a hierarchical path identifier for multicast and a user identifier to the received lower layer frame or the received label switch frame determined to be duplicated by the determining unit, and forwarding the frame.

Accordingly, it becomes possible to cope with operations of MAC address learning in the ingress edge router and the egress edge router, and operations of multicasting and broadcasting in the MPLS network. The user, for example, can use the point-to-multipoint layer 2 VPN as a backbone of a wide area LAN service.

### BRIEF DESCRIPTION OF DRAWINGS

FIG. 1 is a schematic diagram of a structure of a MPLS-layer2-VPN according to a first embodiment of this invention

FIG. 2 is a diagram for illustrating tunnel labels and VC labels;

FIG. 3(a) is a diagram showing an example of the format of a MPLS frame for multicast according to the first embodiment of this invention;

FIG. 3(b) is a diagram showing information types included in the MPLS frame for multicast according to the first embodiment of this invention;

FIGS. 4(a) through 4(c) are diagrams for illustrating tunnel labels according to the first embodiment of this invention;

FIG. 5 is a block diagram of an ingress router according to the first embodiment of this invention;

FIG. 6 is a block diagram of a relay router according to the first embodiment of this invention;

FIG. 7 is a block diagram of an egress router according to the first embodiment of this invention;

FIG. 8(a) is a diagram showing an example of a MAC address table for multicast according to the first embodiment of this invention;

FIG. 8(b) is a diagram showing an example of a VC label table for address learning according to the first embodiment of this invention;

FIG. 8(c) is a diagram showing an example of a VC label table for multicast according to the first embodiment of this invention;

FIGS. 9(a) and 9(b) are diagrams for illustrating a frame forwarding method according to the first embodiment of this invention;

FIG. 10 is a diagram of a structure of a MPLS network according to a second embodiment of this invention;

FIG. 11 is a block diagram of an ingress router according to the second embodiment of this invention;

FIG. 12 is a block diagram of a relay router according to the second embodiment of this invention;

FIG. 13 is a diagram of a structure of a MPLS network according to a third embodiment of this invention;

FIG. 14 is a block diagram of an ingress router according to the third embodiment of this invention;

FIG. 15 is a block diagram of a relay router according to the third embodiment of this invention;

FIG. 16 is a diagram of a structure of a MPLS network according to a fourth embodiment of this invention;

FIG. 17 is a block diagram of an ingress router according to the fourth embodiment of this invention;

FIG. 18 is a block diagram of a relay router according to the fourth embodiment of this invention;

FIG. 19 is a diagram of a structure of a MPLS network according to a fifth embodiment of this invention;

FIG. 20 is a block diagram of an ingress router according to the fifth embodiment of this invention;

FIG. 21 is a block diagram of a relay router according to the fifth embodiment of this invention;

FIG. 22 is a diagram of a structure of a MPLS network according to a sixth embodiment of this invention;

FIG. 23 is a block diagram of an egress router according to the sixth embodiment of this invention;

FIG. 24 is a diagram of a structure of a MPLS network according to a seventh embodiment of this invention;

FIG. 25 is a block diagram of an egress router according to the seventh embodiment of this invention;

FIG. 26 is a diagram showing an example of LSPs for multicast according to the seventh embodiment of this invention;

FIG. 27(a) is a diagram for illustrating a VC label for multicast and tunnel labels for multicast according to the third embodiment of this invention

FIG. 27(b) is a diagram for illustrating an example of a VC label table for multicast according to the fourth embodiment of this invention;

FIG. 27(c) is a diagram for illustrating LSPs for multicast according to the fourth embodiment of this invention;

FIG. 28(a) is a diagram for illustrating an example of a frame format according to the fourth embodiment of this invention;

FIG. 28(b) is a diagram for illustrating an example of a VC label table for multicast according to the fifth embodiment of this invention;

FIG. 29 is a diagram for illustrating label switching in a MPLS network;

FIG. 30(a) is a diagram for illustrating label swapping in a MPLS network;

FIG. 30(b) is a diagram showing an example of a label table;

FIG. 31 is a diagram for illustrating PHP;

FIGS. 32(a) through 32(c) are diagrams for illustrating an example of a format of a MPLS frame;

FIG. 33(a) is a diagram for illustrating a DU mode;

FIG. 33(b) is a diagram for illustrating a DoD mode;

FIG. 34 is a diagram for illustrating a frame forwarding method defined in Draft-Martini;

FIG. 35 is a diagram for illustrating a method of assigning VC labels;

FIG. 36 is a block diagram of an ingress router;

FIG. 37 is a diagram for illustrating flooding;

FIG. 38 is a block diagram of a relay router;

FIG. 39 is a block diagram of an egress router;

FIG. 40 is a diagram for illustrating address learning;

FIG. 41 is a diagram for illustrating unicast forwarding; and

FIG. 42 is a diagram for illustrating broadcasting using a known technique.

### BEST MODE FOR CARRYING OUT THE INVENTION

### (A) Description of First Embodiment of the Invention

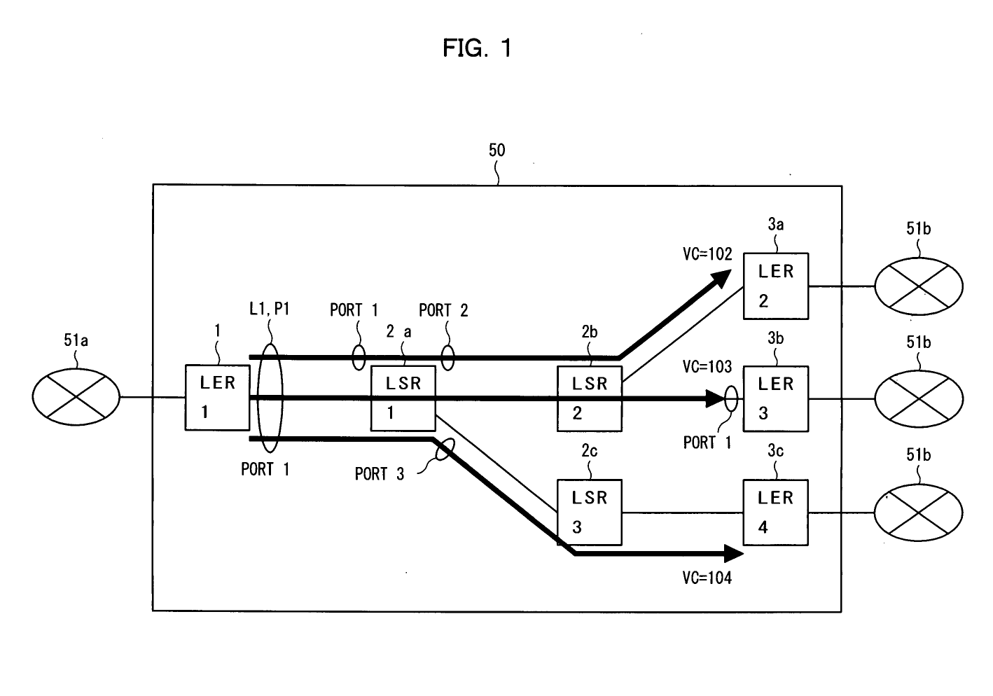

FIG. 1 is a schematic diagram of a MPLS-Layer2-VPN (a Layer 2 virtual network or a VPN network to which MPLS is applied; hereinafter referred to as a MPLS network) according to a first embodiment of this invention. An MPLS network 50 shown in FIG. 1 can transfer a layer 2 frame (lower layer frame) including a protocol identifier for identifying duplication or non-duplication and a MPLS frame (label switch frame) having hierarchical path identifiers such as a tunnel label, a VC label and the like on the basis of the tunnel label and the VC label.

Here, a thick black line connecting routers represents the VC label. The tunnel label in VPLS represents a path connecting PEs (provider edge routers, represented as LER) in the MPLS network 50.

The protocol identifier identifies both multicast, where a plurality of routers (router addresses or router destinations) are designated and the same data is transmitted thereto, and broadcast, in which data is transmitted to many and unspecified routers, as an object of duplication. The protocol identifier also identifies unicast, where a single address is designated and specific data is transmitted, as an object of non-duplication.

Meanwhile, the relationship between the lower layer and the high layer can be relatively determined.

(1) Schematic Structure

(1-1) MPLS Network 50 and User Networks 51a and 51b

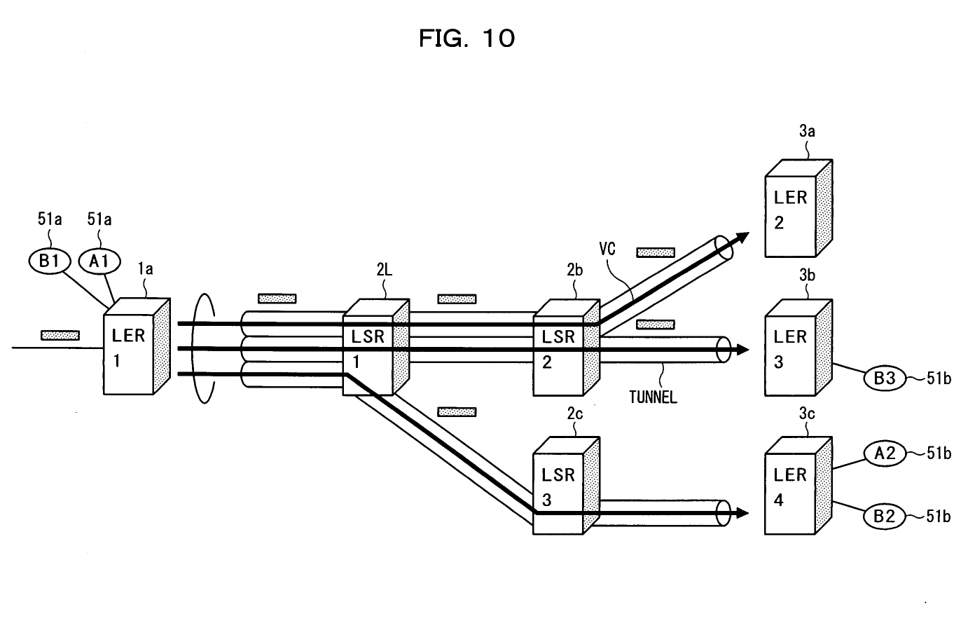

The MPLS network 50 is connected to external user networks 51a and 51b. Each of the user networks 51a and 51b is, for example, an IP network, which has LANs, IP routers, personal computers, work stations, etc. Incidentally, reference characters A1 and A2 and reference characters B1 through B4 shown in FIG. 10 designate users (communication apparatuses or communication terminals) belonging to the user networks 51a and 51b.

The MPLS network 50 forwards a MPLS frame, which is obtained by giving one or plurality of labels among an existing tunnel label, VC label and VCID, and a tunnel label and VC label for multicast to which a frame forwarding method of this invention is applied to a layer 2 frame such as an Ethernet packet or a frame in any one of various protocols, to one or plural routers belonging to the MPLS network 50. Each of the routers refers to the tunnel label, the VC label or the like to determine the forwarding path.

The MPLS network 50 comprises a number of routers coping with the MPLS, such as an ingress router (LER) 1, relay routers (LSRs) 2a through 2c and egress routers 3a through 3c. In the following description, the ingress router 1, the relay routers 2a through 2c and egress routers 3a through 3c are generally referred to simply as routers.

The direction in which a frame is forwarded in the MPLS networks 50 is, for example, a direction from the ingress router 1 toward the egress routers 3a through 3c, among a number of directions. However, the direction of forwarding can be set between desired routers.

(1-2) Tunnel Label and VC Label

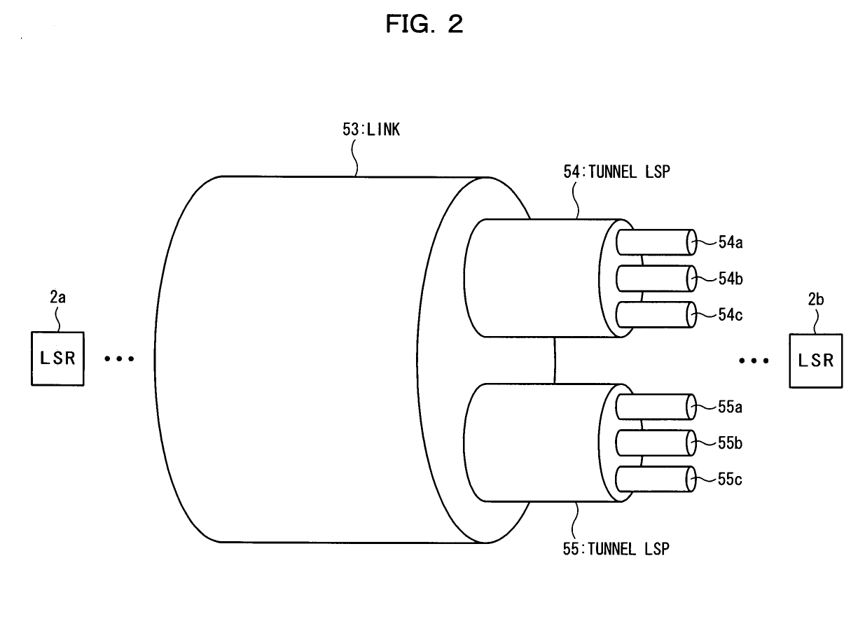

FIG. 2 is a diagram for illustrating the tunnel label and the VC label. A link 53 shown in FIG. 2 is an actual transmission path between, for example, the relay router 2a and the relay router 2b. The ingress router 1 sets two tunnel LSPs 54 and 55 in the link 53 between the ingress router 1 and any one or all of the egress routers 3a through 3c, and sets three VC labels 54a through 54c, and three VC labels 55a through 55c in the tunnel LSPs 54 and 55, respectively.

Frames that the MPLS network 50 can forward are frames having formats in various protocols such as a SONET frame and the like other than an Ethernet packet. The MPLS network 50 can give a tunnel label and a VC label to the frame to create a MPLS frame, and forward the frame (thus, referred to as MPLS).

(1-3) Packet and Frame

The user networks 51a and 51b transmit IP packets and Ethernet packets (MAC packets) to the MPLS network 50. Ethernet packet is a basic unit of forwarded data, referred to as a layer 2 packet. IP packet is given a header and encapsulated by the higher layer (for example, layer 3) of layer 2. This is called a layer-3 frame.

A frame forwarded in the MPLS network 50 is a frame given an MPLS header and encapsulated, which is referred to as an MPLS frame.

The MPLS network 50 transmits a frame obtained by removing the header of the MPLS frame to each of the user networks 51a and 51b. In concrete, the MPLS network 50 transmits an original packet or frame before forwarded to the MPLS network. Namely, IP packets, Ethernet packets and the like are transmitted.

In the following description, the above packets and frames are transferred, unless specifically mentioned.

(1-4) Ingress Router 1, Relay Routers 2a Through 2c and Egress Routers 3a Through 3c

The ingress router 1 (FIG. 1) is configured as an ingress edge router which pushes an MPLS frame, which is obtained by giving a tunnel label and a VC label to an Ethernet packet from the outside of the MPLS network 50, to the MPLS network 50. The ingress router 1 functions as an initial node disposed at an edge at which the MPLS network 50 is connected to the user network 51a. The ingress router 1 communicates with the relay router 2a belonging to the MPLS network 50 and other relay routers belonging to the MPLS network 50.

Each of the relay routers 2a through 2c is configured as a relay router, which forwards an MPLS frame to the MPLS network 50 on the basis of the tunnel label and the VC label. For example, the relay router 2a refers to the tunnel label and the VC label included in the MPLS frame, forwards the frame to the other relay routers 2b and 2c, the ingress router 1, one or all of the egress routers 3a through 3c and the like. The relay router 2a also learns an address. Like the relay router 2a, the relay routers 2b and 2b forwards the MPLS frame.

Each of the egress routers 3a through 3c is configured as an egress edge router, which removes the tunnel label and the VC label given to the MPLS frame forwarded from the MPLS network 50, and transmits the frame to the outside of the MPLS network 50. Each of the egress routers 3a through 3c also functions as a terminal node in the MPLS network 50.

Each of the relay routers 2a through 2c, which are disposed between the ingress router 1 which is the start node of the LSP (Label Switching Path) and the egress router 3a, 3b or 3c which is the end of the LSP, has a label table holding a relationship between a reception label and transmission label of the MPLS frame. The routing in the MPLS network 50 is performed on the basis of the label tables. Each of the relay routers 2a through 2c refers to the label table, swaps the tunnel label and the VC label of the received frame, and forwards the frame.

Whereby, the external frame (or the external packet) forwarded from the user network 51a to the MPLS network 50 is given (a tunnel label and VC label) or (VCID) selected among a tunnel label and VC label in the existing technique, a tunnel label and VC label newly defined by applying this invention, a VCID and the like to be described later by the ingress router 1 to be formed into an MPLS frame, and the frame is forwarded to the following relay router 2a.

The label of the MPLS frame is referred by the relay router 2a to determine a router to which the frame is to be forwarded. The label of the MPLS frame is replaced with a label assigned to the relay router 2b or 2c in the following stage, and the frame is forwarded. The MPLS frame forwarded in the MPLS network 50 is outputted from each of the egress routers 3a through 3c to the user networks 51a and 51b.

Incidentally, the MPLS frame can be forwarded from each of the egress routers 3a through 3c to the ingress router 1 in the MPLS network 50. However, this embodiment is described by way of example where the frame is transferred from the ingress router 1 to each of the egress routers 3a through 3c, unless specifically mentioned.

(2) Frame Format

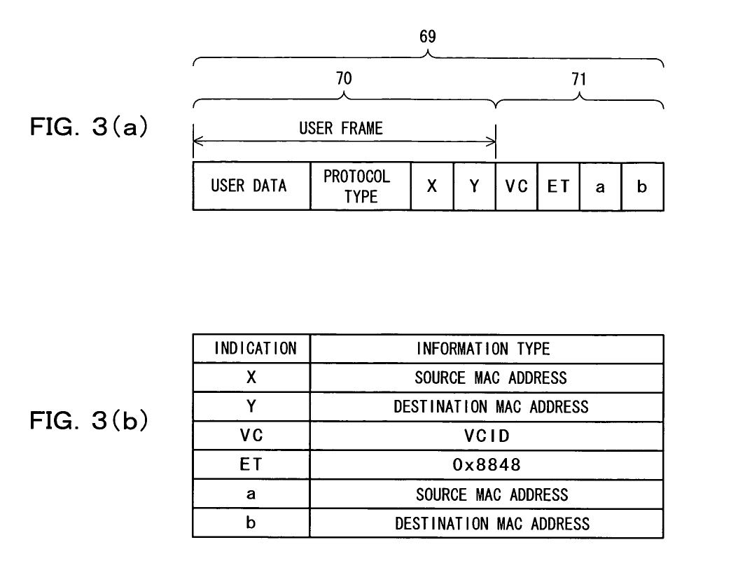

FIG. 3(a) is a diagram showing an example of format of the MPLS frame for multicast according to the first embodiment of this invention. FIG. 3(b) is a diagram showing types of information included in the MPLS frame for multicast according to the first embodiment of this invention. An MPLS frame for multicast 69 shown in FIG. 3(a) has a layer 2 frame (user frame) 70 including “protocol type” (protocol identifier) for identifying duplication or non-duplication, and an MPLS header 71 in which header information (tunnel label and VC label) used for MAC bridging process to be described later is written.

The layer 2 frame 70 shown in FIG. 3(a) has fields (regions) of “user data,” “protocol type,” source MAC address “X,” destination MAC address “Y,” etc.

The MPLS header 71 shown in FIG. 3(a) has fields of “VC,” “ET,” “a” and “b.” Each of the fields are attached in order to the outside of the layer 2 frame 70. Namely, the fields are stacked.

Here, “VC” is a field showing a VCID (user identifier) such as “1234” or the like. “ET” is a field showing “protocol type” of the frame, representing, for example, an Ether packet, in which “x8848” (0x representing a hexadecimal number) or the like is written. “a” is “source MAC address” (for example, p1). “b” is “destination MAC address,” in which “0xFFFFFFFFFFFF” or the like representing broadcast is written.

Here, the source MAC address and destination MAC address are included in both the layer 2 frame and the MPLS frame. The ingress router 1 duplicates “source MAC address” and “destination MAC address” in the layer 2 frame onto “source MAC address” and “destination MAC address” of the MPLS frame, and writes the same therein. Namely, with respect to a layer 2 frame, the ingress router 1 writes “destination MAC address in the user frame” into “destination MAC address” of the layer 2 header when the layer 2 frame is a multicast frame. When the layer 2 frame is a broadcast frame, the ingress router 1 writes “0xFFFFFFFFFFFF” into “destination MAC address” of the layer 2 header. When the destination of the frame is unknown, the process performed by the ingress router 1 is the same as broadcasting.

The ingress router 1 writes a MAC address “p1” of its own into “source MAC address” shown as “a” in the layer 2 header, and writes “0x8848” into “Ether type.”

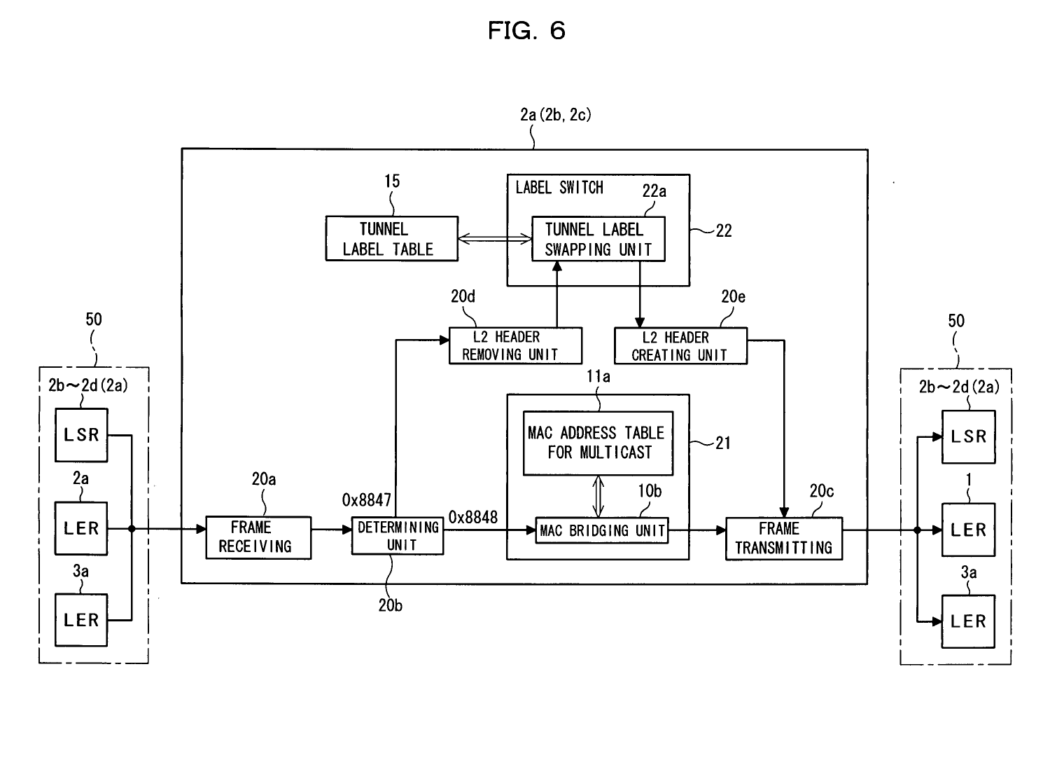

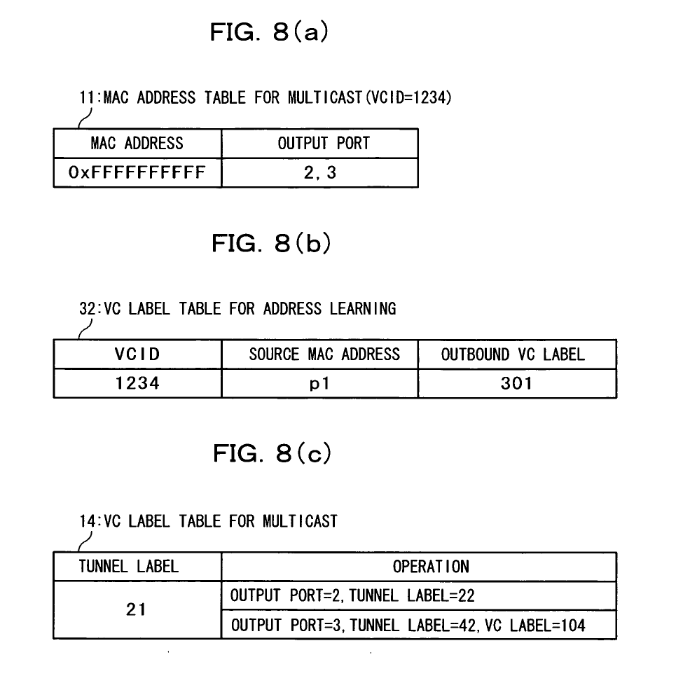

Each of the relay routers 2a through 2c refers to “Ether type” of the layer 2 header of the received frame, identifies it as multicast, and outputs the received frame to a MAC bridge process unit 10b (refer to FIG. 6). The MAC bridge process unit 10b retrieves in a MAC address table for multicast 11a [FIG. 8(a)] to acquire information about whether the destination MAC address “0xFFFFFFFFFFFF” or the multicast address included in the received frame has been registered or not, and determines an output port from which the frame is to be transmitted.

As above, each of the routers (the ingress router 1, the relay routers 2a through 2c and the egress routers 3a through 3c) refers to the outer portion of the MPLS header 71, and processes the MPLS frame.

(3) An Example of VC Label and Tunnel Label in MPLS Network 50

VC labels of LSPs from the ingress router 1 to the egress routers 3a through 3c shown in FIG. 1 are related to output ports, respectively, which are set as 102, 103 and 104, for example.

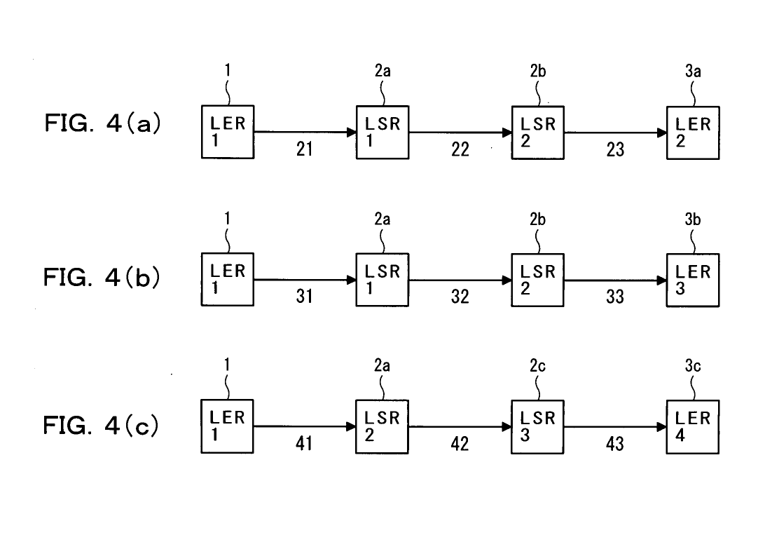

FIGS. 4(a) through 4(c) are diagrams for illustrating tunnel labels according to the first embodiment of this invention. In FIGS. 4(a) through 4(c), like reference characters designate like or corresponding parts having been described with reference to FIG. 1. Each of tunnel labels (label values 21 to 23) shown in FIG. 4(a) is given to a section between neighboring routers. For example, before the frame is forwarded, the tunnel label value 21 is set to a section between the ingress router 1 and the relay router 2a, the tunnel label value 22 between the relay router 2a and the relay router 2b, and the tunnel label value 23 between the relay router 2b and the egress router 3a. Similarly, tunnel label values (for example, 31 to 33, and 41 to 43) of the tunnel labels are beforehand set between the ingress router 1 and the egress router 3b, and between the ingress router 1 and the egress router 3c. Note that various values may be used for the tunnel label values.

(4) Structure of Ingress Router 1

The ingress router 1 forwards MPLS frames from the relay routers 2a through 2c to the user network 51a, and forwards multicast frames, broadcast frames and unicast frames from personal computers, work stations, LANs and the like (hereinafter referred to as user sites) belonging to the user network 51a to the relay routers 2a through 2c in the MPLS network 50.

The ingress router 1 reads “protocol type” [refer to FIG. 3(b)] included in a layer 2 frame from the user network 51a to determine the cast type. The ingress router 1 can transmit a broadcast frame or a multicast frame to each of the egress routers 3a through 3c, addressing to the relay routers 2a through 2c and the like belonging to the same MPLS network 50 having the user identifier VCID “1234.”

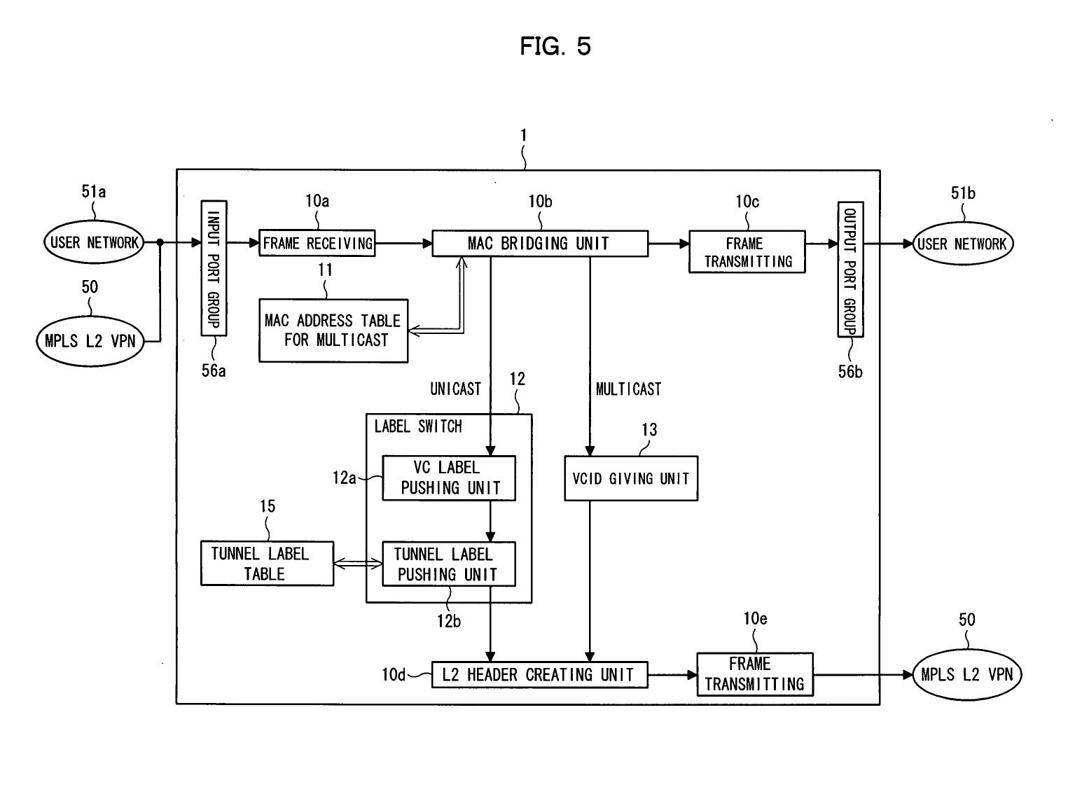

FIG. 5 is a block diagram of the ingress router 1 according to the first embodiment of this invention. The ingress router 1 shown in FIG. 5 comprises a frame receiving unit 10a, the MAC bridge process unit (determining unit: also referred to as a MAC bridging unit) 10b, a first frame transmitting unit 10c, a MAC address table for multicast 11, a label switching unit 12, a tunnel label table 15, a VCID giving unit (VCID giving unit) 13, a L2 header creating unit 10d, a second frame transmitting unit 10e, an input port group (receiving port group) 56a and an output port group (transmitting port group) 56b.

The input port group 56a has a plurality of receiving ports for packets or frames. The frame receiving unit 10a receives both a frame from the user network 51a and frames from the relay routers 2a through 2c via the plural input ports. The output port group 56b has a plurality of transmitting ports for packets or frames. The first frame transmitting unit 10c forwards MPLS frames from the relay routers 1c through 2c via the plural output ports to the user network 51b, and transmits a frame from the MAC bridge process unit 10b.

The MAC bridge process unit 10b determines whether a received layer 2 frame is to be duplicated or not on the basis of the protocol identifier of the received layer 2 frame, which functions as a determining unit. The label switching unit 12, the VCID giving unit 13, the tunnel label table 15, the LS header creating unit 10d, the second frame transmitting unit 10e function in cooperation as a forwarding process unit for passing a received layer 2 frame determined not to be duplicated by the MAC bridge process unit 10b, while forwarding an MPLS frame obtained by giving a tunnel label and a VC label to the received layer 2 frame determined to be duplicated by the MAC bridge process unit 10b.

Accordingly, the forwarding process unit gives a VC label (user point identification label) showing the ingress router 1 which is a user point of the forwarding source of the frame to be duplicated and a tunnel LSP label showing a virtual path for the frame to be duplicated, and forwards the frame.

When the number of the LSPs is increased, it is possible to suppress an increase in number of the entries, and prevent the tunnel label switching process (switching process) from being complicated.

The MAC bridge processing unit 10b determines which the frame from the user network 51a is a unitcase frame, a multicast frame, a broadcast frame or a unicast frame whose destination is unknown, and forwards the determined frame. In concrete, the MAC bridge process unit 10b outputs a unicast frame to the label switching unit 12, or outputs a multicast frame, a broadcast frame and a frame whose destination is unknown to the VCID giving unit 13. In order to determine the type, the MAC bridge process unit 10b refers to the MAC address table for multicast 11.

FIG. 8(a) is a diagram showing an example of the MAC address table for multicast 11 according to the first embodiment of this invention. In the MAC address table for multicast 11 shown in FIG. 8(a) a MAC address and a plurality of output ports for each user (for each VCID) are related and held. Whereby, the MAC bridge process unit 10b determines whether to duplicate the received frame or not.

When “source MAC address” of the received frame is “0xFFFFFFFFFFFF,” the MAC bridge process unit 10b determines that the received frame is a broadcast frame, and outputs the received frame to the output ports 2 and 3. The MAC bridge process unit 10b outputs a frame, which is from the MPLS network 50 to the user network 51b, to the first frame transmitting unit 10c (refer to FIG. 5, for example).

Accordingly, the MAC bridge process unit 10b fulfils a function of distributing frames on the basis of “destination MAC address.”

The label switching unit 12 (FIG. 5) sets a tunnel label and a VC label for a section between the ingress router 1 and each of the egress routers 3a through 3c before forwarding the frame. The label switching unit 12 gives a VC label and a tunnel label to a frame determined to be a unicast frame by the MAC bridge process unit 10b, and outputs the frame. The label switching unit 12 comprises a VC label pushing unit 12b for giving a VC label to a frame and outputting the frame, and a tunnel label pushing unit 12b for giving a tunnel label to the frame and outputting the frame. Incidentally, the tunnel label pushing unit 12b will be described later.

Accordingly, the load of duplicating the same MPLS frames on the ingress router 1 can be decreased.

The VCID giving unit 13 (FIG. 5) gives a VCID and “protocol type” to a frame determined to be a multicast frame by the MAC bridge processing unit 10b, and outputs the frame given the VCID and “protocol type” to the L2 header creating unit 10d to give transmission/reception MAC addresses.

In concrete, the VCID giving unit 13 writes “1234” and “0x8848” into the VC and “protocol type” of the MPLS header 71 of the mtulticast MPLS frame [FIG. 3(a)], and sets the source MAC address “a” of the frame to the MAC address “p1” of the ingress router 1 itself. Further, when the received frame is a multicast frame, the VCID giving unit 13 sets “Y” to the destination MAC address of the layer 2 frame 70 [FIG. 3(a)]. When the received frame is a multicast frame or a frame whose destination is unknown, the VCID giving unit 13 sets “0xFFFFFFFFFFFF” to the destination MAC address. Whereby, MPLS frames are generated, and transmitted from the ingress router 1 to the relay routers 2a through 2c.

As above, the ingress router 1 gives a user identifier VCID to a multicast frame received from the user site, gives a layer 2 address of the output port to “source MAC address” of the layer 2 header, selects multicast MPLS (0x8848) as “protocol type” and writes the same, encapsulates the frame, and forwards the encapsulated frame to the MPLS network (MPLS LS VPN) 50.

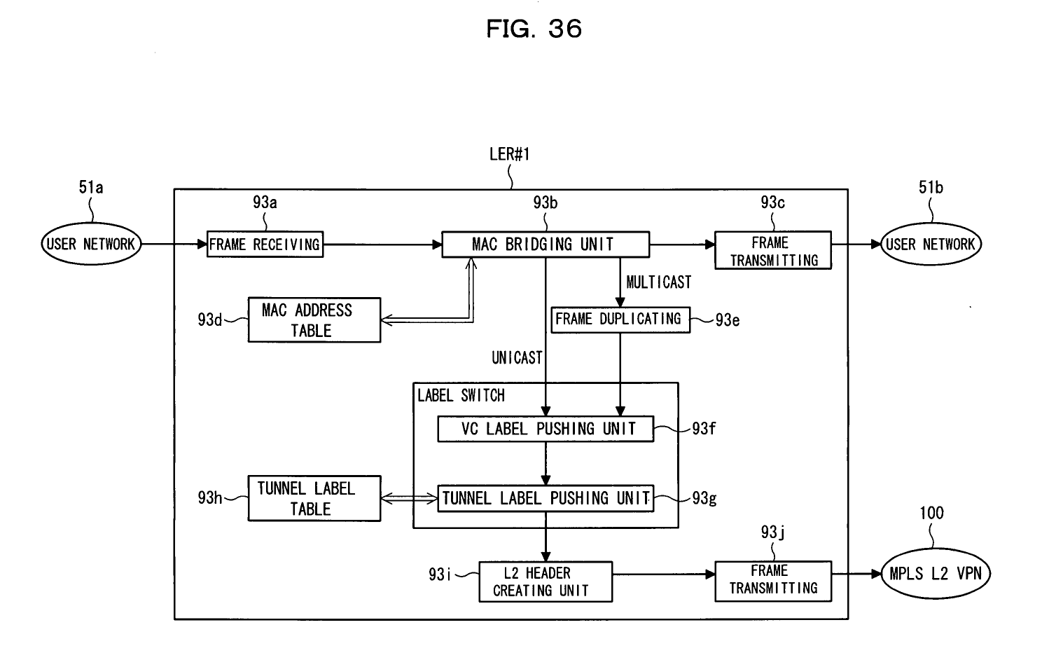

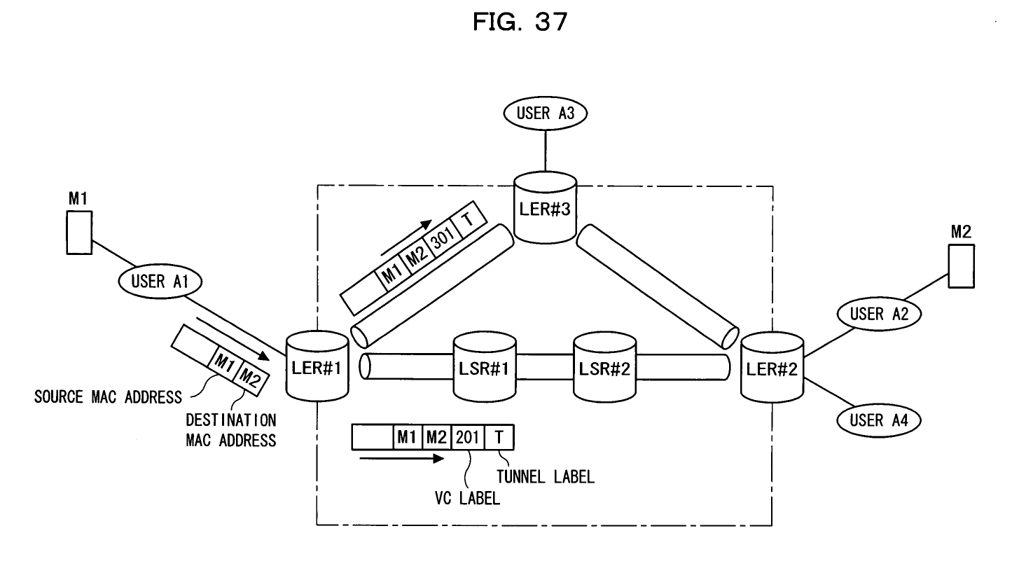

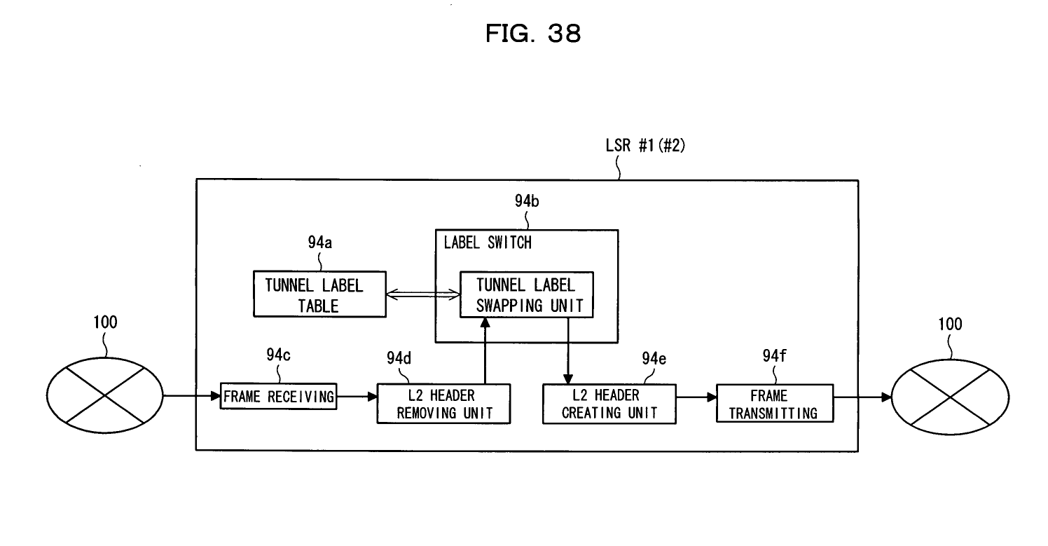

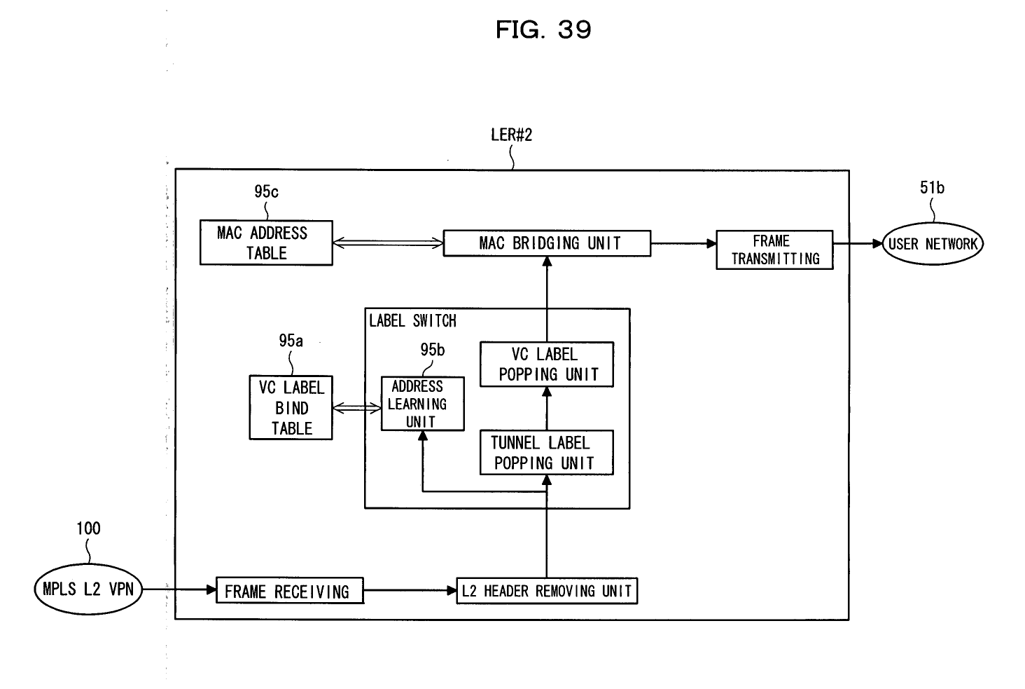

As compared the ingress router of this invention with the known ingress router #1 (refer to FIG. 36), the known ingress router #1 duplicates a frame determined to be a multicast frame, a broadcast frame or a unicast frame whose destination is unknown by the MAC bridge process unit 93b, whereas the ingress router 1 of this invention outputs only a frame obtained by giving a VCID to a multicast frame.

Accordingly, it is possible to prevent a plurality of frames from transmitted between the ingress router 1 of this invention and, for example, the relay router 2a in the following stage.

The L2 header creating unit 10d (refer to FIG. 5) creates an MPLS header of a frame outputted from the tunnel label pushing unit 12b or the VCID giving unit 13. The second frame transmitting unit 10e transmits a frame, which is sent from the user network 51a outputted from the LS header creating unit 10d, to the MPLS network 50.

A unicast frame whose destination is not unknown among layer 2 unicast frames from the user network 51a is given labels in the ingress router 1, and forwarded to the MPLS network 50, whereby point-to-multipoint communication is accomplished. On the other hand, when the layer 2 frame from the outside is a multicast frame, a broadcast frame or a unitcast frame whose destination is unknown, the frame is not forwarded but bridged to the MPLS network 50 as it is. Namely, this bridging is performed on the basis of the MAC address table to forward the frame in Layer 2. The MPLS frame from the MPLS network 50 is forwarded and bridged to the user network 51b.

(5) Relay Routers 2a Through 2c

FIG. 6 is a block diagram of the relay router 2a according to the first embodiment of this invention. The relay router 2a shown in FIG. 6 comprises a frame receiving unit 20a, a determining unit 20b, a MAC bridge managing unit 21, a first frame transmitting unit 20c, an L2 header removing unit 20d, a label switching unit 22, a tunnel label table 15 and an L2 header creating unit 20e. Incidentally, each of the relay routers 2b and 2c is similar in structure to the relay router 2a.

The frame receiving unit 20a receives frames from the relay routers 2b and 2c, and the ingress router 1.

The determining unit 20b determines whether a MPLS frame is to be duplicated or not on the basis of “protocol type” included in the MPLS frame. When the physical layer is Ethernet, “0x8848” is written in “protocol type” of the received frame [refer to FIG. 3(a)] in the case of multicast MPLS or “0x8847” in the case of unicast MPLS. When the physical layer is SONET or SDH (Synchronous Digital Hierarchy), “0x0283” is written in the “protocol type” in the case of multicast MPLS or “0x0281” in the case of unicast MPLS.

When the physical layer is in Ethernet, SONET or SDH protocol, the types of frames applied various protocols such as multicast MPLS, unicast MPLS and the like are determined. A frame whose protocol cannot be determined is discarded.

Note that these are de-fact standards, which are international standards for high-speed digital communication systems using optical fibers. SDH can be used for backbone lines of the Internet connecting Internet service providers. SDH is mainly used in Europe, but called SONET in North America. To avoid confusion, this is generally inscribed as SONET/SDH. SONET/SDH defines mainly specifications of the physical layer. ATM (Asynchronous Transfer Mode) is mostly used for the protocol of the data link layer.

ATM is a technique for high-speed information communications, where a data string having a fixed length of 53 bytes (ATM cell) is used as a unit to transmit and receive information. Since ATM can forward at a high speed of 156 Mbps with optical fibers, ATM is used when lines of large capacity for connecting LANs are required.

Each of the relay routers 2a through 2c can forward MPLS frame in Ethernet, and identify a multicast MPLS frame. In PoS, each of the relay routers 2a through 2c can forward a MPLS frame, and identify a multicast MPLS frame. The relay routers 2a through 2c have the frame identifying function in second and later embodiments to be described later, as well.

The MAC bridge managing unit 21 (FIG. 6) bridges a frame when the determining unit 20b determines that the frame is a multicast MPLS packet. The MAC bridge managing unit 21 comprises the above MAC bridge process unit 10b, and an address table for multicast 11a almost the same as that of the MAC bridge process unit 10b provided in the ingress router 1.

(5-1) MAC Address Table for Multicast 11a

In the MAC address table for multicast 11a, a MAC address and output ports are related to each other and held. The MAC bridge process unit 10b can enter an entry in the MAC address table for multicast 11a. The MAC bridge process unit 10b enters a relationship between a MAC address of a processed frame and output ports in the MAC address table for multicast 11a, whereby each of the egress routers 3a through 3c learns an address of a layer 2 frame 70 [FIG. 3(a)] from the received multicast frame.

The MAC address table for multicast 11a is generated in a manner that the relay router 2a exchanges a GMRP message frame (IEEE 802.1D) advertising a multicast address desiring to receive over Ethernet or a GVRP (IEEE 802.1Q) message frame advertising a VLAN tag desiring to receive with routers belonging to the user network 51a. Alternatively, the MAC address table for multicast 11a is generated manually by a service providing entity such as a service provider or the like.

When entering a multicast MAC address using the GMRP message or GVRP message, it is necessary to identify the MPLS network 50 (user VPN) to which a user apparatus having the multicast MAC address belongs. For this, in exchanging the both messages or the like, the forwarding source router of the user gives a VCID to shim headers [refer to FIG. 4(a)] of the both messages. It is preferable to use STP (Spanning Tree protocol: IEEE 802.1D) in order to avoid a loop and wasteful forwarding of the multicast frame.

The first frame transmitting unit 20c provided on the output's side of the MAC bridge process unit 21 (FIG. 6) transmits a frame outputted from the MAC bridge process unit 10b or a frame outputted from the L2 header creating unit 20e to the ingress router 1, the egress router 3a, the relay routers 2b and 2c, or the like. The first frame transmitting unit 20c has a plurality of output ports.

(5-2) Received Frame Processing Method

The determining unit 20b reads “protocol type” of a received frame from the relay router 2b or 2c, the ingress router 1 or the egress router 3a belonging to the MPLS network 50. When the “protocol type” is “0x8848,” the determining unit 20b determines that the frame is a multicast Ethernet packet, and inputs the received frame to the MAC bridge managing unit 21. When the “protocol type” is “0x8847,” the determining unit 20b determines that the received frame is a unicast Ethernet packet, and inputs the received frame to the L2 header removing unit 20d.

With respect to the frame determined to be a multicast MPLS, the MAC bridge managing unit 21 retrieves in the MAC address table for multicast 11a [FIG. 8(a)] having the VCID of “1234.” On the basis of a result of the retrieval, the frame having a destination MAC address “0xFFFFFFFFFFFF” is forwarded to each of the output ports 2 and 3, whereby the forwarding destinations of the frame are determined.

The MAC bridge process unit 10b duplicates the frame as required, and forwards the frame. In concrete, when the MAC address is “0xFFFFFFFFFFFF,” the MAC bridge process unit 10b recognizes that the frame is a broadcast frame or a frame whose destination is unknown, and outputs the frame to each of the output ports 2 and 3 of the frame transmitting unit 20c.

As above, a packet determined to be multicast MPLS is bridged by each of the relay routers 2a through 2c.

(5-3) Forwarding Process Unit

The L2 header removing unit 20d (FIG. 6) removes the header of a frame determined to be a unicast frame by the determining unit 20b.

The label switching unit 22 gives a tunnel label to the unicast frame outputted from L2 header removing unit 20d. The label switching unit 22 comprises a tunnel label swapping unit 22a for replacing the tunnel label for the relay router 2b or 2c in the following stage. The tunnel label swapping unit 22a retrieves in the tunnel label table 15 and gives a tunnel label.

The tunnel label swapping unit 22a retrieves in the tunnel label table 15. When the received label value is registered (when there is an entry), the tunnel label swapping unit 22a gives a tunnel label to the received frame, and outputs the frame. When there is no register of the received label value (when there is no entry), the tunnel label swapping unit 22a discards the received frame.

Since the entry is prepared for each of established LSPs, it is preferable that the tunnel label swapping unit 22a decreases the entries in the tunnel label table 15 by merging (putting together or bundling) a plurality of tunnel labels or using the hierarchical technique such as stacking or the like.

The L2 header creating unit 20e creates an L2 header for the frame outputted from the label switching unit 22, and outputs the frame to which the L2 header has been given to the frame transmitting unit 20c.

The MAC bridge managing unit 21, the first frame transmitting unit 20c, the L2 header removing unit 20d, the label switching unit 22, the tunnel label table 15 and the L2 header creating unit 20e function in cooperation as a forwarding process unit. Namely, the forwarding process unit bridge-forwards a MPLS frame determined to be a frame not to be duplicated by the determined unit 20b, while duplicating a frame determined to be a frame to be duplicated by the determining unit 20b and the replacing the VC label and the tunnel LSP label thereof.

The relay routers 2b and 2c are similar in structure to the relay router 2a.

(5-4) Label Processing

In the MPLS network 50, a multicast frame, a broadcast frame or a unicast frame whose destination is unknown received from a user site is required to be transmitted to a plurality of user sites belonging to the same MPLS network 50. For this, the MPLS frame is duplicated in the relay routers 2a through 2c in the MPLS network 50 as required.

Accordingly, it is possible to prevent the same frame from being duplicated and forwarded in the same link, and prevent an increase in load on the MPLS network 50.

A MPLA frame in an existing MPLS network is forwarded in the label processing in each of the relay routers 2a through 2c. On the other hand, in this MPLS network 50, a multicast frame and a broadcast frame are both forwarded in the MAC bridging process. The ingress router 1 gives “0x8847” to “Ether type” of the unicast frame, while giving “0x8848” to “Ether type” of the multicast frame when encapsulating the layer 2 frame, whereby each of the relay routers 2a through 2c and the egress routers 3a through 3c can identify the frame type.

Accordingly, it is possible to reduce the burden of the label process on each of the relay routers 2a through 2c.

(6) Egress Routers 3a Through 3c

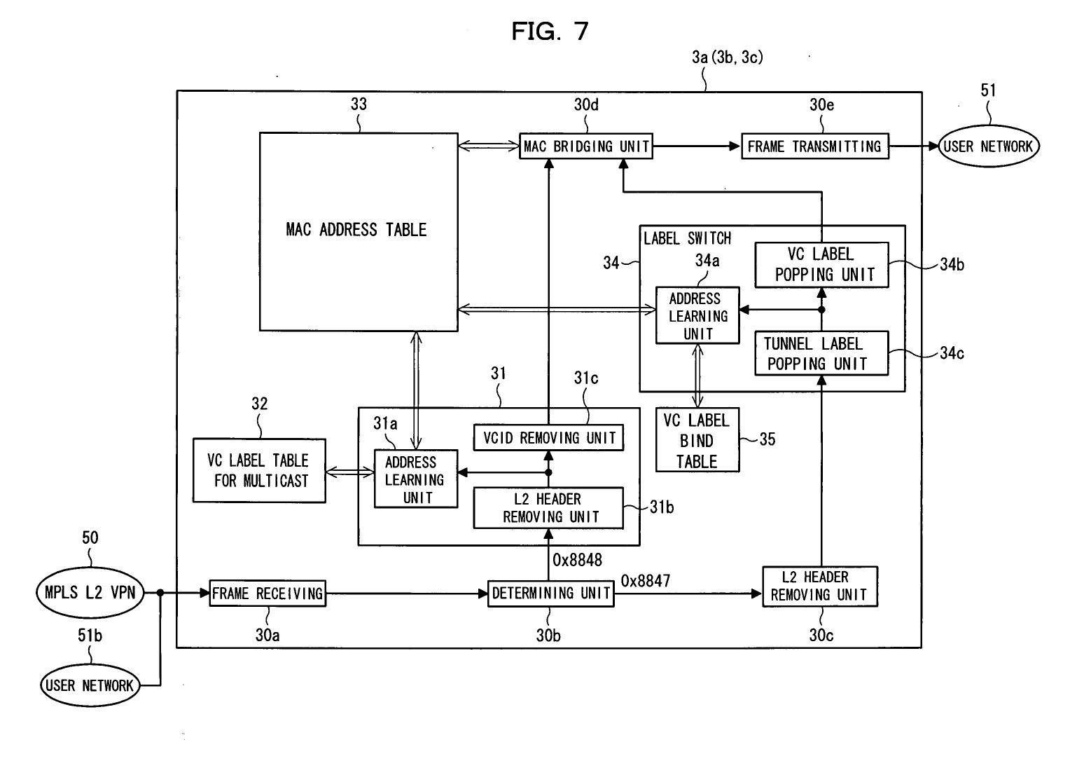

FIG. 7 is a block diagram of the egress router 3a according to the first embodiment of this invention. The egress router 3a shown in FIG. 7 comprises a frame receiving unit 30a, a determining unit 30b, a popping process unit 31, a VC label table for multicast 32, an L2 header removing unit 30c, a label switching unit 34, a VC label bind table 35, a MAC address table 33, a MAC bridge process unit (MAC bridging unit) 30d and a first frame transmitting unit 30e. The egress routers 3b and 3c have the same structure as the egress router 3a.

(6-1) Frame Reception and Frame Determination

The frame receiving unit 30a receives a MPLS frame from the relay router 2a, 2b or 2c belonging to the MPLS network 50, and a layer 2 frame from the user network 51a. The determining unit 30b determines the frame type of the received frame from the frame receiving unit 30a. The determining unit 30b reads “protocol type” of the received frame. When the “protocol type” is “0x8848” or “0x8847,” the determining unit 30b determines that the received frame is multicast MPLS or unicast MPLS. When the determining unit 30b cannot read “protocol type” of the received frame, the determining unit 30b determines that the received frame is a frame whose destination is unknown, and discards the frame.

(6-2) Unicast Frame Processing

The L2 header removing unit 30c removes the layer 2 header of the received frame determined to be a unicast frame by the determining unit 30b.

The label switching unit 34 has a label removing function of removing (popping) the tunnel label or the VC label (or the both labels as required) from the frame sent from the L2 header removing unit 30c, and an address learning function of learning the MAC address and the VC label of the frame whose tunnel label has been removed.

A tunnel label popping unit 34c removing the tunnel label from the received frame and a VC label popping unit 34b removing the VC label are in cooperation to fulfill the label removing function.

The MAC bridge process unit 30d refers to the MAC address table 33 with respect to the frame (frame whose LS header and VCID both have been removed) sent from the VCID removing unit 31c of the popping process unit 31 to bridge the frame, while bridging the frame whose VC label has been removed by the label switching unit 34.

The first frame transmitting unit 30e transmits the frame sent from the MAC bridge process unit 30d to the user network 51b.

(6-3) Address Learning

The address learning unit 34a, the VC label bind table 35 and the MAC address table 33 cooperate with one another to fulfill the address learning function.

The VC label bind table 35 relates “source MAC address” to “VC label,” and holds them. The address learning unit 34a refers to the VC label and the MAC address in the VC label bind table 35 to learn them.

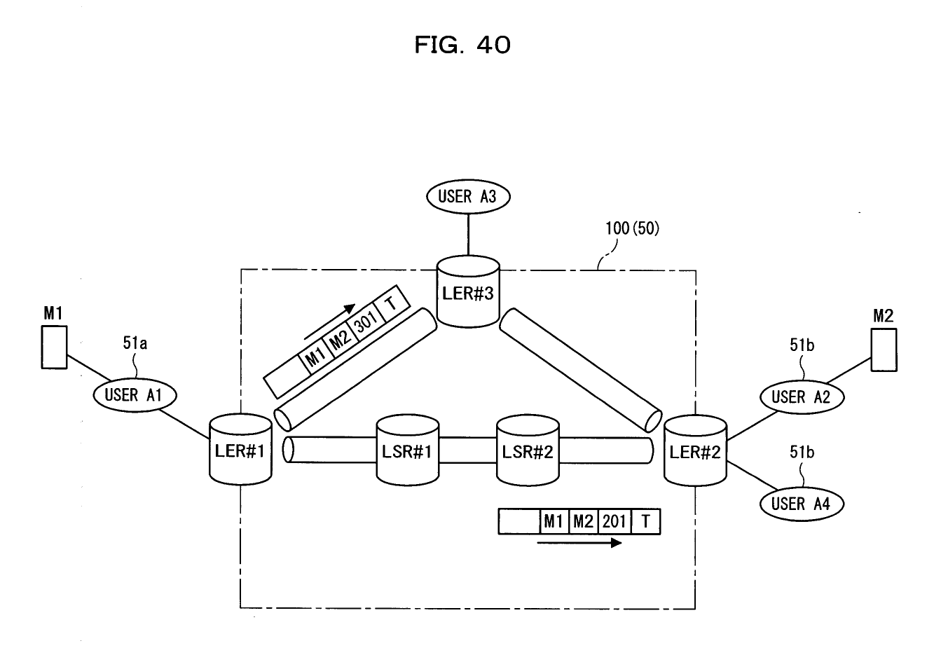

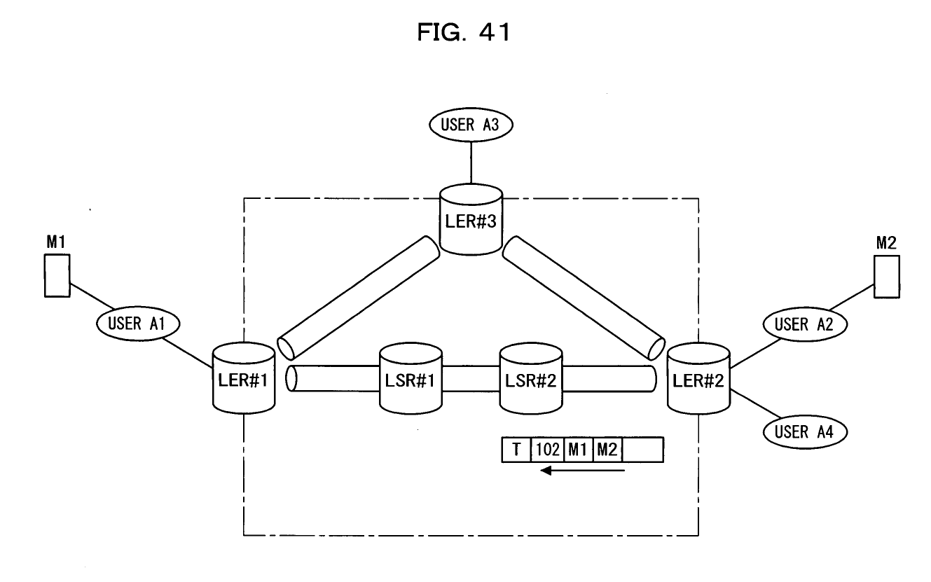

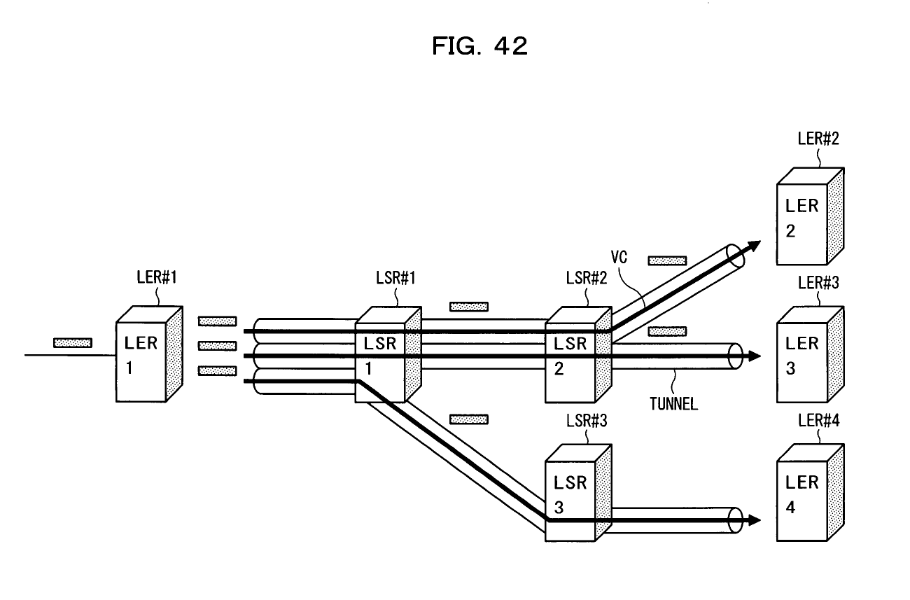

FIG. 40 is a diagram for illustrating the address learning method. In FIG. 40, like reference characters designate like or corresponding parts described above. User sites A1, A2 and A3 having the same VCID (representing sites functioning as the same VPLS segments) are connected to the MPLS network 50. Between the user site A1 having a MAC address M1 and the user site A2, layer 2 frames are transmitted and received.

When the ingress router #1 receives a frame having the MAC address M1, with both the ingress router #1 and the egress router #2 having no entry of the MAC addresses M1 and M2, the ingress router #1 gives a VC label (for example, 201) to the frame, and forwards the MPLS frame.

The egress router #2 receives the forwarded MPLS frame, obtains 201 of the VC label, refers to the VC label bind table 35 (FIG. 7), relates the MAC address M1 to a VC label (for example, 102) which represents the direction from the egress router #2 toward the ingress router #1 (that is, the opposite direction to the direction in which the frame is forwarded), and makes an entry in the MAC address table 33 (FIG. 7). Whereby, the MAC address M1 is learned.

When receiving a frame having a destination MAC address M1 from the user site A4, the egress router 3a retrieves the MAC address M1 in the MAC address table 33 (FIG. 7), and obtains the VC label 102 corresponding to the MAC address M1. The egress router 3a sets 102 to the VC label in the received frame, and forwards the MPLS frame to the MPLS network 50.

As above, between the ingress router 1 and the egress router 3a, the address learning is performed.

(6-4) Multicast Frame Processing

The popping process unit 31 shown in FIG. 7 fulfills a function as a forwarding process unit. The popping process unit 31 learns a relationship between a tunnel label and a VC label, and transmits a layer 2 frame whose tunnel label and VC label have been removed to the outside of the MPLS network 50. The popping process unit 31 comprises a L2 header removing unit 31b removing the L2 header from an encapsulated received frame, a VCID removing unit 31c removing the VCID from the received frame, and an address learning unit 31a learning the source address (SA: Source Address; source MAC address) and the outbound VC label of the received frame from the VC label table for multicast 32.

The VC label table for muticast 32 relates “VCID,” “source MAC address (SA)” and “outbound VC label” to one another as shown in FIG. 8(b), for example, and holds them. The VC label table for address learning 32 is created by exchanging messages between the egress router 3a and the ingress router 1.

The popping process unit 31 (FIG. 7) determines the source address of the source ingress router that the popping process unit 31 still does not know on the basis of “source MAC address” included in the L2 header of the received frame, refers to the VCID of the VC label included in the frame and the VC label table for multicast obtained from the source ingress router 1 to establish information in the VC label table for address learning 32 [FIG. 8(b)].

The MAC address table 33 relates a MAC address and a VC label, and holds them. The address learning and bridging process are performed by referring to the MAC address table 33.

When the frame receiving unit 30a receives a frame from the MPLS network 50 and the determining unit 30b determines that the frame is a multicast frame, the address learning unit 31a retrieves in the VC label table for muticast 32 on the basis of VCID “1234” and source MAC address “p1” to obtain a VC label (for example, 301). Further, the address learning unit 31a enters the VCID “1234” in the MAC address table 33 set for each VCID, with the VC label “301,” the MAC address “X” and the output port “1” being a set of entries.

The layer 2 frame from the user network 51a is forwarded in the MPLS network 50 on the basis of its source MAC address, and transmitted to only the egress router 3a, for example, connected to the destination user site.

Accordingly, it is possible to avoid wasteful frame duplication and frame forwarding between the ingress router 1 and the egress routers 3a through 3c, and decrease the load on the MPLS network 50.

As above, it is possible to prevent redundant or unnecessary frame forwarding, thus to effectively use the band in the MPLS network 50.

(7) Lower Layer Frame Virtual Forwarding System

The MPLS network (virtual network system) 50 of this invention comprises the ingress router 1, the relay routers 2a through 2c and the egress routers 3a through 3c. Each of the ingress router 1, relay routers 2a through 2c and egress routers 3a through 3c has the determining unit (10b, 20b or 30b) for determining whether a received layer 2 packet or a received MPLS frame is to be duplicated or not on the basis of the protocol identifier of the received layer 2 packet or the received MPLS frame, and the forwarding process unit for passing the received layer 2 packet or the received MPLS frame determined not to be duplicated by the determining unit (10b, 20b or 30), while giving a tunnel label and VC label for unitcast, a tunnel label and VC label for multicast and a VCID (user identifier) to the received layer 2 frame or the received MPLS frame determined to be duplicated by the determining unit (10b, 20b or 30b) and forwarding the frame.

(8) Description of Operation

A frame forwarding method according to the first embodiment of this invention, with the above structure, will be now described in detail with reference to FIGS. 3(a), 8(b), 9(a) and 9(b).

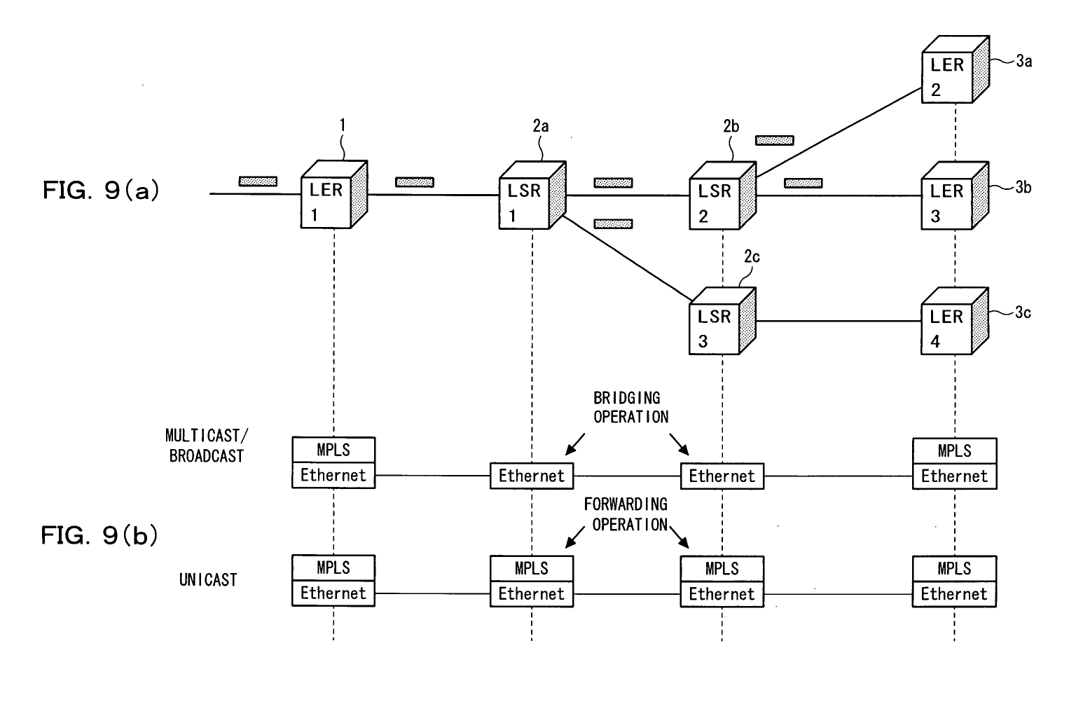

FIGS. 9(a) and 9(b) are diagrams for illustrating the frame forwarding method according to the first embodiment of this invention. In FIG. 9(a), like reference characters designate like or corresponding parts described above.

A first frame forwarding method (mode 1) of this invention is performed in the MPLS network 50 which can forward a layer 2 frame containing a protocol identifier for identifying duplication or non-duplication and an MPLS frame having a tunnel label and a VC label on the basis of the tunnel label and the VC label.

(8-1) When the ingress router 1 shown in FIG. 9(a) receives a unicast frame from the user network 51a, the ingress router 1 gives a tunnel label and a VC label to the unicast frame as does in the normal operation.

When receiving a multicast frame, a broadcast frame or a unicast frame whose destination is unknown, which is to be duplicated, from the user site, the ingress router 1 processes both “protocol type” contained in each frame and “destination MAC address” contained in each frame.

With respect to “protocol type,” the ingress router 1 selects multicast MPLS for “protocol type” of the L2 header of each frame, and writes the same. For example, when receiving an Ethernet packet which is the forwarding media (physical media), the ingress router gives “0x8848” (“0x8847” in the case of unicast MPLS). In the case of PoS, the ingress router 1 gives 0x0283 (“0x0281” in the case of unicast MPLS). The ingress router 1 outputs the one frame.

With respect to “destination MAC address,” the ingress router 1 writes “destination MAC address” included in the layer 2 frame into the “destination MAC address” of the L2 header in the case of a multicast frame. In the case of a broadcast frame, the ingress router 1 writes “0xFFFFFFFFFFFF.” The ingress router 1 designates the MAC address of the ingress router 1 as “source MAC address.” When the forwarding media is Ethernet, the ingress router 1 writes “0x8848” (multicast MPLS) into “Ether type.” Further, the ingress router 1 writes VCID into the MPLS shim header.

When receiving a frame having a destination MAC address “Y” and a source MAC address “X” from the user site, the ingress router 1 retrieves in the MAC address table 33. When the destination MAC address “Y” is not registered, the ingress router 1 determines that the frame is a frame whose destination is unknown, and performs the same process as broadcasting.

According to the first frame forwarding method of this invention, the ingress router 1 determines whether a received Ethernet packet is to be duplicated or not on the basis of the protocol type of the received Ethernet packet (determining step). The ingress router 1 forwards a MPLS frame obtained by giving a tunnel label and a VC label to the received Ethernet packet determined to be a frame not to be duplicated (unicast frame) at the determining step (forwarding process step), and passes the frame. On the other hand, the ingress router 1 forwards a MPLS frame obtained by giving a tunnel label and a VC label to the received Ethernet packet determined to be duplicated at the determining step, and forwards the frame. Any one of the relay routers 2a through 2c duplicates or forwards the MPLS frame forwarded at the forwarding step (relaying step).

In the forwarding process (forwarding process step), the ingress router 1 forwards an MPLS frame obtained by giving an address for multicast to “destination MAC address” of the received Ethernet packet. Any one of the relay router 2a through 2c duplicates and forwards the MPLS frame forwarded at the forwarding process step on the basis of the VC label table for muticast 32 in which the address for multicast is related to forwarding destination router addresses (relaying step).

(8-2) Next, when the relay router 2a receives the multicast MPLS frame, the relay router 2a refers to the MAC address table for multicast 11a to determine forwarding destination routers, makes one copy of the multicast frame or one copy of the broadcast frame, and bridges totaling two frames. Thus, the broadcast frame is again duplicated for one transmission link. In the drawing, the duplication is performed at a branching point of the tunnel LSP such as the relay router 2a.

(8-3) The frame from the relay router 2a is forwarded to the egress routers 3a and 3b via the relay router 2b, and forwarded to the egress router 3c via the relay router 2c. Each of the egress router 3a through 3c learns the address, pops the MPLS header, and forwards the frame to the user network 51b. Whereby, the layer 2 frame is virtually forwarded in the MPLS network.

As above, when the ingress router 1 receives a broadcast frame and forwards the same, the number of frames forwarded between the ingress router 1 and each of the relay routers 2a through 2c is only one per link. Accordingly, it is possible to reduce the burden on the MPLS network as compared with the known case where three frames are outputted from the ingress router.

(8-4) FIG. 9(b) is a diagram schematically showing frames (multicast frame and unicast frame) received by each router shown in FIG. 9(a). When the frame received by the ingress router 1 is a multicast frame, the ingress router 1 bridges only the layer 2 frame 70 of the layer 2 frame 70 and MPLS header 71 [FIG. 3(a)] to the relay router 2a. The relay router 2a performs the bridging process on a broadcast frame to bridge the layer 2 frame 70 to the relay routers 2b and 2c. Each of the relay routers gives the MPLS header 71 to the layer 2 frame, and forwards the frame to the egress router 3a.

When the frame received by the ingress router 1 is a unicast frame, the layer 2 frame 70 and the MPLS header 71 are both forwarded between the routers. In other words, when receiving a multicast frame, the ingress router 1 performs the bridging operation. When receiving a unicast frame, the ingress router 1 forwards the frame.

When the ingress router 1 receives a multicast frame or the like and outputs the same, it is possible to prevent the same frames from being transmitted in links between the ingress router 1 and each of the relay routers 2a through 2c, thus possible to reduce the load on the MPLS network 50.

Even when the ingress router 1 receives a unicast frame whose destination is unknown, it is possible to prevent the unicast frame from being transmitted to each router in the MPLS network 50, and thus possible to reduce the load on the MPLS network 50. Even in a network of the best effort type, it is possible to avoid unnecessary duplication.

According to the routers of this invention, it is possible to suppress the load on the MPLS network 50 (L2 VPN) to the minimum and to effectively use the forwarding band, as above.

### (B) Description of Second Embodiment of the Invention

When it is necessary to forward a frame from the same output port to a plurality of relay routers, the ingress router according to a second embodiment handles the frame as a multicast MPLS frame, selects one among user identification LSPs for forwarding unicast traffics, and forwards the frame. When the relay router receives the frame, the label switching unit duplicates the frame as required and forwards the same. Finally, the frames are forwarded with all the necessary user identification LPSs for unicast.

According to the second embodiment, the user identifying function and the user point identifying function are given to the VC label. Why the user identifying function is required is that each egress router learns the address. Each of the egress routers 3a through 3c requires information about from which ingress node the frame is transmitted. For example, the VC label value 25 is used to identify both the user and the ingress router.

An existing VCLSP for unicast is used for the VCLSP according to the second embodiment, and a frame is forwarded, as stated below.

FIG. 10 is a diagram showing a structure of the MPLS network 50 according to the second embodiment of this invention. The MPLS network 50 shown in FIG. 10 forwards a packet sent from a user A1, B1 or the like in the user network 51a to a user A2, B1 or B3 in a user network 51b, for example. The ingress router 1a gives an LSP having, for example, a VC label to a received frame from the user network 51a such as the user A1, B2 or the like, and forwards the frame. In FIG. 10, like reference characters designate like or corresponding parts described above.

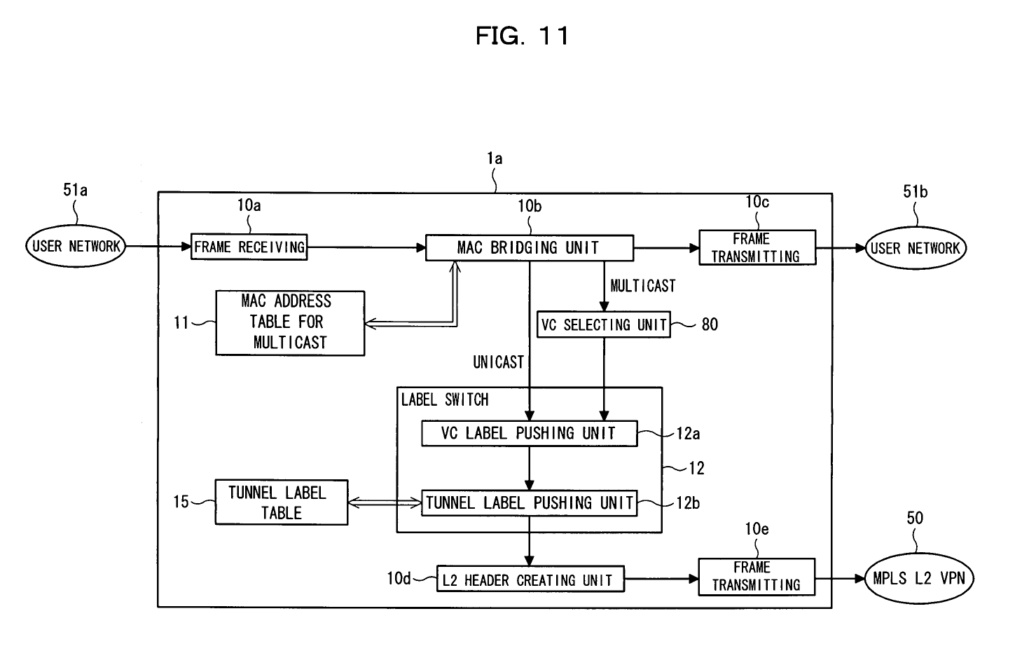

FIG. 11 is a block diagram of an ingress router 1a according to the second embodiment of this invention. The ingress router 1a shown in FIG. 11 comprises a frame receiving unit 10a, a MAC bridge processing unit 10b, a first frame transmitting unit 10c, a MAC address table for multicast 11, a label switching unit 12; a tunnel label table 15, a VC selecting unit 80, a L2 header creating unit 10d and a second frame transmitting unit 10e. In FIG. 11, like reference characters designate like or corresponding parts described above.

The ingress router 1a according to the second embodiment differs from the ingress router shown in FIG. 5 according to the first embodiment in that the ingress router 1a does not have the VCID giving unit 13 but has the VC selecting unit 80.

The VC selecting unit 80 selects a VC label, which is to be given to forward a multicast frame by the MAC bridge process unit 10b, among a plurality of VC labels (unicast VC labels) of unicast frames have been registered by the ingress router 1a, and gives the selected VC label to the multicast frame. These plural VC labels are selected from unicast frame VC labels to be transmitted via the same output port as an output port forwarding the above multicast frame among plural output ports provided to the first frame transmitting unit 10c.

As a reference for selecting the VC label by the VC label selecting unit 80, used is a VC label having the minimum value or the maximum value, or an output port having the largest number or the smallest number, for example. Namely, a desired LSP is selected from user identification LSP labels for unicast, and the multicast-frame received from the user site is transmitted.

Accordingly, the forwarding process unit gives a VC label (label of user point identification path) selected from a plurality of VCLSPs (user point identification paths) for forwarding unicast frames to a received Ethernet packet determined to be duplicated by the MAC bridge process unit 10b, and forwards the packet.

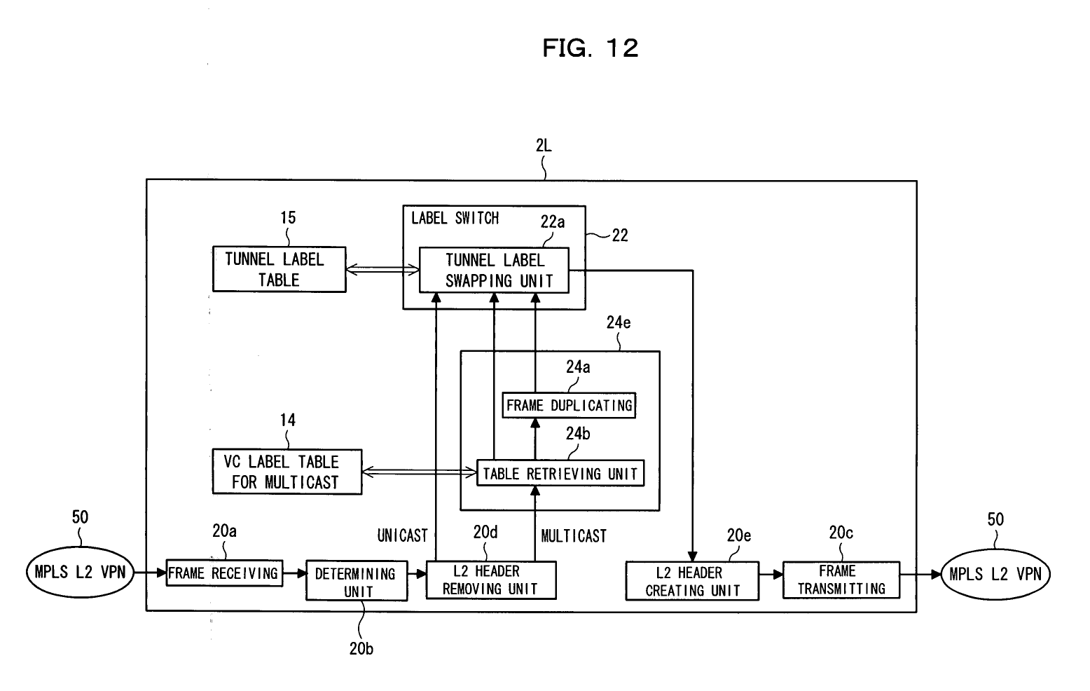

FIG. 12 is a block diagram of a relay router 2L (2 el) according to the second embodiment of this invention. The relay router 2L shown in FIG. 12 has a function of retrieving a VC label to be given to a received frame when the received frame is a multicast frame. The relay router 2L comprises a VC label table for multicast 14 and a VC label retrieving unit 24e, along with a frame receiving unit 20a, a determining unit 20b, a L2 header removing unit 20d, a L2 header creating unit 20e, a first frame transmitting unit 20c, a label switching unit 22 and a tunnel label table 15. In FIG. 12, like reference characters designate like or corresponding parts described above.

FIG. 8(c) is a diagram showing an example of the VC label table for multicast 14 according to the second embodiment of this invention. In the VC label table for multicast 14, a tunnel label of a received frame is related to contents of a process on the tunnel label for each LSP, and held. When the tunnel label of a received frame is 21, the label switching unit 12 gives a tunnel label 22 to the received frame, and forwards the received frame from an output port 2, for example. When the tunnel label of the same received frame is 21, the label switching unit 12 gives a tunnel label 42 and a VC label 104 to the received frame, and forwards the received frame from an output port 3.

Whereby the tunnel label of the received frame is replaced in each LSP in the MPLS network 50, and forwarded. A frame of each user corresponding to an LSP can be separately forwarded.

The VC label retrieving unit 24e gives a VC label to a multicast frame from the frame receiving unit 20a, and duplicates the frame to which the VC label has been given. The VC label retrieving unit 24 comprises a table retrieving unit 24b and a frame duplicating unit 24a. The table retrieving unit 24b retrieves in the VC label table for multicast 14 with respect to the received multicast frame. In this retrieval, contents of a process related to a VC label value of corresponding data held for each of LSPs in the VC label table for multicast 14 is read out, using the VC label value of the received frame as an index.

The frame duplicating unit 24a gives a VC label retrieved by the table retrieving unit 24b to the multicast frame, duplicates the frame, and outputs the same. The VC label given to each multicast frame is an existing VC label used for an LSP addressed to the relay router 2b or 2c that the relay router 2L itself has.

The plural frames given the selected VC labels are inputted to the label switching unit 22. The label switching unit 22 gives a tunnel label to each of the inputted plural frames on the basis of the tunnel label table 15, and inputs the frames to which the VC labels and the tunnel labels have been given to the L2 header creating unit 20e. The VC label functions as an identifier for identifying both the user and the ingress router 1a showing the user point.

The received frame determined to be a unicast frame by the determining unit 20b is inputted to the label switching unit 22, given a tunnel label, and forwarded from the frame transmitting unit 20c via the L2 header creating unit 20e.

When the relay router 2L receives a multicast frame from, for example, the neighboring relay router 2b or 2c (FIG. 10), the relay router 2L duplicates the frame, switches the existing VC label and tunnel label for unicast, and forwards the frames.

According to a second frame forwarding method (mode 2) of this invention, at a forwarding process (forwarding process step), the ingress router 1a determines whether a received Ethernet packet is to be duplicated or not on the basis of the MAC address table for multicast 11 in which a MAC address to be duplicated and VCLSPs for transferring unicast frames is related to each other (determining step). The ingress router 1a selects a VCLSP from a plurality of VCLSPs for frames not to be duplicated forwarded from the same port as frames to be duplicated among a plurality of VCLSPs (user point identification paths) for forwarding unicast frames which are frames not to be duplicated among VCLSPs that the ingress router 1a beforehand possesses (selecting step). The ingress router 1a transmits a MPLS frame having the selected VCLSP selected at the selecting step (transmitting step).

The relay router 2L duplicates and forwards the MPLS frame transmitted at the transmitting step on the basis of the VC label table for multicast 14 in which a VC label for multicast and forwarding destination router addresses are related to each other (relaying step).

Each of the relay routers 2b and 2c receiving the frame duplicates the MPLS frame as required, and forwards the frame. Finally, the multicast frame is forwarded using necessary all VCLSPs for unicast and tunnel LSPs in the MPLS network 50. The frames are transmitted to, for example, the user network 51b of the users A2, B2 and B3.

Accordingly, the relay router 2L, which heretofore does not have the multicasting and broadcasting functions, can use both the multicasting function and unicasting function. Since the existing network resources can be used as they are, the service provider can configure the virtual network 50 at relatively low cost without newly configuring a network, and both the multicasting function and broadcasting function, which are not heretofore defined, can be realized, whereby a layer 2 packet can be virtually forwarded.

The address learning in each of the egress routers 3a through 3c is the same as the address learning method shown in FIG. 40.

Next, the frame forwarding method according to the second embodiment, with the above structure, will be described with reference to FIG. 10. Between the ingress router 1a and the relay router 2L shown in FIG. 10, tunnel LSPs (represented by pipes) and VCLSPs (represented by solid lines) are set.

The ingress router 1a receives a frame from the outside, refers to the MAC address table for unicast 11, and recognizes which the received frame is a unicast frame, a multicast frame or a broadcast frame to be forwarded to each of VC labels 102, 103 and 104.

When the ingress router 1a receives a multicast frame from the user site, the ingress router 1a selects a VC label to be transmitted from a plurality of unicast VCs that should be transmitted from the same output port on the basis of a selection reference of, for example, the smallest number 102 or the like. The ingress router 1a retrieves the tunnel label 21 in the tunnel label table 15, gives the VC label and the tunnel label to the layer 2 frame, and transmits the MPLS frame from the output port 1. When the ingress router 1a receives a unicast frame whose destination is unknown, the ingress router 1a performs the same process as that in the forwarding method according to the first embodiment.

When the relay router 2L (FIG. 12) receives the MPLS frame, the relay router 2L finds that the MPLS frame is a multicast MPLS frame from “protocol type” in the L2 header, and retrieves in the label table for multicast 14. The relay router 2L duplicates the frame on the basis of contents held in the label table for multicast 14 when it is necessary to transmit the frame to a plurality of output ports, swaps the tunnel label of the duplicated frame to 22, and transmits the swapped frame to the output port 2. The relay router 2L swaps the tunnel label of the duplicated frame to 42, and transmits the frame whose VC label has been swapped to 104 to the output port 3.

The address learning in each of the egress routers 3a through 3c is performed in the same manner as the first embodiment.

As above, in the frame forwarding method according to the second embodiment, duplication of a frame is carried out at the relay router 2L corresponding to a branch of the VC label, and the existing MPLS network 50 can be used as it is.

As above, transmission of a plurality of same frames is avoided in the links between the ingress router 1a and each of the relay routers 2L, 2b and 2c belonging to the MPLS network 50, thus the load on the MPLS network 50 is reduced.

According to this invention, it is possible to suppress the load on the MPLS network 50 to the minimum, and efficiently use the band in the network, as above.

### (C) Description of Third Embodiment

According to a third embodiment, the ingress router generates a point-to-multipoint tunnel LSP for multicast bundling a plurality of unicast tunnel LSPs using the same link, separately from a unicast tunnel LSP.

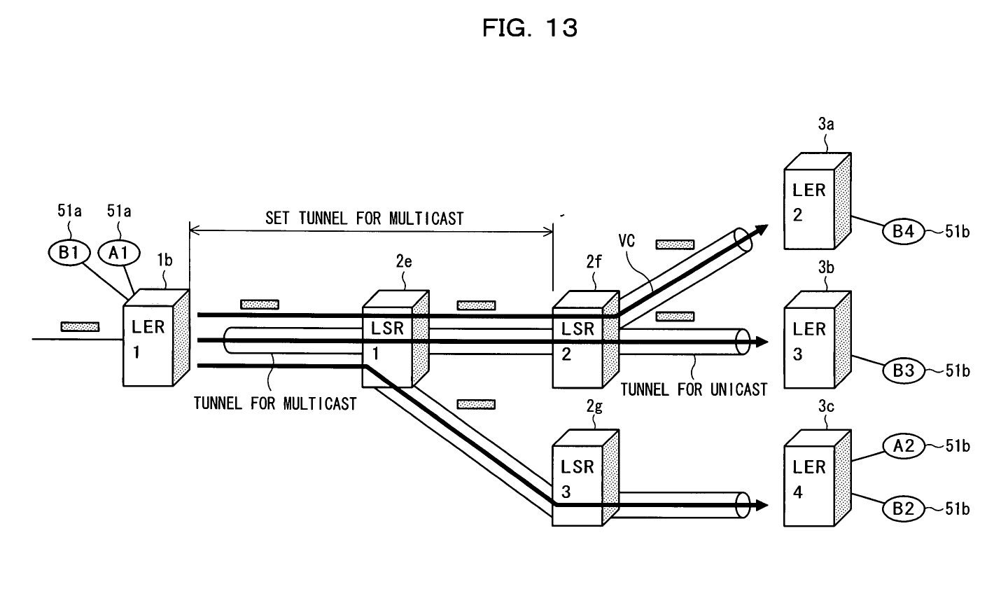

FIG. 13 is a diagram of a structure of a MPLS network 50 according to the third embodiment of this invention. The MPLS network 50 shown in FIG. 13 forwards a packet sent from a user A1, B1 or the like in the user network 51a to a user A2, B2 or B3 in the user network 51b, for example. An ingress router 1b and relay routers 2e through 2g shown in FIG. 13 are modification of the ingress router 1b and the relay routers 2a through 2c according to the first embodiment. Egress routers 3a through 3c are the same as the egress routers described above.

Between the routers, a tunnel LSP (denoted by a pipe) and a VCLSP (denoted by a solid line) are set. According to the third embodiment, the ingress router 1b generates a normal VC label and a normal tunnel label for a unicast frame separately, and creates a new VCLSP for multicast and a new tunnel LSP for multicast.

VCLSP for multicast according to the third embodiment functions as a user identifier and a user point identifier (source ingress router 1b). Namely, VCLSP according to the first and second embodiments is used to identify a user, whereas VCSLP according to the third embodiment includes a user and the ingress router 1b showing the user point.

The ingress router 1b shown in FIG. 13 reads a received frame from a user site such as the user A1, B1 or the like in the user network 51a, and determines whether the received frame is a frame that should be transmitted to the three relay routers 2e through 2g in the MPLS network 50 from the same output port. When it is determined that the received frame is a frame that should be transmitted to the three relay routers 2e through 2g, the ingress router 1b forwards the received frame to, for example, the relay router 2e through a VCLSP for multicast and a tunnel LSP for multicast. These VCLSP and tunnel LSP are included in the received frame.

The relay router 2e forwards the frame. When each of the relay routers 2f and 2g in the following stage receives the frame, each of the relay routers 2f and 2g duplicates the frame as required, and forwards the frames. Finally, the multicast frame is forwarded, using all necessary VCLSPs for unitcast and tunnel LSPs in the MPLS network 50.

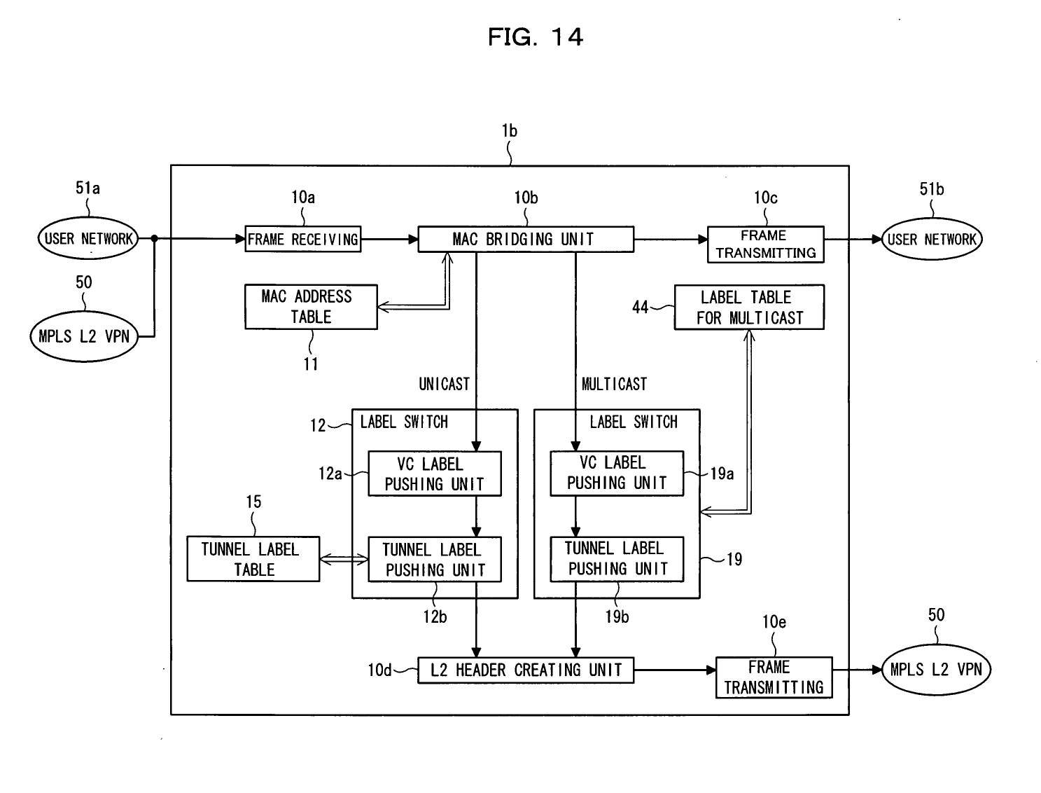

FIG. 14 is a block diagram of the ingress router 1b according to the third embodiment. To the MAC bridge process unit 10b shown in FIG. 14, connected is a multicast process unit (label switch) 19 giving a VC label and a tunnel label to a multicast frame. The multicast process unit 19 comprises a VC label pushing unit 59a for giving a VC label, and a tunnel label pushing unit 19b for giving a tunnel label.

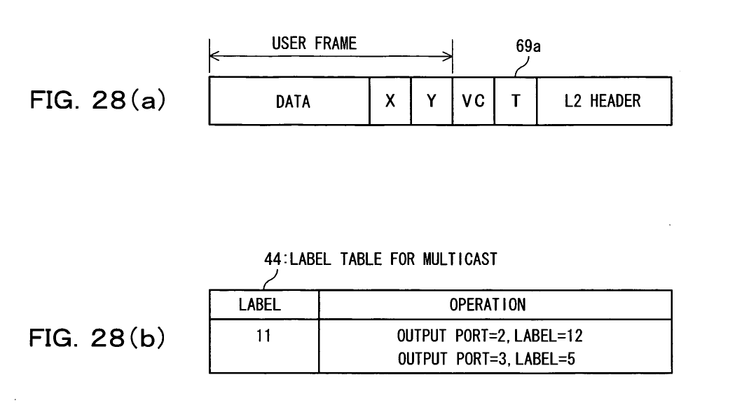

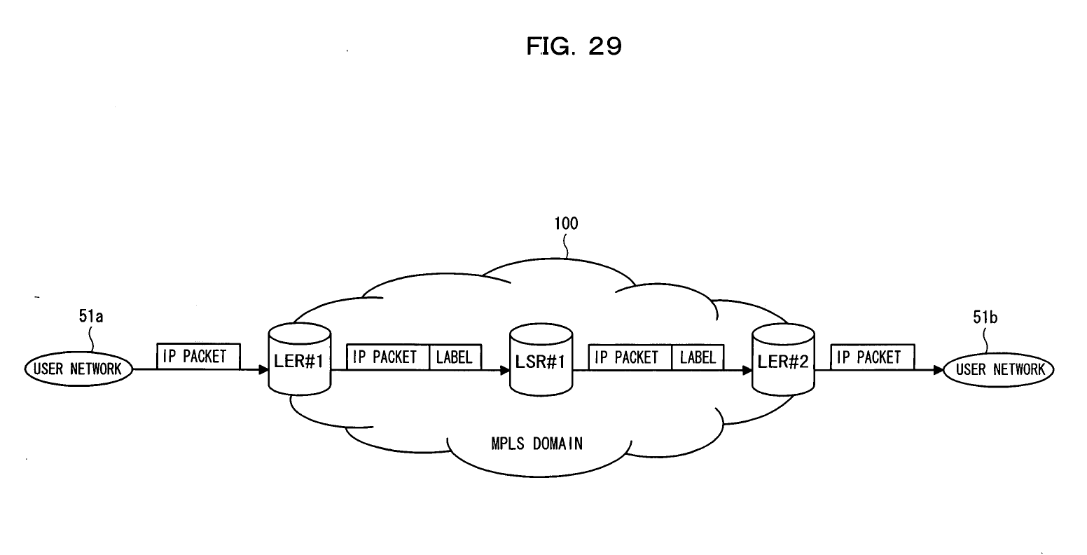

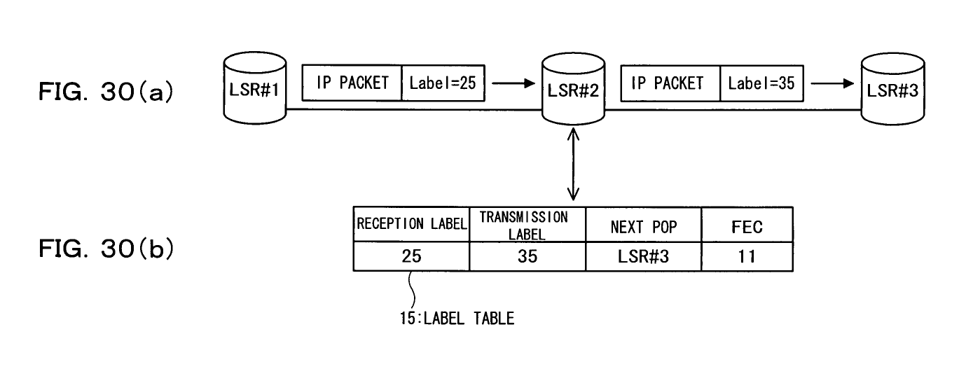

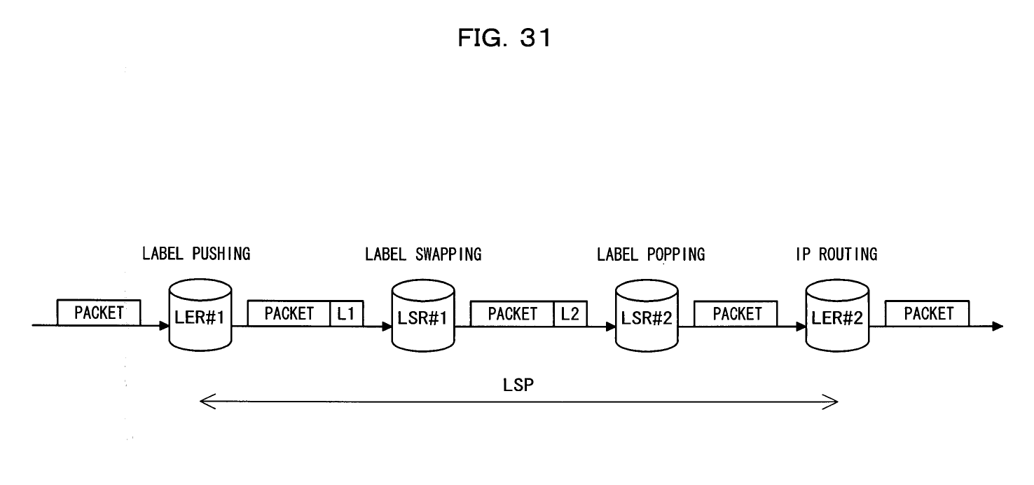

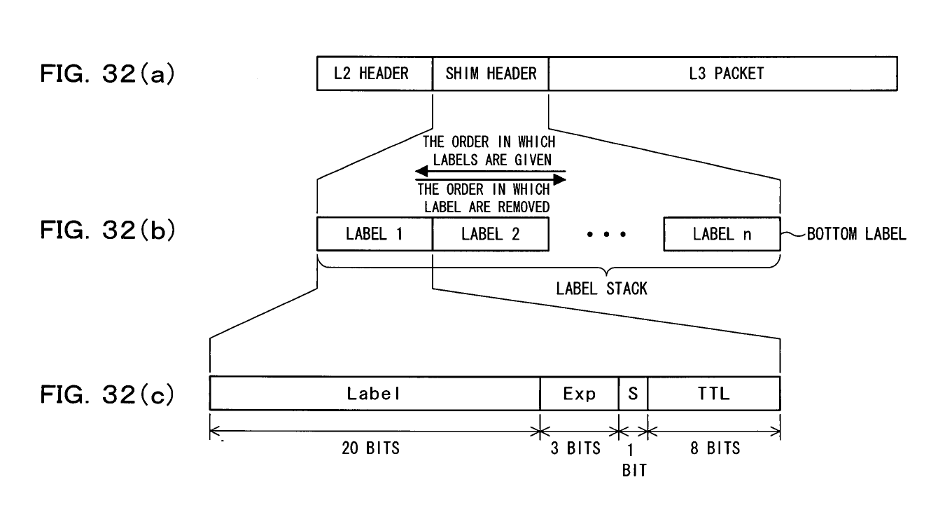

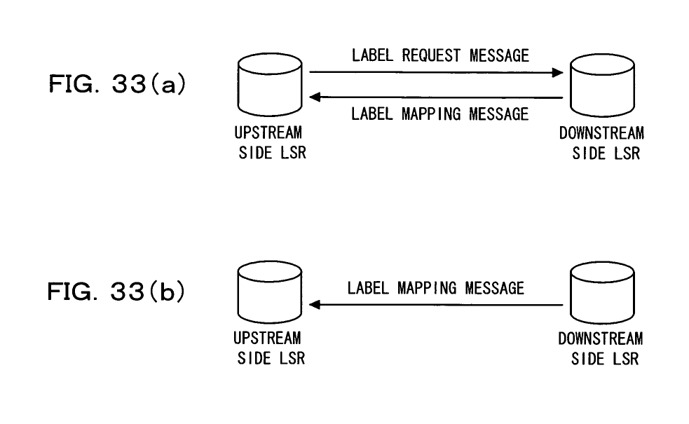

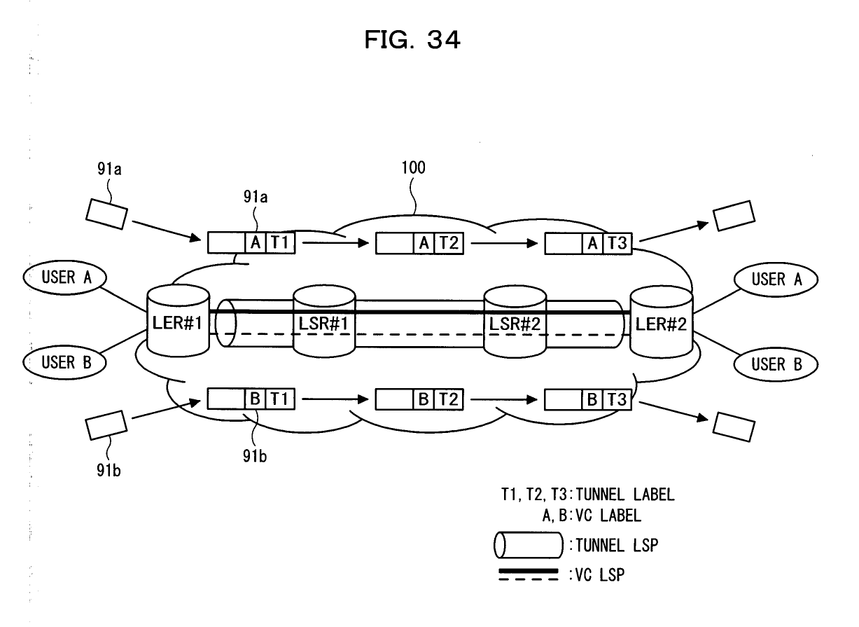

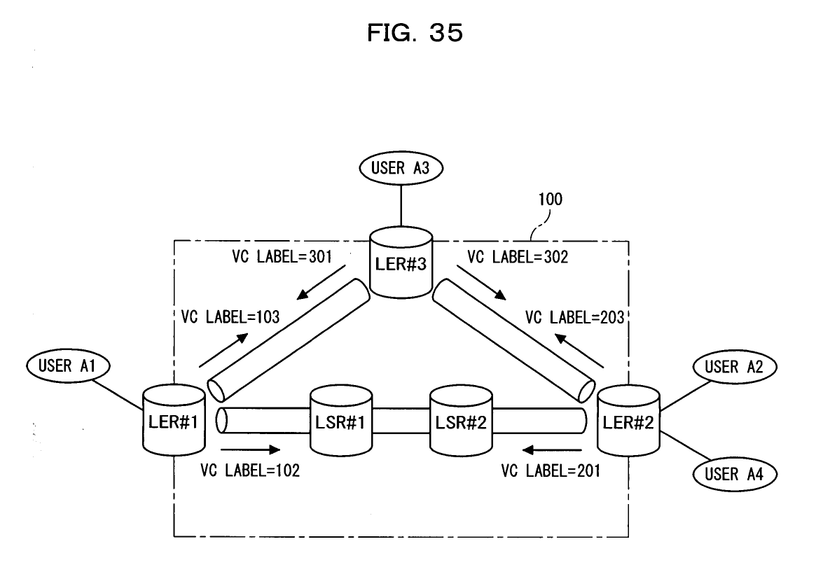

To the multicast process unit 19, connected is a label table for multicast 44 to be described later with reference to FIG. 28(b). In the label table for multicast 44, a VC label value for multicast and tunnel label values are related to each other for each user, and held.

The ingress router 1b shown in FIG. 14 differs from the ingress router 1 according to the first embodiment in that a VC label and a tunnel label are given to a frame determined to be a unicast frame by the MAC bridge process unit 10b, whereas a VC label and a tunnel label are pushed to a frame determined to be a multicast frame by the MAC bridge process unit 10b, as well.

When it is determined that the received frame is a multicast frame, the MAC bridge process unit 10b inputs the received frame to the multicast process unit 19 to give a VC label and a tunnel label thereto. The format of the frame given the labels is formed in the L2 header creating unit 10d. The frame is forwarded from the second frame transmitting unit 10e to another relay router, the ingress router or the egress router in the MPLS network 50.

When the ingress router 1b shown in FIG. 14 receives a layer 2 frame from the MPLS network 50, the frame is bridged in the MAC bridge process unit 10b, and forwarded to the user network 51a via the frame transmitting unit 10c.

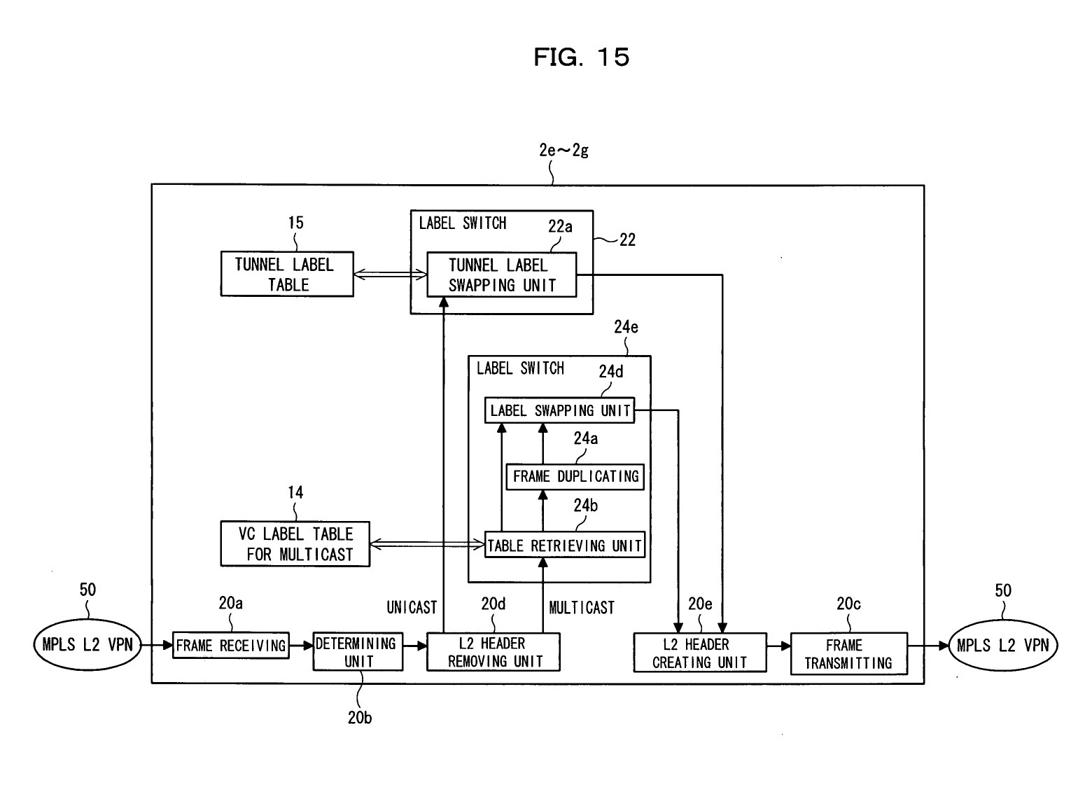

FIG. 15 is a block diagram of the relay router 2e according to the third embodiment of this invention. Each of the relay routers 2f and 2g is similar in structure to the relay router 2e. The relay router 2e comprises a VC label retrieving unit (label switch) 24e and a second VC label table for multicast (second VC label table for multicast) 14.

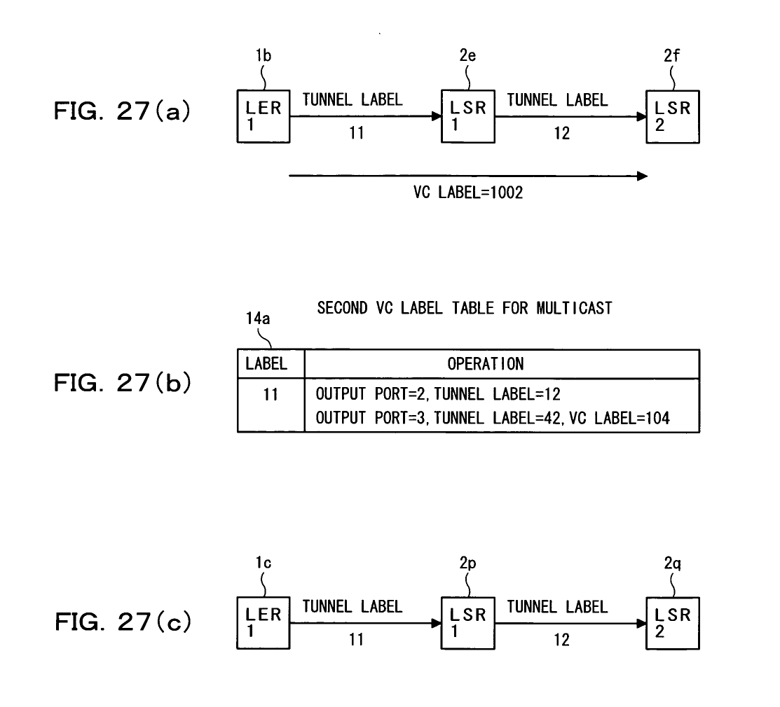

FIG. 27(b) is a diagram showing an example of the second VC label table for multicast 14a according to the third embodiment of this invention. The second VC label table for multicast 14a shown in FIG. 27(b) is almost similar to the VC label table for multicast 14. In the drawings, like reference characters designate like or corresponding parts described above.

The VC label retrieving unit 24e retrieves in the second VC label table for multicast 14a, and duplicates the frame on the basis of the retrieved VC label. The frame is swapped in a label swapping unit (label pushing unit) 24d swapping a label of the received frame, and the MPLS frame is forwarded to the MPLS network 50 via the L2 header creating unit 20e.

The relay router 2f refers to the second VC label table for multicast 14a with respect to the MPLS frame from the relay router 21e, duplicates the MPLS frame, replaces the user identification LSP label and tunnel LSP label for multicast with a VCLSP label and tunnel LSP label for unicast, and transmits the frame.

Here, the VC label retrieving unit 24e (FIG. 12) according to the second embodiment is compared with the VC label retrieving unit 24e according to the third embodiment. The VC label retrieving unit 24e shown in FIG. 12 inputs the duplicated MPLS frame to the label switch unit 22. On the other hand, in the VC label retrieving unit 24e shown in FIG. 15, the label swapping unit 24d writes labels for multicast (VCLSP label and tunnel LSP label) for multicast in the duplicated MPLS frame.

Since the tunnel LSP for multicast is beforehand set between the ingress router 1b and each of the relay routers 2e through 2g shown in FIG. 13, the ingress router 1b does not need to set another tunnel LSP for multicast.

With the above structure, a frame forwarding method according to the third embodiment will be now described with reference to FIG. 13.

FIG. 27(a) is a diagram for illustrating a VC label for multicast and tunnel labels for multicast according to the third embodiment of this invention. In FIG. 27(a), like reference characters designate like or corresponding parts described above.

The ingress router 1b (FIG. 13) sets a tunnel label “11” between the ingress router 1b and the relay router 2e. The relay router 2e sets a tunnel label “12” between the relay router 2e and the relay router 2f. Further, the ingress router 1b sets, for example, “1002” to a VC label between the ingress router 1b and the relay router 2f.

The ingress router 1b receives a layer 2 frame from a user site such as user A1, B1 or the like, and outputs the layer 2 frame to be flooded to the multicast process unit 19 (FIG. 14) when determining that the layer 2 frame is a multicast frame.

The multicast process unit 19 retrieves in the second VC label table for multicast 14a, gives the tunnel label “11” and the VC label “1002,” forwards the frame, and transmits the frame from an output port (for example, output port 1).

In other words, a plurality of unicast tunnel LSPs sharing the same link between the ingress router 1b and the relay router 2e are bundled, and the bundled plural LSPs are set as a point-to-multipoint tunnel LSP for multicast, separately from a unicast tunnel LSP.

The ingress router 1b sets a VC for each MPLS network 50 (or another MPLS network 50) to the point-to-multipoint tunnel LSP for multicast. Whereby, a multicast frame from, for example, the user network 51a is transferred to the tunnel LSP for multicast.

When receiving a unicast frame whose destination is unknown, the ingress router 1b processes the frame in the same way as a multicast frame.

In a frame forwarding method (mode 3) according to this invention, in a forwarding process (forwarding process step), the ingress router 1b shown in FIG. 13 sets a VCLSP for multicast and a tunnel LSP for multicast (setting step), and forwards a MPLS frame through the VCLSP for multicast and the tunnel LSP for multicast (forwarding step).

When receiving the frame, each of the relay routers 2e, 2f and 2g finds, from the “protocol type” in the L2 header, that the frame is a multicast MPLS frame, and retrieves in the second VC label table for multicast. On the basis of a result of the retrieval, the VC label retrieving unit 24e (FIG. 15) outputs the frame in which the tunnel label has been swapped to “12” to the output port 2, swaps the tunnel label and VC label to “42” and “104,” and transmits the swapped frame to the output port 3.

In relaying (relaying step), the relay router 2e duplicates the MPLS frame on the basis of the second VC label table for multicast 14a in which the VCLSP label for multicast is related to a forwarding destination router address, and forwards the MPLS frame (duplicating/forwarding step).

The relay router 2f duplicates the MPLS frame duplicated and forwarded at the duplicating and forwarding step, and forwards the same through the VCLSP for multicast and the tunnel LSP for multicast set at the setting step. Whereby, the multicast frame is relayed and forwarded. The multicast frame is duplicated as required, and each of the multicast frames is finally transferred to a LSP for unicast in the MPLS network 50.

Since the ingress router 1b sets an LSP for multicast, the user can use the existing network resources as they are, and the service provider can give a value added to the virtual network 50 with the minimum investment.

The VC label and the tunnel label between the ingress router 1b and each of the egress routers 3a through 3c are swaped from a LSP for multicast to LSPs for unicast.

Each of the egress routers 3a through 3c learns an address with respect to the received multicast frame, learning the address in the same manner as the known manner (for example, the manner shown in FIG. 40).

As above, transmission of the same frames is avoided in links between the ingress router 1b and the relay router 2e, and the relay router 2e and the relay router 2f, thus the load on the MPLS network 50 is reduced. In the third embodiment, even when the ingress router 1b receives a unicast frame whose destination is unknown, transmission of the unicast frame to each of the relay routers 2e through 2g belonging to the MPLS network 50 is avoided, thus the load on the MPLS network 50 is reduced.

### (D) Description of Fourth Embodiment

In a frame forwarding method according to a fourth embodiment, the ingress router sets a LSP for multicast between the ingress router and the egress router, separately from a unicast VC, whereby VCs of MPLS frames having a plurality of unicast VCs in the same link are bundled into one point-to-multipoint LSPVC. Each relay router relaying and forwarding the MPLS frame duplicates the MPLS frame as required, and forwards the same. Finally, the relay router transfers the frame to a unicast VC.

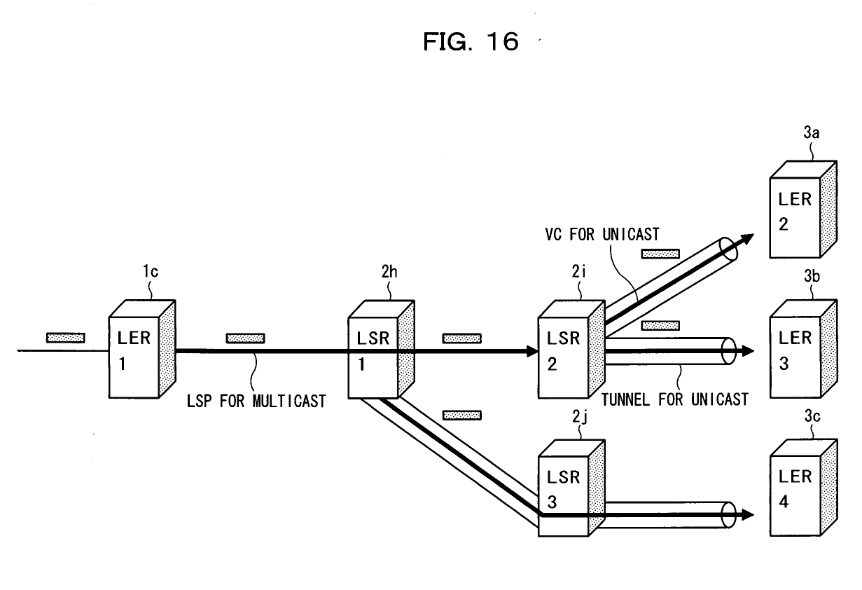

FIG. 16 is a diagram of a structure of an MPLS network 50 according to the fourth embodiment of this invention. An ingress router 1c shown in FIG. 16 sets a VC for multicast, separately from a unicast VC, and sets a point-to-multipoint VCLSP. Each of relay routers 2h through 2j has similar functions to those of the relay routers 2e through 2g used in the third embodiment.

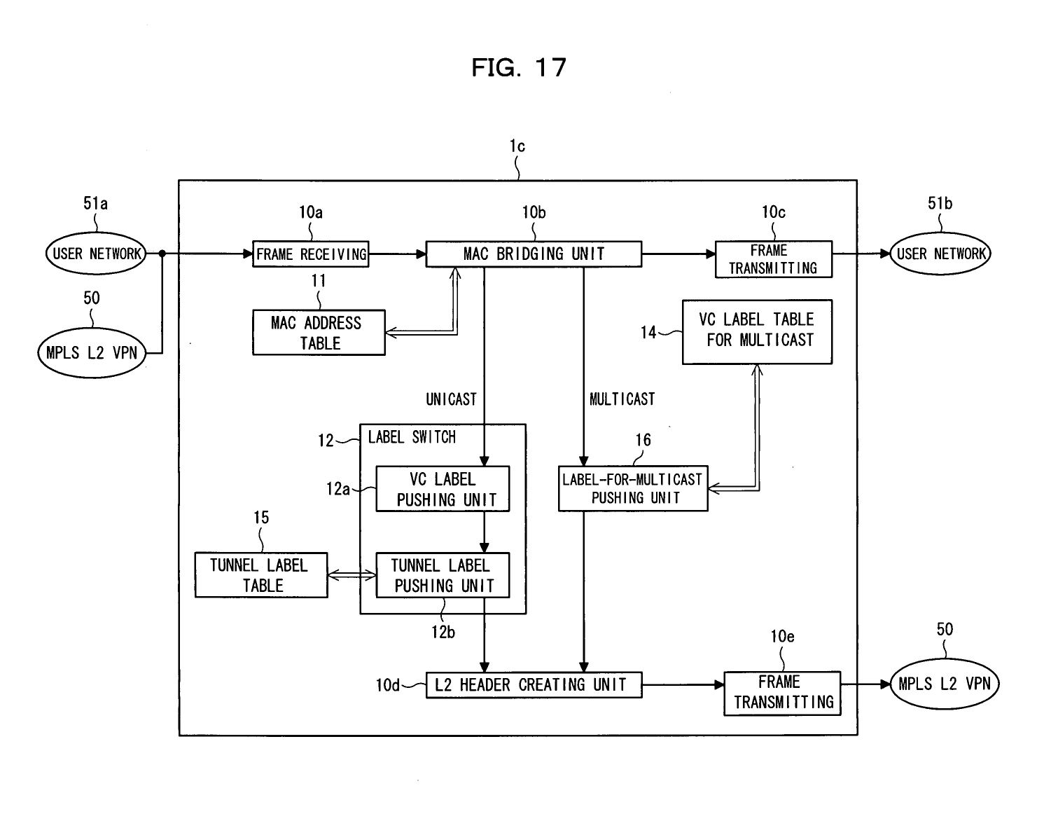

FIG. 17 is a block diagram of the ingress router 1c according to the fourth embodiment of this invention. The ingress router 1c shown in FIG. 17 comprises a label-for-multicast pushing unit 16 connected to the MAC bridge process unit 10b.

The label-for-multicast pushing unit 16 gives a label for multicast newly defined to a frame determined to be a multicast frame by the MAC bridge process unit 10b. The label-for-multicast pushing unit 16 refers to the VC label table for multicast 14, and gives a LSP label for multicast functioning as path determination (tunnel) as a VCLSP for multicast to a multicast frame from the user site. The label-for-multicast pushing unit 16 refers to the VC label table for multicast 14, duplicates the received MPLS frame, removes the LSP label for multicast, and gives an existing user identification LSP label for unicast (VC label) and a tunnel label to the frame.

Now, the ingress router 1b (FIG. 14) according to the third embodiment is compared with the ingress router 1c shown in FIG. 17. The ingress router 1b according to the third embodiment prepares a new VCLSP for multicast and a new tunnel LSP for multicast, separately from a normal VC label and tunnel label for unicast.

On the other hand, the ingress router 1c according to the fourth embodiment does not generate a new VCLSP for multicast and a new tunnel LSP for multicast, but uses a VCLSP for multicast differing from them.

Whereby, forwarding of redundant information data is avoided, and the use efficiency of the transmission band in the virtual network 50 is improved.

In FIG. 17, like reference characters designate like or corresponding parts described above.

FIG. 28(a) is a diagram showing an example of format according to the fourth embodiment of this invention. A frame 69a shown in FIG. 28(a) has only one VCLSP label for multicast without two tunnel and VC labels. This VCLSP for multicast is used to show both a user and the ingress router which is a user point.

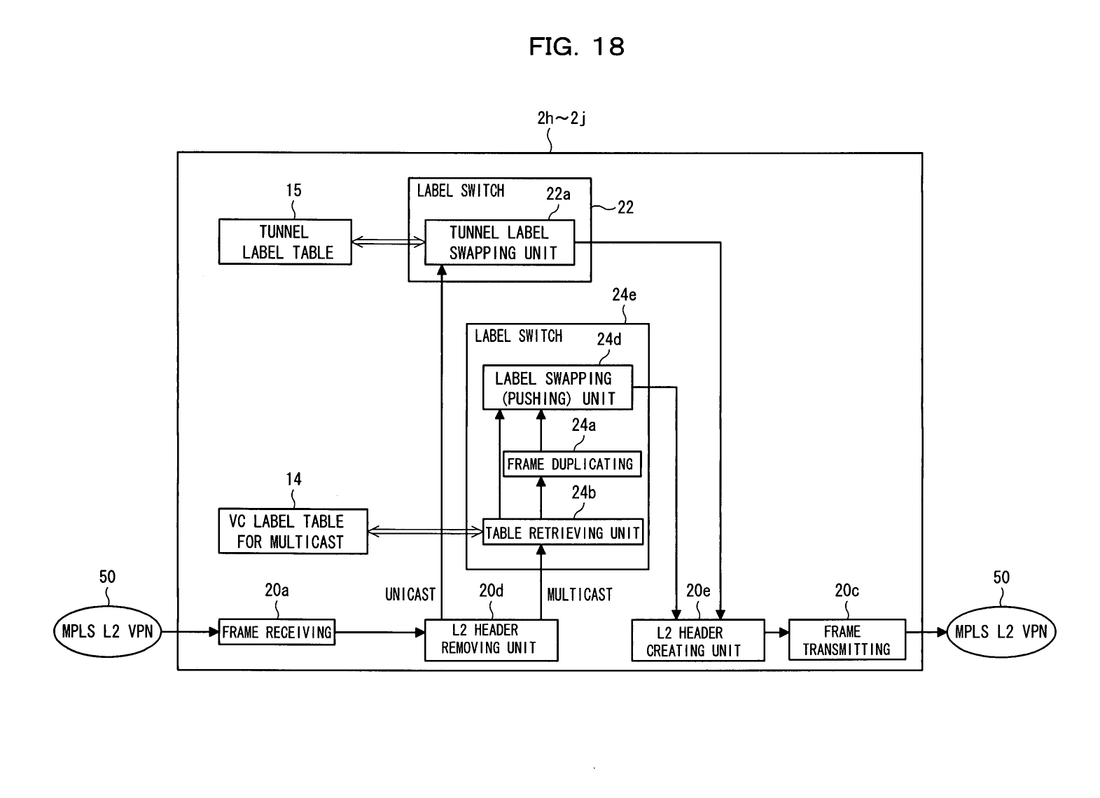

FIG. 18 is a block diagram showing the relay router 2h according to the fourth embodiment of this invention. When receiving a MPLS frame, the relay router 2h shown in FIG. 18 finds that the MPLS frame is a multicast MPLS frame from “protocol type” in the L2 header, retrieves in contents held in the VC label table for multicast 14, and duplicates the received frame on the basis of a result of the retrieval. The relay router 2h transmits the frame whose label has been swapped to “12” to the output port 2, removes the LSP label for multicast and forwards the frame, gives a tunnel label 42 and a VC label 104 to the received frame, and transmits the forwarded frame to the output port 3.

Each of the relay routers 2i and 2j shown in FIG. 16 is similar in structure to the relay router 2h, duplicated description of which is thus omitted.

Now, a fourth frame forwarding method with the above structure according to this invention will be described.

When the ingress router 1c shown in FIG. 17 receives a multicast frame from the user site, the ingress router 1c refers to the VC label table for multicast 14, and beforehand sets a LSP for multicast as shown in FIG. 27(c), for example, between the edge routers, that is, between the ingress router 1c and the egress router 3b, for example.

The ingress router 1c (FIG. 17) outputs a layer 2 frame to be flooded to the label-for-multicast pushing unit 16. The ingress router 1c retrieves in the VC label table for multicast 14, gives a label 11 to a frame outputted from the label-for-multicast pushing unit 16, forwards the frame, and transmits the same from the output port 1. Whereby, the frame is forwarded to the relay router 2h, using a VCLSP for multicast.

Further, each of the relay routers 2i an 2j duplicates the frame as required, and forwards the same. The MPLS frames are finally forwarded through all necessary VCLSPs for unicast and tunnel LSPs for unicast. The LSP for multicast of the ingress router 1c is swapped to the LSP for unicast of the egress router 3a.

In a fourth frame forwarding method (mode 4) of this invention, in the forwarding process (forwarding process step), the ingress router 1c sets a point/tunnel LSP (point/tunnel identification path) for identifying a VCLSP for multicast and a tunnel LSP for multicast (setting step), and forwards a MPLS frame through the point/tunnel LSP (forwarding step).

In relaying (relaying step), the relay router 2h duplicates the MPLS frame on the basis of the VC label table for multicast 14 in which the point/tunnel LSP and forwarding destination router addresses are related to each other, and forwards the frame (duplicating/forwarding step). Each of the relay routers 2i and 2h duplicates the MPLS frame duplicated and forwarded at the duplicating/forwarding step through the point/tunnel LSP set at the setting step.

Meanwhile, the address learning process on the received multicast frame in each of the egress routers 3a through 3c is performed in the same manner as that shown in FIG. 14.

As above, transmission of the same frames in links between the ingress router 1c and the relay router 2h, and the relay router 2h and each of the relay routers 2i and 2j is avoided, and the load on the MPLS network 50 is reduced.

According to the fourth embodiment, even when the ingress router 1c receives a unicast frame whose destination is unknown, transmission of the unicast frame to every router in the MPLS network 50 is avoided, and the load on the MPLS network 50 is reduced.

### (E) Description of Fifth Embodiment

In the known frame forwarding method, tunnel LSP and VCLSP are both set to point-to-point.

To the contrary, in a multicast frame according to the fifth embodiment, a point-to-multipoint path is newly set to each of the both LSPs, that is, a tunnel LSP and a VCLSP, whereby the multicast frame is forwarded in the MPLS network 50. In the frame forwarding method according to the fifth embodiment, the ingress router beforehand sets point-to-multipoint tunnel LS and VCLSP for multicast between the ingress router and the egress router, and the relay router duplicates the multicast frame as required.

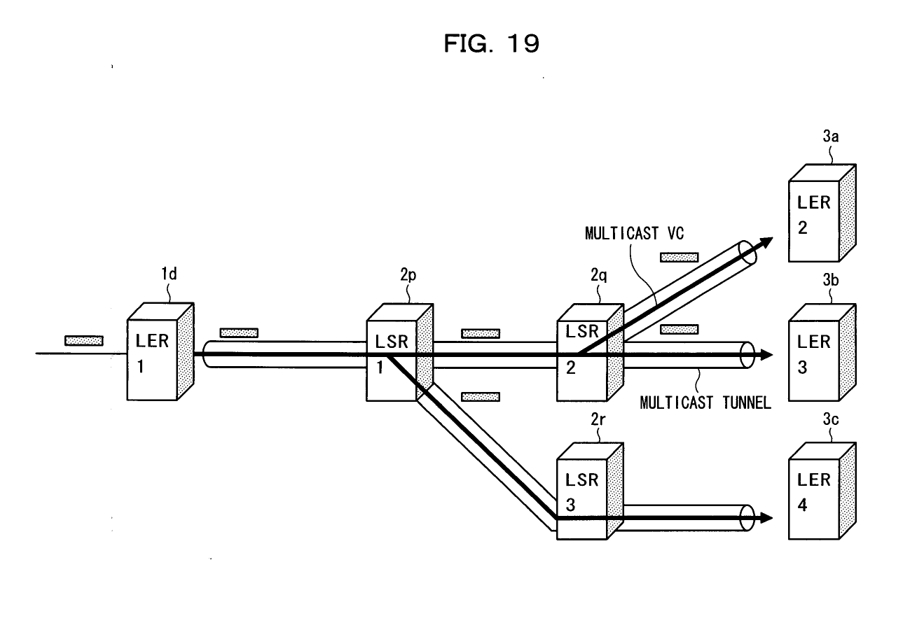

FIG. 19 is a diagram of a structure of an MPLS network 50 according to the fifth embodiment of this invention. The MPLS network 50 shown in FIG. 19 comprises an ingress router 1d, relay routers 2p, 2q and 2r, and three egress routers 3a through 3c. The ingress router 1d sets a VC for multicast, separately from a unicast VC, and sets a point-to-multipoint VCLSP. Each of the relay routers 2p through 2r has similar functions to those of the relay routers 2e through 2g (refer to FIG. 15). In FIG. 19, like reference characters designate like or corresponding parts described above.

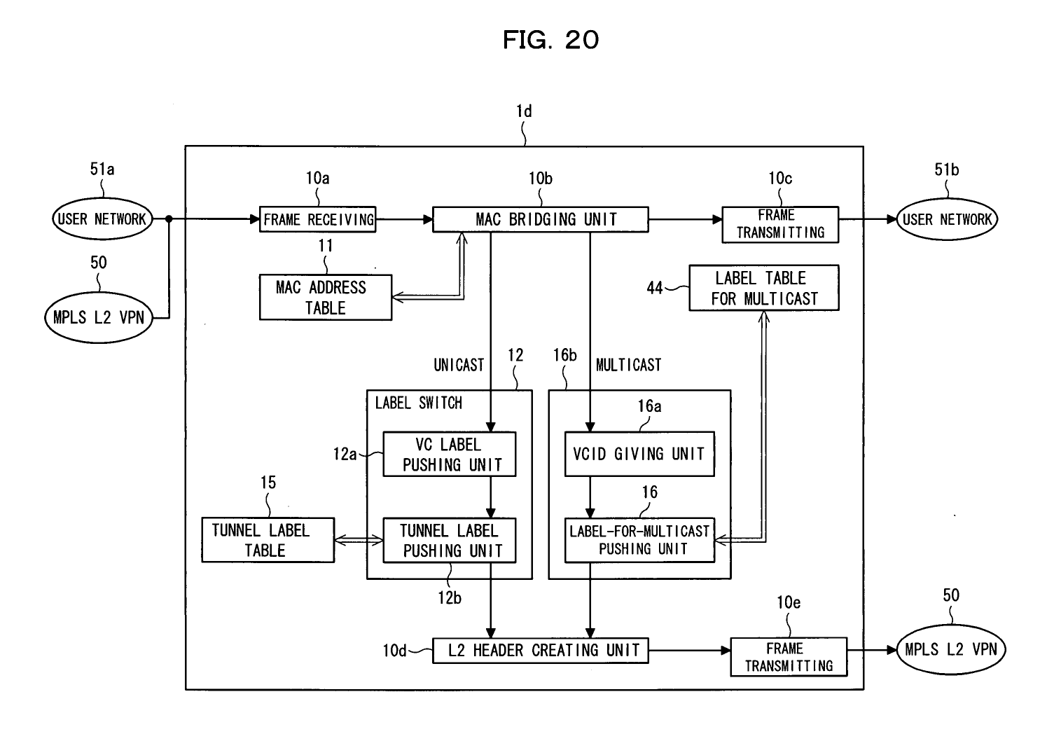

FIG. 20 is a block diagram of the ingress router 1d according to the fifth embodiment of this invention. The ingress router 1d shown in FIG. 20 comprises a label-for-multicast processing unit 16b and a label table for multicast 44. The label-for-multicast processing unit 16b comprises the label-for-multicast pushing unit 16 that the ingress router 1c (FIG. 17) has and a VCID adding unit 16a.

The label table for multicast 44 is almost similar to the above VC label table for multicast 14. In the label table for multicast 44, a tunnel label of a received frame is related to contents of a process (operation) on the tunnel label for each LSP, and held, as shown in FIG. 28(b), for example.

The ingress router 1d gives a user identification label and a tunnel label obtained from the label table for multicast 44 to a multicast frame received from the user site.

In FIG. 20, like reference characters designate like or corresponding parts described above.

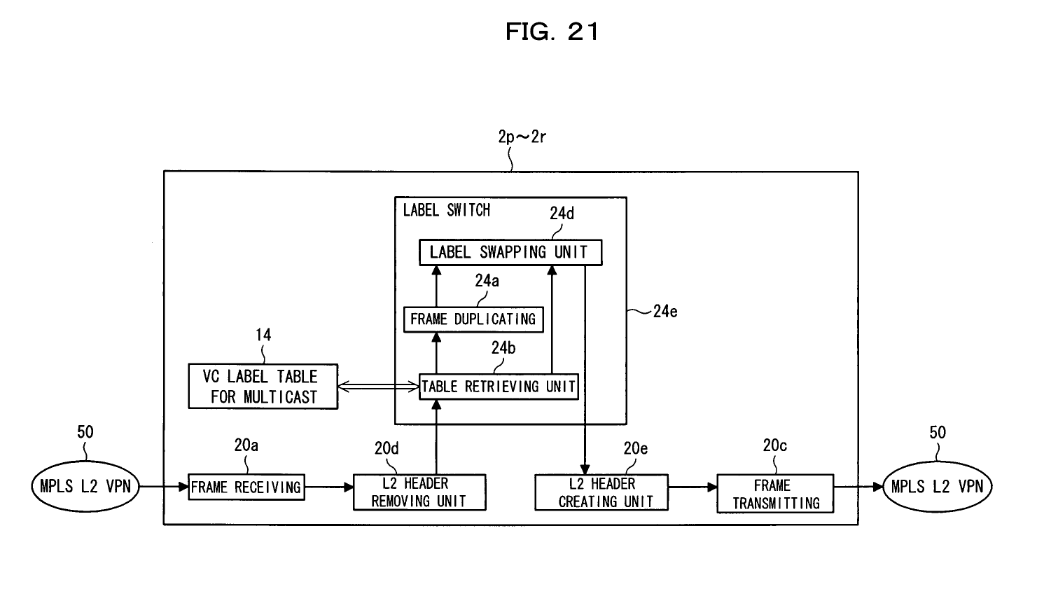

FIG. 21 is a block diagram of the relay router 2p according to the fifth embodiment of this invention. Now, the relay router 2p shown in FIG. 21 is compared with the relay router 2h (FIG. 18).

The L2 header removing unit 20d in the relay router 2h shown in FIG. 18 determines whether the received frame is a unicast frame or a multicast frame, and the frame is inputted to the label switching unit (label switch) 22 or the multicast process unit (label switch) 24e. On the other hand, in the relay router 2p (FIG. 21) according to the fifth embodiment, the frame type of a received frame is not determined by the L2 header removing unit 20d, but the frame whose header has been removed is inputted to the multicast process unit (label switch) 24e. In FIG. 21, like reference characters designate like or corresponding parts described above.

Each of the relay routers 2q and 2r shown in FIG. 19 is similar in structure to the relay router 2p, duplicated description of which is thus omitted.

Whereby, point-to-multipoint tunnel LSPs and VCLSPs for multicast are beforehand set between the ingress router 1d and each of the egress routers 3a and 3c, and the relay router 2p duplicates the multicast frame as required.

Accordingly, it is possible to remove a redundant process on the received frame in the relay router 2p, and to efficiently forward the frame in the MPLS network.

Now, description will be made of a frame forwarding method in the above structure according to the fifth embodiment with reference to FIG. 19.

The ingress router 1d shown in FIG. 19 beforehand sets a value of the tunnel LSP for multicast between the ingress router 1d and each of the egress routers 3a through 3c. The ingress router id beforehand writes a tunnel label and a VC label (for example, “1002”) inside the MPLS frame. This VC label represents that this is a point-to-multipoint multicast LSP from the ingress router id (given a VCID “1234”).

When receiving a multicast frame from the user site, the ingress router 1d outputs the layer 2 frame to be flooded to the multicast label process unit 16b. The label-for-multicast pushing unit 16 retrieves in the VC label table for multicast 44, gives a tunnel label “11” and a VC label “1002” to the received multicast frame, forwards the frame via the L2 header creating unit 10d and the like, and transmits the frame from the output port 1.

When receiving this MPLS frame, the relay router 2p finds, from “protocol type” in the L2 header, that the frame is a multicast MPLS frame, and retrieves in the VC label table for multicast 14. The relay router 2p swaps the tunnel label of the frame to “12” on the basis of a result of the retrieval, and transmits the swapped frame to the output port 2, while transmitting the frame whose tunnel label has been swapped to “15” to the output port 3.

In a fifth frame forwarding method (mode 5) according to this invention, in the forwarding process (forwarding process step), the ingress router 1d sets a VCLSP for multicast and a tunnel LSP for multicast between the ingress router 1d and each of the three egress routers 3a through 3c, each of which removes a tunnel label and a VC label given to a MPLS frame forwarded from the MPLS network 50 and transmits the frame to the outside of the MPLS network 50 (setting step), and transmits a plurality of MPLS frames to the relay routers 2p through 2r from the same output port as an output port from which a frame to be duplicated is forwarded to the relay router 2p through the VCLSP for multicast and the tunnel LSP for multicast set at the setting step (forwarding step).

In relaying (relaying step), each of the relay routers 2p through 2r duplicates the MPLS frame transmitted at the transmitting step, and forwards the frame through the VCLSP for multicast and the tunnel LSP for multicast set at the setting step.

Each of the egress routers 3a through 3c enters the multicast VC label “1002” and a unicast VC label in the opposite direction in the VC label bind table 35 (refer to FIG. 7). The address learning process on the received multicast frame performed in each of the egress routers 3a through 3c is the same as the method shown in FIG. 40.

According to the fifth embodiment, a newly defined VCLSP for multicast and a newly defined tunnel LSP for multicast are created end-to-end as a point-to-multipoint path between the ingress router 1d and each of the egress routers 3a through 3d in the MPLS network 50. The ingress router 1d transmits a frame required to be transmitted to, for example, the three relay routers 2p through 2r from the same port having received the frame from the user site via the relay routers 2p through 2r using the VCLSP for multicast and the tunnel LSP for multicast to forward the frame in the MPLS network 50.

The fifth embodiment provides the similar effects to those provided by the above embodiments. In concrete, transmission of the same frames in links between the ingress router 1d and each of the relay routers 2p through 2r is avoided, and the load on the MPLS network 50 is reduced.

### (F) Description of Sixth Embodiment

A sixth embodiment is a modified variation of the fifth embodiment.

In the known frame forwarding method, tunnel LSP and VCLSP are both set point-to-point. To the contrary, in a frame forwarding method according to the sixth embodiment, both tunnel LSP and VCID are used as a MPLS label used for forwarding, and a point-to-multipoint path is newly set to these tunnel LSP and VCID. Here, VCID has meanings of both user identification and user point identification.

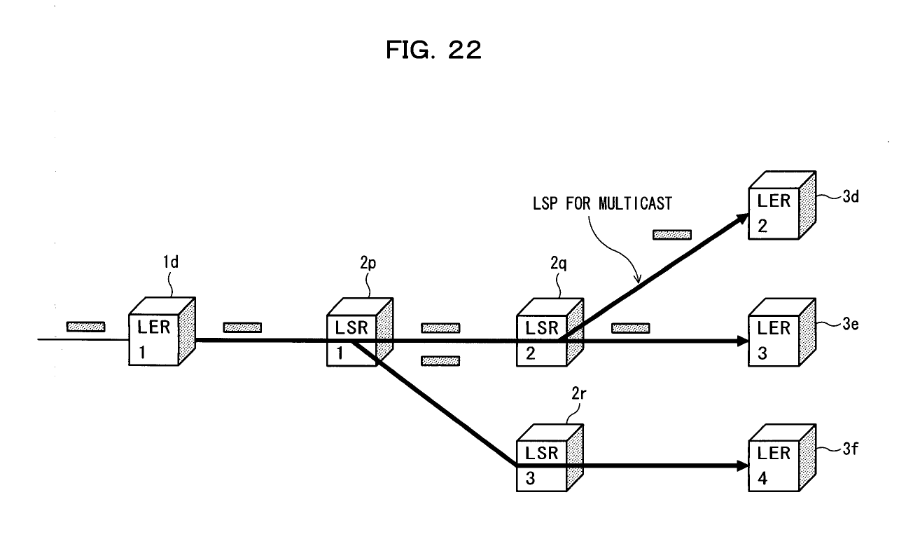

FIG. 22 is a diagram of a structure of an MPLS network 50 according to the sixth embodiment of this invention. The MPLS network 50 shown in FIG. 22 comprises the ingress router 1d, the relay routers 2p through 2r and egress routers 3d through 3f. Among them, the ingress router 1d and the relay routers 2p through 2r are the same as those described above.

Between neighboring routers among the routers shown in FIG. 22, only a VC label (denoted by black line) is set, but a tunnel label is not set. To the contrary, in the MPLS network 50 shown in FIG. 10, for example, a VC label (denoted by solid line) and a tunnel label (denoted by pipe) are set between routers.

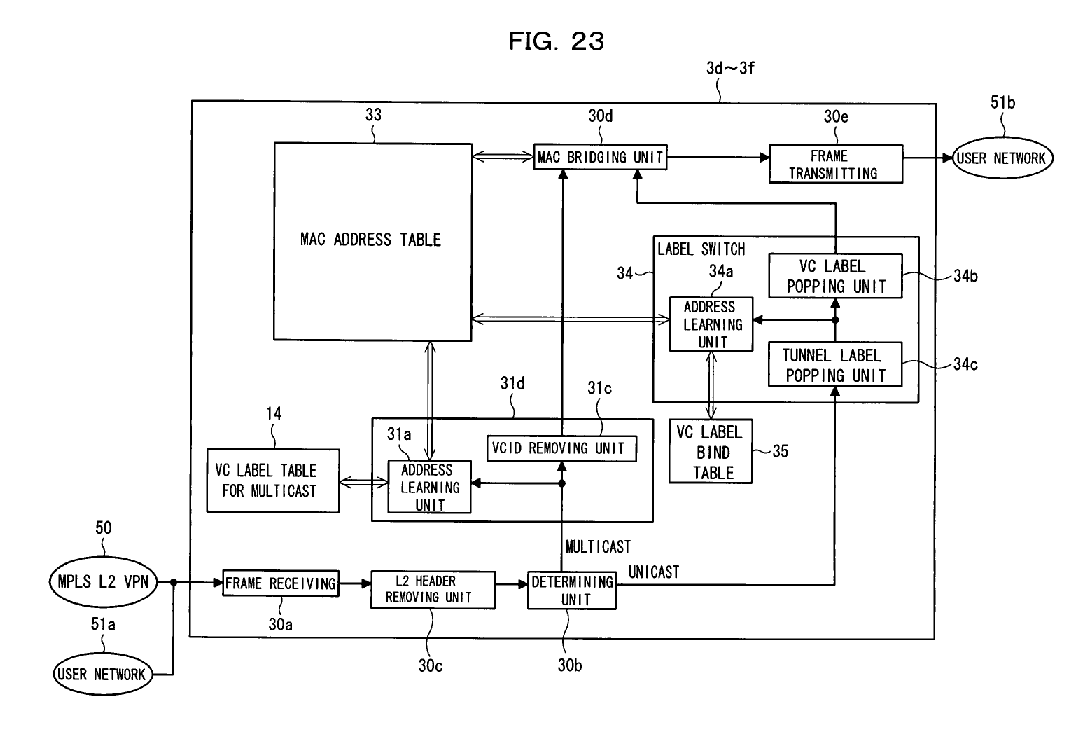

FIG. 23 is a block diagram of the egress router 3d according to the sixth embodiment of this invention. The egress router 3d shown in FIG. 23 is almost similar to the egress router 3a (FIG. 7), but differs from the egress router 3a in that the egress router 3d determines the frame type of a received frame and performs the popping process on the frame.

The L2 header removing unit 30c removes the header of a frame from the frame receiving unit 30a of the egress router 3d shown in FIG. 23, and the determining unit 30b determines whether the frame is a unicast frame or a multicast frame. In the case of a multicast frame, the popping process unit 31d removes the VCID of the multicast frame, and inputs the frame to the MAC bridge process unit 30d.

On the other hand, in the egress router 3a (FIG. 7), the determining unit 30b determines whether a frame from the frame receiving unit 30a is a unicast frame or a multicast frame, and the L2 header removing unit 31b removes the L2 header of the unicast frame or the multicast frame.

In FIG. 23, like reference characters designate like or corresponding parts described above. Each of the egress routers 3e and 3f shown in FIG. 22 has the same structure as the egress router 3d.

Next, description will be made of a frame forwarding method in the above structure according to the sixth embodiment with reference to FIG. 22.

The ingress router 1d sets a newly define LSP for multicast, as a point-to-multipoint LSP, end-to-end (between the ingress router 1d and each of the egress routers 3d through 3f) as same as a point-to-point tunnel LSP for unicast.

In order to flood the layer 2 frame received from the user site, the ingress router 1d outputs the frame to the multicast process unit 16b (FIG. 16). The multicast process unit 16b gives a user identifier VCID “1234” to a position (VC) of VC shim header shown in FIG. 28(b) of a multicast frame required to be transmitted to the plural relay routers 2p through 2r from the same port having received the frame from the user site. The ingress router 1d retrieves in the VC label table for multicast 14, gives a LSP label for multicast “11” to the frame, forwards the frame, and transmits the frame from the output port 1.

Accordingly, the LSP for multicast of the frame from the ingress router 1d to the relay router 2p functions to show the user and the ingress router 1d as being the user point.

When the relay router 1p receives this frame, the relay router 2p finds, from “protocol type” in the L2 header, that the frame is a multicast MPLS frame, and retrieves in the VC label table for multicast 14. The relay router 2p outputs the frame whose label has been swapped to “12” to the output port 2 on the basis of a result of the retrieval, while transmitting the frame whose label has been swapped to “15” to the output port 3. Namely, the relay router 2p duplicates the frame and swaps the label thereof to relay the MPLS frame having the VCID.

When each of the egress routers 3d through 3f receives this MPLS frame, the egress router retrieves in the VC label table for multicast 14 on the basis of the LSP label for multicast and the user identification VCID, and finds the VC label that the egress router has to learn. In concrete, each of the egress routers 3d through 3f retrieves the label for multicast 13 in the contents held in the VC label table for multicast 14 of the VCID “1234”, and learns the VC label 301.

In a sixth frame forwarding method (mode 6) of this invention, in the forwarding process (forwarding process step), the ingress router 1d sets a point/tunnel LSP identifying a VCLSP for multicast and a tunnel for multicast between the ingress router 1d and each of the three egress routers 3d through 3f, which removes a tunnel label and a VC label given to a MPLS frame forwarded from the MPLS network 50 and transmits the frame to the outside of the MPLS network 50 (setting step). The ingress router 1d gives a user identifier for identifying the user to the inside of the plural MPLS frame to be forwarded to the three relay routers 2p through 2r from the same port transferring the frame to be duplicated (giving step). The ingress router 1e transmits one or more MPLS frames including the user identifier given to the inside of the frame at the giving step to each of the relay routers 2p through 2r through the point/tunnel LSP set at the setting step (transmitting step).

In relaying (relaying step), each of the relay routers 2p through 2r duplicates the MPLS frame transmitted at the transmitting step, and forwards the frame through the point/tunnel LSP set at the setting step (forwarding step).

Each of the egress routers 3d through 3f learns the address, using the point/tunnel LSP used at the forwarding step and the user identifier given at the giving step (learning step).

As above, since VCID fulfills the both functions for user identification and user point identification, it is possible to newly set a point-to-multipoint path to the tunnel LSP and VCID, and thus efficiently forward the frame.

Further, transmission of the same frames is avoided in links between the ingress router 1d and each of the relay routers 2p through 2r, thus the load on the MPLS network 50 is reduced.

### (G) Description of Seventh Embodiment

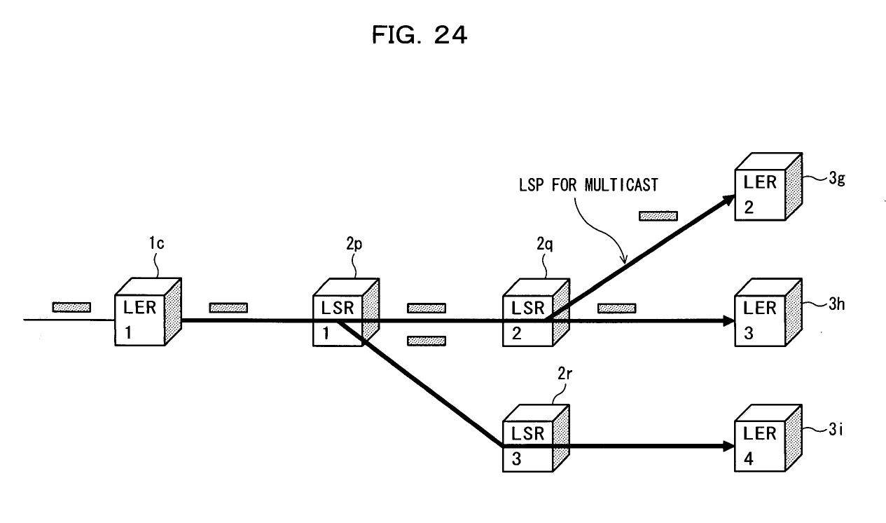

FIG. 24 is a diagram of a structure of an MPLS network 50 according to a seventh embodiment of this invention. The MPLS network 50 shown in FIG. 24 comprises the ingress router 1c (FIG. 17), the relay routers 2p through 2r (FIG. 21) and egress routers 3g through 3i. In FIG. 24, like reference characters other than the above designate like or corresponding part described above.

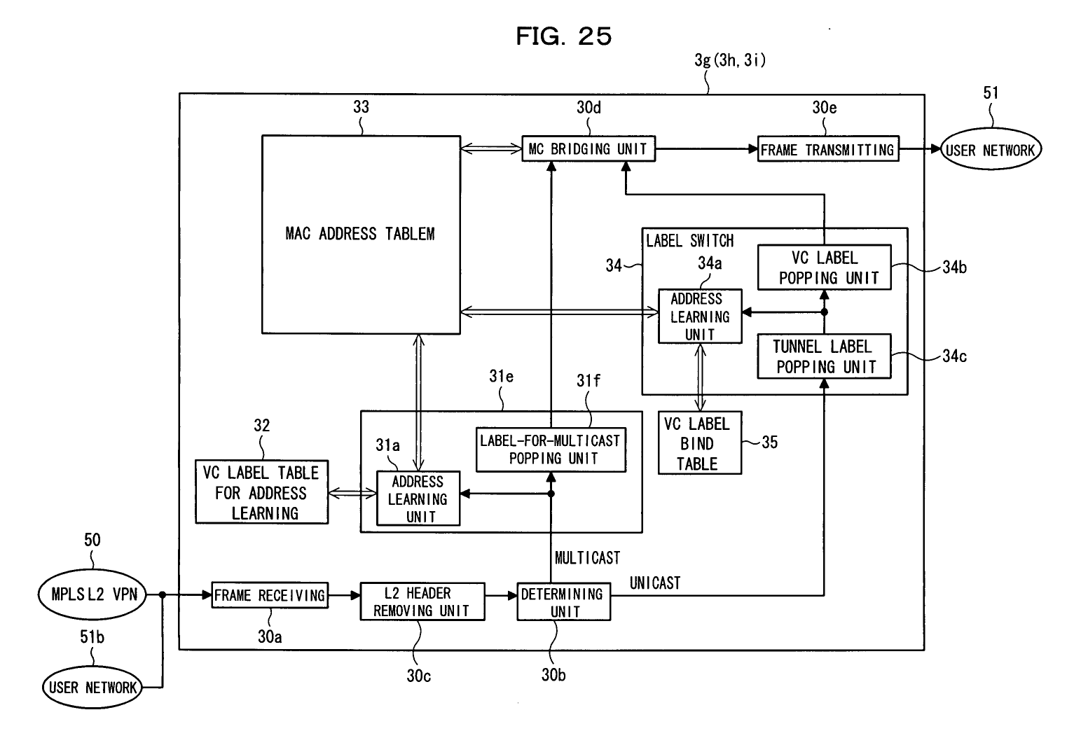

FIG. 25 is a block diagram of the egress router 3g according to the seventh embodiment of this invention. A pop processing unit 31e of the egress router 3g shown in FIG. 25 comprises a label-for-multicast popping unit 31f and the address learning unit 31a.

The label-for-multicast popping unit 31f is used to learn an address in an LSP label for multicast. In FIG. 25, like reference characters designate like or corresponding parts described above, as well as the address learning unit 31a.

Each of the egress routers 3h and 3i shown in FIG. 24 is similar in structure to the egress router 3g, duplicated descriptions of which are thus omitted.

In the above structure, the ingress router 1c shown in FIG. 24 creates an newly defined LSP for multicast end-to-end as a point-to-multipoint path between the ingress router 1c and the egress router 3g in the MPLS network 50 so that the ingress router 1c (user point), which is the source, can be identified.

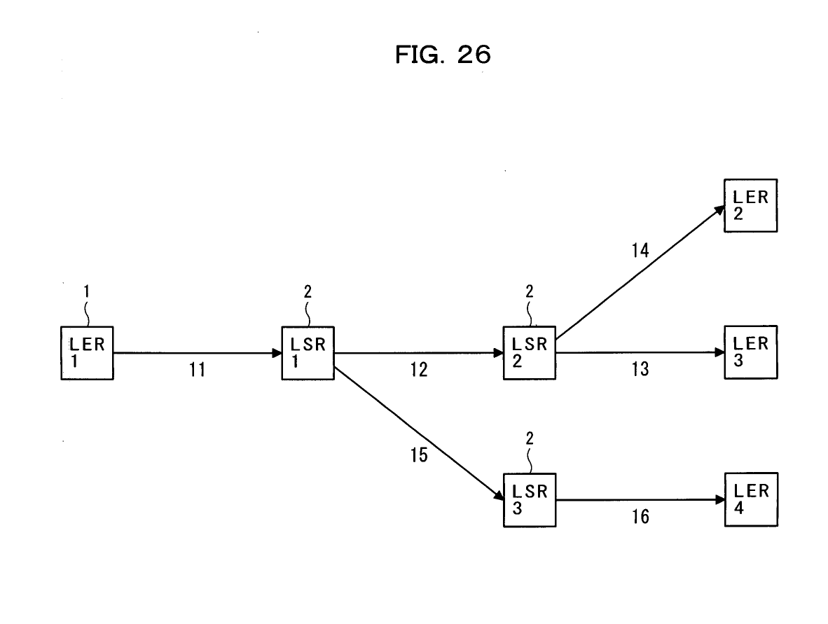

FIG. 26 is a diagram showing an example of LSP for multicast according to the seventh embodiment of this invention. The ingress router 1c sets a point-to-multipoint LSP for multicast between the ingress router 1c and the egress router 3g, and sets a VCID so that the egress router 1c and each of the egress routers 3g through 3i can be identified.

Whereby, the LSP for multicast performs a role for path determination, that is, as a tunnel. The ingress router 1c refers to the VC label table for multicast 14 with respect to a multicast frame received from the user site, sets a LSP for multicast, and forwards the frame to the relay router 2p to transmit the same.

In concrete, the ingress router 1c outputs the layer 2 frame to be flooded to the label push unit for multicast 16. The ingress router 1c retrieves in the label table for multicast 14, gives a label 11, forwards the frame, and transmits the same from the output port 1.

When the relay router 2p, or the relay router 2q or the like connected to the relay router 2p receives this frame, the relay router 2q or the like finds, from “protocol type” in the L2 header, that the received frame is a multicast MPLS frame, retrieves in the VC label table for multicast 14 (FIG. 21), duplicates the received frame on the basis of a result of the retrieval, switches (replaces) the user identification label for multicast and the tunnel LSP label, and transmits the frame.

For example, the relay router 2p transmits the frame whose label has been swapped to “12” to the output port 2, while transmitting the frame whose label has been swapped to “15” to the output port 3.

When the egress router 3g receives the MPLS frame from the relay router 2q, the egress router 3g retrieves in the VC label table for address learning 32 on the basis of the label 13 of the multicast frame, and finds the VC label to be learned.

In a seventh frame forwarding method (mode 7) according to this invention, in the forwarding process (forwarding process step), the ingress router 1c sets a point/tunnel LSP identifying a VCLSP for multicast and a tunnel LSP for multicast between the ingress router 1c and each of the three egress routers 3d through 3f, each of which removes the tunnel label and the VC label given to the MPLS frame forwarded from the MPLS network 50 and transmits the frame to the outside of the MPLS network 50 (setting step), gives the point/tunnel LSP set at the setting step to the outside of the plural MPLS frames to be forwarded to the three relay routers 2p through 2r from the same output port as the output port forwarding the frame to be duplicated (giving step), and transmits one or more MPLS frames given the point/tunnel LSP at the giving step to each of the relay routers 2p through 2r through the point/tunnel LSP set at the setting step (transmitting step).

In the relaying step, each of the relay routers 2p through 2r duplicates the MPLS frame transmitted at the transmitting step, and forwards the frames through the point/tunnel LSP set at the setting step (forwarding step).

Each of the egress routers 3d through 3f learns the address, using the point/tunnel LSP used at the forwarding step (learning step).

As above, transmission of the same frames in a link between the ingress router 1c and the relay router 2p, and the load on the MPLS network 50 is reduced.

As above, a new LSP for multicast is set between the ingress router 1c and the egress router 3g, whereby each of the egress routers 3d through 3f can identify the ingress router 1c which is the source, and a point-to-multipoint path can be established end-to-end.

As this, it is possible to suppress the load on the MPLS network 50 to the minimum, and to efficiently use the forwarding band in the layer 2 MPLS network 50 (L2VPN).

### (H) Others

Note that the present invention is not limited to the above examples.

The MPLS network 50 can encapsulate an optical frame or an optical cell as a lower layer frame other than a layer 2 packet, and forward the same. For example, when the MPLS network 50 is connected to an optical wavelength transmission network (not shown), the optical wavelength transmission network corresponds to the lower layer network and the MPLS network corresponds to the higher layer network.

In more detail, a plurality of routers belonging to the MPLS network are connected, in layer 2 which is the lower layer of the routers, through optical paths corresponding to the above links and optical switches corresponding to the routers in layer 2. Further, MPLS, which is the higher layer of the routers belonging to the MPLS network, and the optical switch function, which is the higher layer of an optical transmission apparatus belonging to the optical wavelength transmission network, can be logically connected to each other through a LSP set to each of the optical path and optical switch.

### Industrial Applicability

According to the router, the frame forwarding method and the lower layer frame virtual forwarding system of this invention, it is possible to prevent an increase in load on the virtual network because the same frames are not duplicated and forwarded in the same link between the ingress router and the relay router. Since the load on the virtual network can be reduced, the transmission band can be efficiently used. Further, it is possible to realize multicasting and broadcasting in the virtual network irrespective of the form of packets or frames in various protocols. Additionally, existing network resources can be used. Moreover, since the egress edge router has the address learning function, the egress edge router can identify the source ingress edge router, and a point-to-point path can be established end-to-end.

1. A router in a virtual network being able to forward a lower layer frame including a protocol identifier for identifying duplication or non-duplication and a label switch frame having a hierarchical path identifier on the basis of the hierarchical path identifier, said router comprising:
a determining unit for determining whether a received lower layer frame or a received label switch frame is to be duplicated or not on the basis of a protocol identifier of the received lower layer frame or the received label switch frame; and
a forwarding process unit for giving at least any one of a hierarchical path identifier for unicast, a hierarchical path identifier for multicast and a user identifier to the received lower layer frame or the received label switch frame determined to be duplicated by said determining unit, and forwarding the frame.

2. The router according to claim 1, wherein said router is configured as an ingress edge router pushing the label switch frame obtained by giving the hierarchical path identifier to an external lower layer frame from the outside of said virtual network to said virtual network;
said determining unit determines whether a received external lower layer frame is to be duplicated or not on the basis of a multicast physical address table in which a physical address to be duplicated is related to a plurality of output ports; and
said forwarding process unit gives at least one label among a label of a user point identification path selected from a plurality of user point identification paths for forwarding unicast frames, a user point identification path label showing a point of a forwarding source of the frame to be duplicated and a tunnel path label showing a virtual route for the frame to be duplicated, a multicast label for multicast, and a user identifier for identifying a user, and forwards the frame.

3. The router according to claim 1, wherein said router is configured as a relay router forwarding the label switch frame to said virtual network on the basis of the hierarchical path identifier;
said determining unit determines whether to duplicate the label switch frame or not on the basis of a protocol identifier included in the label switch frame; and
said forwarding process unit bridges to forward the label switch frame determined not to be duplicated by said determining unit, while duplicating the label switch frame determined to be duplicated by said determining unit on the basis of a VC label table for multicast in which at least a user point identification path label is related to contents of a process to be performed on the label switch frame to be duplicated, and giving the user point identification path label and the tunnel path label to the same.

4. The router according to claim 1, wherein said router is configured as an egress edge router removing the hierarchical path identifier given to the label switch frame forwarded from said virtual network and transmitting the label switch frame to the outside of said virtual network; and
said forwarding process unit comprises a popping process unit learning a relationship between a source physical address of the label switch frame and the hierarchical path identifier, and transmitting a lower layer frame from which the hierarchical path identifier has been removed to the outside of said virtual network.

5. A frame forwarding method in a virtual network being able to forward a lower layer frame including a protocol identifier for identifying duplication or non-duplication and a label switch frame having a hierarchical path identifier on the basis of the hierarchical path identifier, said frame forwarding method comprising:
a determining step of determining, by an ingress edge router pushing the label switch frame obtained by giving the hierarchical path identifier to an external lower layer frame from the outside of said virtual network to said virtual network, whether a received layer lower frame or a received label switch frame is to be duplicated on the basis of a protocol identifier of the received lower layer frame or the received label switch frame;
a forwarding process step of passing, by said ingress edge router, the received lower layer frame or the received label switch frame determined not to be duplicated at said determining step, while giving at least any one of a hierarchical path identifier for unicast, a hierarchical path identifier for multicast and a user identifier to the received lower layer frame or the received label switch frame determined to be duplicated at said determining step, and forwarding the same; and
a relaying step of duplicating or forwarding, by a relay router forwarding to said virtual network, the received lower layer frame or the received label switch frame forwarded at said forwarding process step on the basis of at least any one of the hierarchical path identifier for unicast, the hierarchical path identifier for multicast and the user identifier.

6. The frame forwarding method according to claim 5, wherein, at said forwarding process step, said ingress edge router forwards the label switch frame obtained by giving an address for multicast to a destination address of the received external lower layer frame; and
at said relaying step, said relay router duplicates and forwards the label switch frame forwarded at said forwarding process step on the basis of a physical address table for multicast in which an address for multicast is related to forwarding destination router addresses.

7. The frame forwarding method according to claim 5, wherein said forwarding process step comprises:
a determining step of determining, by said ingress edge router, whether to duplicate the received external lower layer frame or not on the basis of a physical address table in which a physical address to be duplicated is related to a user point identification path for forwarding a unicast frame;
a selecting step of selecting, by said ingress edge router, a user point identification path from user point identification paths for a plurality of the frames not to be duplicated forwarded from the same output ports as output ports for forwarding the frames to be duplicated among a plurality of user point identification paths for forwarding the frames not to be duplicated among the user point identification paths; and
a transmitting step of transmitting, by said ingress edge router, the label switch frame having a user point identification path selected at said selecting step; and
at said relaying step, said relay router duplicates and forwards the label switch frame transmitted at said transmitting step on the basis of a user point identification path label table for multicast in which a user point identification label for multicast is related to forwarding destination router addresses.

8. The frame forwarding method according to claim 5, wherein said forwarding process step comprises:
a setting step of setting, by said ingress edge router, a user point identification path for multicast and a tunnel path for multicast; and
a forwarding step of forwarding, by said ingress edge router, the label switch frame through the user point identification path for multicast and the tunnel path for multicast;
said relaying step comprises a duplicating/forwarding step of duplicating and transferring, by a first relay router, the label switch frame on the basis of a label table for multicast in which the user point identification path label for multicast is related to forwarding destination router addresses;
a second relay router duplicating the label switch frame duplicated and forwarded at said duplicating/forwarding step, and forwarding the same through the user point identification path for multicast and the tunnel path for multicast set at said setting step.

9. The frame forwarding method according to claim 5, wherein said forwarding process step comprises:
a setting step of setting, by said ingress edge router, a point/tunnel identification path for identifying a user point for multicast and a tunnel for multicast; and
a forwarding step of forwarding, by said ingress edge router, the label switch frame through the point/tunnel identification path;
said relaying step comprises a duplicating/forwarding step of duplicating and forwarding, by a first relay router, the label switch frame on the basis of a second label table for multicast in which the point/tunnel identification path is related to forwarding destination router addresses;
a second relay router duplicating the label switch frame duplicated and forwarded at said duplicating/forwarding step, and forwarding the same through the point/tunnel identification path set at said setting step.

10. The frame forwarding method according to claim 5, wherein said forwarding process step comprises:
a setting step of setting a user point identification path for multicast and a tunnel path for multicast between said ingress edge router and each of a plurality of egress edge routers, each of which removes the hierarchical path identifier given to the label switch frame forwarded from said virtual network and transmits the label switch frame to the outside of said virtual network; and
a transmitting step of transmitting, by said ingress edge router, a plurality of the label switch frames to be transferred to a plurality of said relay routers from the same output ports as output ports for forwarding the frames to be duplicated to said respective relay routers through the user point identification path for multicast and the tunnel path for multicast set at said setting step;
at said relaying step, each of said relay routers duplicates the label switch frame transmitted at said transmitting step, and forwards the same through the user point identification path for multicast and the tunnel path for multicast set at said setting step.

11. The frame forwarding method according to claim 5, wherein said forwarding process step comprises:
a setting step of setting a point/tunnel identification path for identifying a user point for multicast and a tunnel for multicast between said ingress edge router and each of a plurality of egress edge routers, each of which removes the hierarchical path identifier given to the label switch frame forwarded from said virtual network and transmits the label switch frame to the outside of said virtual network;
a giving step of giving, by said ingress edge router, a user identifier for identifying a user to the inside of each of a plurality of the label switch frames to be forwarded to a plurality of said relay routers from the same output ports as output ports for forwarding the frames to be duplicated; and
a transmitting step of transmitting, by said ingress edge router, the label switch frame including the user identifier given to the inside of the frame at said giving step to each of said relay routers through the point/tunnel identification path set at said setting step;
said relaying step comprises a forwarding step of duplicating, by said relay router, the label switch frame transmitted at said transmitting step and forwarding the same through the point/tunnel identification path set at said setting step; and
a learning step of learning an address, by said egress router, using the point/tunnel identification path used at said forwarding step and the user identifier given at said giving step.

12. The frame forwarding method according to claim 5, wherein said forwarding process step comprises:
a setting step of setting a point/tunnel identification path for identifying a user point for multicast and a tunnel for multicast between said ingress edge router and each of plural egress edge routers, each of which removes the hierarchical path identifier given to the label switch frame forwarded from said virtual network and transmits the label switch frame to the outside of said virtual network;
a giving step of giving, by said ingress edge router, the point/tunnel identification path set at said setting step to the outside of each of a plurality of the label switch frames to be forwarded to a plurality of said relay routers from the same output ports as output ports for forwarding the frames to be duplicated; and
a transmitting step of transmitting, by said ingress edge router, the label switch frame given the point/tunnel identification path at said giving step to each of said relay routers through the point/tunnel identification path set at said setting step;
a forwading step comprises a forwarding step of duplicating, by said relay router, the label switch frame transmitted at said transmitting step and forwarding the same through the point/tunnel identification path set at said setting step; and
a learning step of learning an address, by said egress edge router, using the point/tunnel identification path used at said forwarding step.

13. A lower layer frame virtual forwarding system comprising:
an ingress edge router for pushing a label switch frame obtained by giving a hierarchical path identifier to an external lower layer frame from the outside of a virtual network, which can transfer a lower layer frame including a protocol identifier for identifying duplication or non-duplication and the label switch frame having the hierarchical path identifier, to said virtual network;
a relay router for forwarding the label switch frame forwarded from said ingress edge router to said virtual network on the basis of the hierarchical path identifier;
an egress edge router for removing the hierarchical path identifier given to the label switch frame forwarded from said relay router, and transmitting the label switch frame to the outside of said virtual network;
each of said ingress edge router, said relay router, and said egress edge router comprising:
a determining unit for determining whether a received lower layer frame or a received label switch frame is to be duplicated or not on the basis of a protocol identifier of the received lower layer frame or the received label switch frame; and
a forwarding process unit for passing the received lower layer frame or the received label switch frame determined not to be duplicated by said determining unit, while giving at least any one of a hierarchical path identifier for unicast, a hierarchical path identifier for multicast and a user identifier to the received lower layer frame or the received label switch frame determined to be duplicated by said determining unit, and forwarding the frame.

14. The router according to claim 1, wherein said forwarding process unit passes the received lower layer frame or the received label switch frame determined not to be duplicated by said determining unit.
